(19) United States
(12) Patent Application Publication
(10) Pub. No.: US 2025/0267737 A1
(43) Pub. Date: Aug. 21, 2025

(54) NEW RADIO (NR) POSITIONING METHODS FOR IN COVERAGE SIDELINK POSITIONING

(71) Applicant: InterDigital Patent Holdings, Inc., Wilmington, DE (US)

(72) Inventors: Tuong Hoang, Montreal (CA); Fumihiro Hasegawa, Westmount (CA); Tao Deng, New York, NY (US); Jaya Rao, Montreal (CA); Moon IL Lee, Melville, NY (US); Paul Marinier, Brossard (CA); Kunjan Shah, London (GB)

(73) Assignee: InterDigital Patent Holdings, Inc., Wilmington, DE (US)

(21) Appl. No.: 18/858,653

(22) PCT Filed: Apr. 25, 2023
(86) PCT No.: PCT/US2023/019768

§ 371 Date: Oct. 21, 2024

Related U.S. Application Data
(60) Provisional application No. 63/334,809, filed on Apr. 26, 2022.
(60) Provisional application No. 63/395,406, filed on Aug. 5, 2022.
(60) Provisional application No. 63/421,669, filed on Nov. 2, 2022.
(60) Provisional application No. 63/445,340, filed on Feb. 14, 2023.

(51) Int. Cl. H04W 76/14; H04W 64/00; H04W 92/18

(52) U.S. Cl. CPC H04W 76/14; H04W 64/00; H04W 92/18

(57) ABSTRACT

Sidelink positioning may be accomplished by a wireless transmit/receive unit (WTRU). The WTRU may be configured to transmit a first message comprising sidelink positioning information associated with a group of WTRUs. The sidelink positioning information may comprise an indication of a sidelink positioning method for determining positions of the WTRUs in the group of WTRUs. The WTRU may be configured to transmit a second message comprising a request for sidelink positioning reference signal (SL-PRS) resources for the group of WTRUs. The WTRU may be configured to receive an indication of allocated SL-PRS resources for the group of WTRUs. The WTRU may be configured to send an indication of the allocated SL-PRS resources to the group of WTRUs.

### CROSS REFERENCE TO RELATED APPLICATIONS

This application claims priority to U.S. Provisional Patent Application No. 63/334,809, filed Apr. 26, 2022, U.S. Provisional Patent Application No. 63/395,406, filed Aug. 5, 2022, U.S. Provisional Patent Application No. 63/421,669, filed Nov. 2, 2022, and U.S. Provisional Patent Application No. 63/445,340, filed Feb. 14, 2023. U.S. Provisional Patent Application No. 63/334,809 is incorporated herein by reference in its entirety. U.S. Provisional Patent Application No. 63/395,406 is incorporated herein by reference in its entirety. U.S. Provisional Patent Application No. 63/421,669 is incorporated herein by reference in its entirety. U.S. Provisional Patent Application No. 63/445,340 is incorporated herein by reference in its entirety.

### BACKGROUND

Sidelink communications enable device-to-device (D2D) communications. Sidelink communications may have various applications, such as, for example, vehicle-to-everything (V2X) applications. Sidelink communications may be used in in-network coverage scenarios and out-of-network coverage scenarios. As advancements in telecommunications continue, users are expecting quicker response times and lower latency times. Advancements in sidelink communications are needed to meet these expectations.

### SUMMARY

Communication between one or more user equipments (UEs) and a network is considered herein. A UE also may be referred to as a wireless transmit/receive unit (WTRU). The terms UE and WTRU may be used interchangeably herein. Methods and systems are described herein for reducing signaling overhead between network entities (e.g., severs, nodes, next generation Node B-gNB, etc.) and WTRUs. For example, scheduling procedures for a group of WTRUs (e.g., target WTRUs and anchor WTRUs) to perform sidelink positioning to reduce signaling overhead between gNB and the WTRUs in the group are described herein.

In various examples, which will become evident in context of the herein description, to accomplish sidelink positioning, a WTRU may determine whether downlink control information (DCI) is for sidelink-positioning reference signal (SL-PRS) based on an indication in the DCI. The WTRU may determine whether to transmit data and/or SL-PRS in a scheduled sidelink resource. The WTRU may determine the positioning method based on the set of SL-PRS scheduled by the network. The WTRU may determine whether to request SL-PRS resource for another WTRU. The WTRU may determine the value of parameters for SL-PRS transmission/reception resources for the group. The WTRU may use one SL-PRS transmission to multiple anchor WTRUs in a round trip time (RTT) positioning method. The WTRU may determine whether to transmit SL-PRS using unicast or groupcast for RTT method. The WTRU may determine which WTRU to request/select sidelink resource for one or more member in the group. The WTRU may determine SL-PRS resources for RTT positioning method. The WTRU may determine whether to forward the scheduled SL-PRS resources to another WTRU. The WTRU may determine the SL-PRS transmission resources for other WTRUs. The WTRU may report synchronization offset information of the positioning group to network. The WTRU may indicate the synchronization offset based on the resource allocation mode of two WTRUs. The WTRU may request periodic and/or aperiodic SL-PRS resources. The WTRU may trigger changing a SL-PRS configuration (e.g., SL-PRS offset and/or periodicity). The WTRU may determine whether to measure a reference signal time difference (RSTD) between two radio access technologies (RATs). The WTRU may determine the reference node for RSTD measurement. The WTRU may request other WTRUs to mute during its measurement gap (MG) and/or positioning processing window (PPW) in user-to-user (Uu) communications. The WTRU triggers resource reselection and/or pre-emption upon reception of MG/PPW configuration in Uu. The WTRU triggers resource reselection and/or pre-emption upon reception of MG and/or PPW in Uu of the peer WTRU.

In additional various examples, which will become evident in context of the herein description, to accomplish sidelink positioning, a WTRU may determine the time gap between initial transmission and retransmission of a SL-PRS. The WTRU may determine which SL-PRS configuration to use. The WTRU may prioritize the resource pool used by a peer WTRU. The WTRU may determine which ID to scramble/generate the SL-PRS sequence. The WTRU may determine when to monitor a SL-PRS resource pool. The WTRU may determine whether the DCI is for SL-PRS, or data transmission based on a radio network temporary identifier (RNTI). The WTRU may determine whether the DCI is for SL-PRS, or data transmission based on search space set. The WTRU may determine whether the DCI is for SL-PRS, or data based on an indicated codepoint in a bitfield. The WTRU may be scheduled group common DCI for SL-PRS. The WTRU may determine whether to forward the scheduled SL-PRS for the member WTRUs in a group. The WTRU may determine whether to transmit the scheduled SL-PRS based on an acknowledgement (ACK) from member WTRUs. The WTRU may send sidelink positioning group information to a network.

In further various examples, which will become evident in context of the herein description, to accomplish sidelink positioning, a WTRU may WTRU may receive SL-PRS configurations. The WTRU may determine the location of a physical sidelink control channel/physical sidelink shared channel (PSCCH/PSSCH) for SL-PRS multiplexing. The WTRU may embed sidelink control information (SCI) in a SL-PRS pattern. The WTRU may receive information for sidelink positioning from one node and indicate the information to another node. The WTRU may provide a request for sidelink positioning. The WTRU may indicate an ID/index (identification/index) associated with sidelink positioning to a network.

In various other examples, which will become evident in context of the herein description, to accomplish sidelink positioning, a WTRU may determine whether to multiplex SCI with SL-PRS. The WTRU may determine the location of SCI. The WTRU may determine the parameters for a SL-PRS transmission. The WTRU may determine a resource pool for SL-PRS. The WTRU may determine the resource location mode for sidelink positioning. The WTRU may receive scheduled resource(s) for sidelink positioning. The WTRU may determine which WTRU to request resource from for sidelink positioning. The WTRU may trigger resource allocation and/or requesting resource(s) for sidelink positioning. The WTRU may determine the information to indicate and/or report the SL-PRS resource usage. The WTRU may determine whether to indicate and/or report the SL-PRS resource usage. The WTRU may determine the resource to indicate and/or report the SL-PRS resource usage. The WTRU may determine the information to include in SL-PRS measurement reporting. The WTRU may determine the information to indicate and/or report the sidelink resource usage in uplink. The WTRU may receive sidelink positioning resources for a group of WTRUs and forward to other WTRUs. The WTRU may receive configuration for sidelink positioning. The WTRU may transmit configuration for sidelink positioning to other WTRUs. The WTRU may determine the SL-PRS reception resource of each WTRU in a group. The WTRU may determine its SL-PRS transmission resources. The WTRU may determine the SL-PRS measurement reporting resource from each WTRU in a group. The WTRU may be configured for periodic and/or semi-static resources for sidelink positioning. The WTRU's behavior may be based on the status of the feedback for SL-PRS resource usage from other WTRUs. The WTRU may indicate the priority of a sidelink positioning service. The WTRU may report its SL-PRS resources to the network. The WTRU may determine whether to perform SL-PRS reception. The WTRU may request a MG and/or a positioning processing window (PPW) for SL-PRS reception. The WTRU may indicate its SL-PRS reception resources to another WTRU. The WTRU may prioritize between SL-PRS reception and other types of sidelink transmission and/or reception.

An example WTRU may be configured to transmit, via a transceiver, a first message comprising sidelink positioning information associated with a group of WTRUs. The sidelink positioning information may comprise an indication of a sidelink positioning method for determining positions of the WTRUs in the group of WTRUs. The WTRU may transmit, via the transceiver, a second message comprising a request for sidelink positioning reference signal (SL-PRS) resources for the group of WTRUs. The WTRU may receive, via the transceiver, an indication of allocated SL-PRS resources for the group of WTRUs. The WTRU may send, via the transceiver, an indication of the allocated SL-PRS resources to the group of WTRUs. The requested resources may be based on the sidelink positioning method, a number of WTRUs in the group of WTRUs, and/or a quality of service (QOS) associated with the sidelink positioning method. The sidelink positioning information in the first message may comprise a group identifier (ID) associated with the group of WTRUs. The request for SL-PRS resources in the second message may comprise the group ID. The sidelink positioning method may comprise at least one of round trip time (RTT) positioning, sidelink-time difference of arrival (SL-TDOA) positioning, and/or sidelink-angle of departure (SL-AoD) positioning. The WTRU may be one of the WTRUs in the group of WTRUs, and the request for SL-PRS resources may comprise a request for SL-PRS transmission resources for the WTRU and a request for SL-PRS transmission resources for other WTRUs in the group of WTRUs. The request for SL-PRS resources may comprise a number of SL-PRS transmission resources requested for the WTRU. The request for SL-PRS resources may comprise a number of SL-PRS transmission resources requested for the remaining WTRUs in the group of WTRUs. The second message may comprise a medium access control (MAC) control element (CE). The WTRU may be configured to perform a sidelink discovery procedure to identify the group of WTRUs. The WTRU may be configured to transmit the first message and the second message to a node. The node may comprise at least one of network node, another WTRU, a roadside unit (RSU), or any appropriate combination thereof.

Further disclosed herein is at least one computer-readable storage medium having executable instructions stored thereon. When executed by a processor, of a WTRU for example, the instructions may cause the at least one computer-readable storage medium to transmit a first message comprising sidelink positioning information associated with a group of WTRUs. The sidelink positioning information may comprise an indication of a sidelink positioning method for determining positions of the WTRUs in the group of WTRUs. When executed, the instructions may further cause the processor to transmit a second message comprising a request for sidelink positioning reference signal (SL-PRS) resources for the group of WTRUs. When executed, the instructions may further cause the processor to receive an indication of allocated SL-PRS resources for the group of WTRUs. When executed, the instructions may further cause the processor to send an indication of the allocated SL-PRS resources to the group of WTRUs. The requested resources may be based on the sidelink positioning method, a number of WTRUs in the group of WTRUs, and/or a quality of service (QOS) associated with the sidelink positioning method. The sidelink positioning information in the first message may comprise a group identifier (ID) associated with the group of WTRUs. The request for SL-PRS resources in the second message may comprise the group ID. The sidelink positioning method may comprise at least one of round trip time (RTT) positioning, sidelink-time difference of arrival (SL-TDOA) positioning, and/or sidelink-angle of departure (SL-AoD) positioning. The WTRU may be one of the WTRUs in the group of WTRUs, and the request for SL-PRS resources may comprise a request for SL-PRS transmission resources for the WTRU and a request for SL-PRS transmission resources for other WTRUs in the group of WTRUs. The request for SL-PRS resources may comprise a number of SL-PRS transmission resources requested for the WTRU. The request for SL-PRS resources may comprise a number of SL-PRS transmission resources requested for the remaining WTRUs in the group of WTRUs. The second message may comprise a medium access control (MAC) control element (CE). When executed, the instructions may further cause the processor to perform a sidelink discovery procedure to identify the group of WTRUs. When executed, the instructions may further cause the processor to transmit the first message and the second message to a node. The node may comprise at least one of network node, another WTRU, a roadside unit (RSU), or any appropriate combination thereof.

A another example of a WTRU configured to perform sidelink positioning, the WTRU may receive an indication of a resource for performing sidelink positioning for a group of WTRUs. The indication may be based on the resource being capable of transmitting and receiving a sidelink positioning reference signal (SL-PRS) and/or performing RTT-based sidelink positioning. The indication may be based on the resource being capable of transmitting a SL-PRS and/or performing SL-PRS-transmission based positioning, receiving a SL-PRS, and/or performing SL-PRS-reception based positioning. The WTRU may determine at least one anchor WTRU in the group of WTRUs. The WTRU may determine a group identifier for the group of WTRUs. The WTRU may send sidelink positioning group information to a network node. The network node may comprise a gNB. The WTRU may request resources for performing sidelink position for the group of WTRUs. The indication of the resource may be received via a downlink control information (DCI) transmission. Based on the resource being capable of receiving a SL-PRS, the WTRU may send the indication of the resource to the at least one anchor WTRU. Based on the resource being capable of reporting SL-PRS measurements, the WTRU may send the indication of the resource to the at least one anchor WTRU. Sending the indication of the resource to the at least one anchor WTRU may utilize the group identifier for the group of WTRUs. The WTRU may determine at least one anchor WTRU in the group of WTRUs. The WTRU may determine a group identifier for the group of WTRUs. The WTRU may send sidelink positioning group information to a network node. The network node may comprise a gNB.

An example computer-readable storage medium may have executable instructions stored thereon. When executed by a processor, the executable instructions may configure the processer to facilitate sidelink positioning. When the executable instructions execute, the processor may configure the WTRU to receive an indication of a resource for performing sidelink positioning for a group of WTRUs. The WTRU may receive the indication based on the resource being capable of transmitting and receiving a sidelink positioning reference signal (SL-PRS). The WTRU may be configured to perform round trip time (RTT)-based sidelink positioning, based on the resource being capable of transmitting a SL-PRS. The WTRU may be configured to perform SL-PRS-transmission based positioning based on the resource being capable of receiving a SL-PRS. The WTRU may be configured to perform SL-PRS-reception based positioning. When the executable instructions execute, the processor may configure the WTRU to determine at least on anchor WTRU in the group of WTRUs. When the executable instructions execute, the processor may configure the WTRU to determine a group identifier for the group of WTRUs. When the executable instructions execute, the processor may configure the WTRU to send sidelink positioning group information to a network node. The network node may comprise a gNB. When the executable instructions execute, the processor may configure the WTRU to request resources for performing sidelink position for the group of WTRUs. Downlink control information (DCI) transmission may receive the indication of the resource. Based on the resource being capable of receiving a SL-PRS, when the executable instructions executed, the processor may configure the WTRU to send the indication of the resource to the at least one anchor WTRU. Based on the resource being capable of reporting SL-PRS measurements, when the executable instructions execute, the processor may configure the WTRU to send the indication of the resource to the at least one anchor WTRU. Sending the indication of the resource to the at least one anchor WTRU may utilize the group identifier for the group of WTRUs.

In examples, each WTRU of a group of WTRUs may be configured with a respective orthogonal cover code (OCC). Each OCC may be based on a respective identifier (ID) of each WTRU in the group of WTRUs. Each OCC may receive a respective sidelink positioning reference signal (SL-PRS) configuration for each resource of a plurality of resources. Each respective SL-PRS configuration may comprise at least one of a bandwidth associated with the respective resource, a duration associated with the respective resource, a number of repetitions associated with the respective resource, a size of the respective resource, multiplexing rules associated with the respective resource, and/or receiving a respective SL-PRS measurement reporting configuration for each resource of the plurality of resources.

Each SL-PRS measurement reporting configuration may comprise at least one of a bandwidth associated with the respective resource, a duration associated with the respective resource, a number of repetitions associated with the respective resource, a size of the respective resource, and/or multiplexing rules associated with the respective resource.

Each SL-PRS measurement reporting configuration may send an indication of each respective SL-PRS configuration and/or each respective SL-PRS measurement reporting configuration to each WTRU of the group of WTRUs that utilize a group ID that identifies the group of WTRUs. Each SL-PRS measurement reporting configuration may receive an indication of scheduled resources of the plurality of resources for performing sidelink positioning for the group of WTRUs, and/or determine a SL-PRS resource and/or SL-PRS measurement reporting resource for each anchor WTRU in the group of WTRUs. The determination of the SL-PRS resource and/or SL-PRS measurement reporting resource for each anchor WTRU may be based on at least one of an ID for each anchor WTRU, a number of WTRUs in the group of WTRUs, the OCC for each WTRU of the group of WTRUs, a set of sidelink resources scheduled for the group, and/or the multiplexing rules associated with the each resource of the plurality of resources. To perform SL-PRS measurement and/or derive its positioning, the WTRU may calculate a round trip time (RTT) between each WTRU of the group of WTRUs and each anchor WTRU of the group of WTRUs based on measured and reported transmission and reception times therebetween. The WTRU may determine relative positioning of each WTRU of the group of WTRUs based on the calculated RTT. The WTRU may send an indication of the relative positioning to each WTRU of the group of WTRUs.

Each SL-PRS measurement reporting configuration may comprise at least one of a bandwidth associated with the respective resource, a duration associated with the respective resource, a number of repetitions associated with the respective resource, a size of the respective resource, and/or multiplexing rules associated with the respective resource. Each SL-PRS measurement reporting configuration may send an indication of each respective SL-PRS configuration and/or each respective SL-PRS measurement reporting configuration to each WTRU of the group of WTRUs that utilize a group ID that identifies the group of WTRUs. Each SL-PRS measurement reporting configuration may receive an indication of scheduled resources of the plurality of resources for performing sidelink positioning for the group of WTRUs and/or determine a SL-PRS resource and/or SL-PRS measurement reporting resource for each anchor WTRU in the group of WTRUs. The determination of the SL-PRS resource and/or SL-PRS measurement reporting resource for each anchor WTRU may be based on at least one of an ID for each anchor WTRU, a number of WTRUs in the group of WTRUs, the OCC for each WTRU of the group of WTRUs, a set of sidelink resources scheduled for the group, and/or the multiplexing rules associated with the each resource of the plurality of resources.

A may include a transceiver and a processor. The processor may be configured to transmit, via the transceiver, a first message comprising sidelink positioning information associated with a group of WTRUs. The sidelink positioning information may include an indication of a sidelink positioning method for determining positions of the WTRUs in the group of WTRUs. The processor may be configured to transmit, to transmit, via the transceiver, a second message comprising a request for sidelink positioning reference signal (SL-PRS) resources for the group of WTRUs. The processor may be configured to receive, via the transceiver, an indication of allocated SL-PRS resources for the group of WTRUs. The processor may be configured to send, via the transceiver, an indication of the allocated SL-PRS resources to the group of WTRUs.

The resources requested by the WTRU may be based, at least in part, on the sidelink positioning method, a number of WTRUs in the group of WTRUs, and/or a quality of service (QOS) associated with the sidelink positioning method.

The sidelink positioning information in the first message may include a group identifier (ID) associated with the group of WTRUs. The request for SL-PRS resources in the second message may include the group ID. The sidelink positioning method may include at least one of round trip time (RTT) positioning, sidelink-time difference of arrival (SL-TDOA) positioning, and/or sidelink-angle of departure (SL-AoD) positioning.

The request for SL-PRS resources may include a request for SL-PRS transmission resources for the WTRU. The request for SL-PRS resources may include a request for SL-PRS transmission resources for other WTRUs in the group of WTRUs. The request for SL-PRS resources may include a number of SL-PRS transmission resources requested for the WTRU and/or a number of SL-PRS transmission resources requested for the other WTRUs in the group of WTRUs.

The second message may include a medium access control (MAC) control element (CE).

The processor further configured to perform a sidelink discovery procedure to identify the group of WTRUs.

The processor may be configured to transmit the first message and the second message to a node. The node may include at least one of network node, another WTRU, and/or a roadside unit (RSU).

At least one computer-readable storage medium may have executable instructions stored thereon. When executed by a processor the executable instructions may configure the processer to transmit a first message comprising sidelink positioning information associated with a group of WTRUs. The sidelink positioning information may comprise an indication of a sidelink positioning method for determining positions of the WTRUs in the group of WTRUs. The processor may transmit a second message comprising a request for sidelink positioning reference signal (SL-PRS) resources for the group of WTRUs. The processor may receive an indication of allocated SL-PRS resources for the group of WTRU. The processor may send an indication of the allocated SL-PRS resources to the group of WTRUs. The requested resources may be based, at least in part, on the sidelink positioning method, a number of WTRUs in the group of WTRUs, and/or a quality of service (QOS) associated with the sidelink positioning method.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A depicts an example system diagram illustrating an example communications system in which one or more disclosed embodiments may be implemented.

FIG. 1B depicts an example system diagram illustrating an example wireless transmit/receive unit (WTRU) that may be used within the communications system illustrated in FIG. 1A according to an embodiment.

FIG. 1C depicts an example system diagram illustrating an example radio access network (RAN) and an example core network (CN) that may be used within the communications system illustrated in FIG. 1A according to an embodiment.

FIG. 1D depicts an example system diagram illustrating a further example RAN and a further example CN that may be used within the communications system illustrated in FIG. 1A according to an embodiment.

FIG. 2 depicts an example illustration of round trip time (RTT) sidelink (SL) positioning, wherein a first WTRU, such as an anchor WTRU, may be indicated by a second WTRU, such as a target WTRU, to transmit a SL positioning reference signal (PRS) in one SL-PRS resource.

FIG. 3 depicts an example illustration of sidelink control information (SCI) location for shared and dedicated resource pools.

FIG. 4 depicts an example illustration of pattern based-physical sidelink control channel/physical sidelink shared channel (PSCCH/PSSCH) and sidelink-positioning reference signal (SL-PRS) multiplexing.

FIG. 5 depicts an example illustration of time-frequency-based PSCCH/PSSCH and SL-PRS multiplexing.

FIG. 6 depicts an example illustration of a PSCCH/PSSCH having an associated SL-PRS.

FIG. 7 depicts an example illustration wherein a WTRU has embedded SCI in a pattern.

FIG. 8 depicts an example illustration of potential scheduled and/or selected resources for SL positioning.

FIG. 9 depicts an example illustration of potential scheduled/selected resources for SL positioning, in which SL-PRS Transmission (Tx) resource is in the same slot with its indication.

FIG. 10 depicts an example illustration of downlink control information (DCI) for scheduling resources for SL positioning.

FIG. 11 depicts an example illustration of providing feedback of a SL positioning reference signal (SL-PRS) resource usage before a SL-PRS resource.

FIG. 12 depicts an example illustration of feeding back the SL-PRS resource usage after the SL-PRS resource.

FIG. 13 depicts an example illustration of SL-PRS scheduling for a group of user equipments (UEs), also referred to as WTRUs.

FIG. 14 depicts an example illustration of anchor WTRUs using orthogonal cover codes (OCCs) for one SL-PRS resource.

FIG. 15 depicts an example illustration of SL-PRS measurement report scheduling for a group of WTRUs.

FIG. 16 depicts an example illustration of semi-static resources for SL positioning.

FIG. 17 depicts an example illustration of overlapping between SL-PRS reception and SL communication resource pools.

FIG. 18 depicts an example illustration of SL-PRS and SL-PRS measurement reporting multiplexing among WTRUs in the group.

FIG. 19 depicts an example signal flow diagram for in-coverage round trip time (RTT) positioning.

FIG. 20 depicts an example signal flow diagram for WTRU-based in-coverage SL positioning.

FIG. 21 depicts an example flow diagram of SL positioning in which WTRU information is provided by an anchor WTRU or WTRUs.

FIG. 22 depicts an example flow diagram of in-coverage, SL positioning (WTRU-based), anchor WTRU information coming from the location management function (LMF), PRS configuration coming from the LMF to the target WTRU.

FIG. 23 depicts an example flow diagram of two-sided RTT SL positioning.

FIG. 24 depicts an example diagram depicting a WTRU obtaining and providing sidelink resources associated with a group of WTRUs.

FIG. 25 depicts another example diagram depicting a WTRU obtaining and providing SL resources associated with a group of WTRUs.

### DETAILED DESCRIPTION

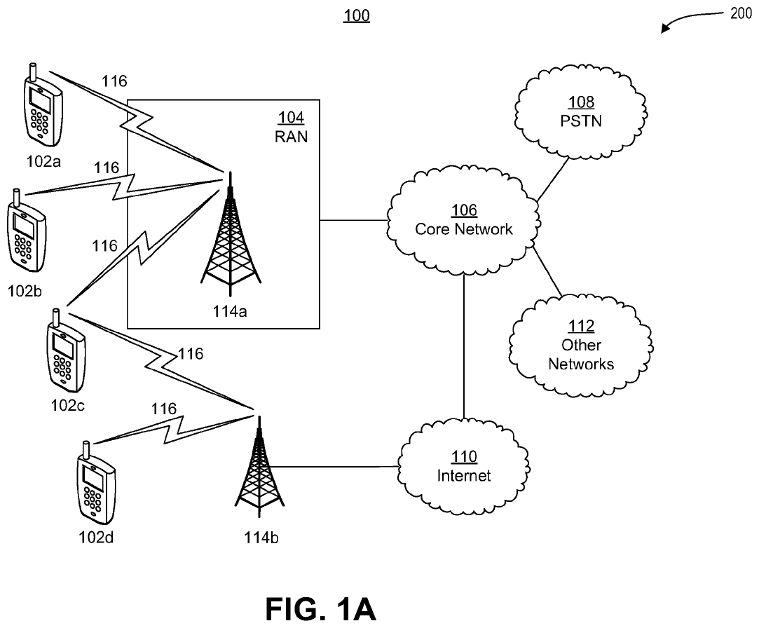

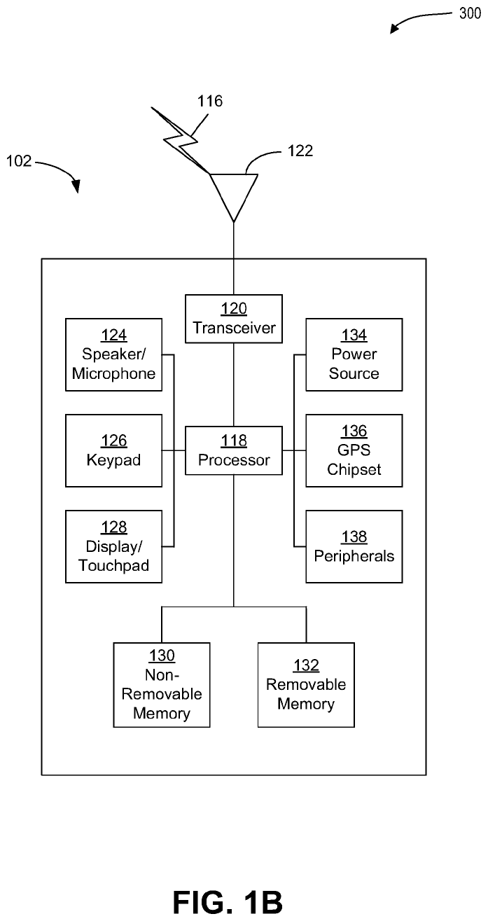

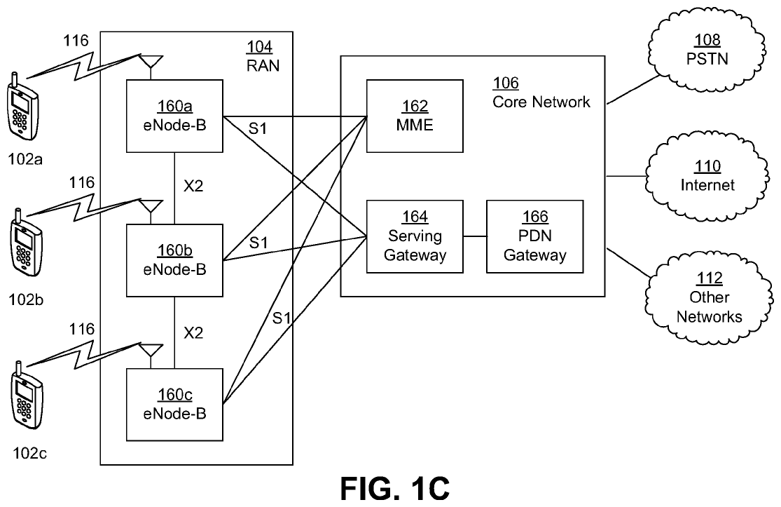

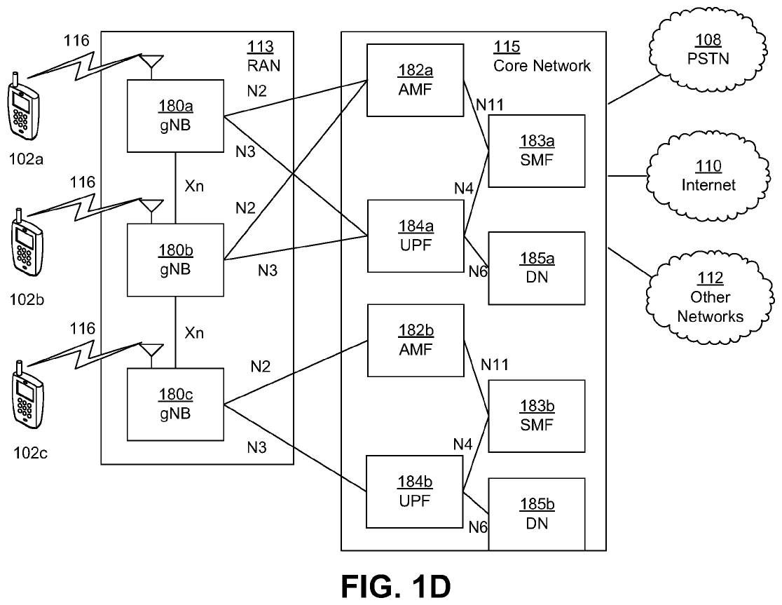

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11 af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHZ to 928 MHZ. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Wireless communication between one or more user equipments (UEs) and a network is considered herein. A WTRU may also be referred to as a wireless transmit/receive unit (WTRU). The terms UE and WTRU are used interchangeably herein.

Sidelink communications may support communications among different vehicles. Sidelink communications (e.g., transmission, reception, etc.) may be resourced in various manners. For example, a resource for sidelink transmission/reception may be structured as resource pools. Resource pools may comprise a set of continuous frequency resources repeating in time following a bitmap pattern. A WTRU may be configured via one or multiple resource pools. For in-coverage WTRUs (e.g., WTRUs within network coverage), a resource pool may be configured via a system information block (SIB), radio resource control (RRC), or the like, and/or any appropriate combination thereof. For out-of-coverage WTRUs (e.g., WTRUs not covered by a network), a resource pool may be pre-configured on the WTRU.

Each sidelink transmission may span within a slot comprising a physical sidelink shared channel (PSSCH), a physical sidelink control channel (PSCCH), and/or any appropriate combination thereof. PSSCH and PSCCH may utilize frequency domain multiplexing (FDM), time domain multiplexing (TDM), and/or any appropriate combination thereof.

Sidelink control information (SCI) may be divided into two parts. These two parts may be known as the first stage SCI and the second stage SCI. The first stage SCIs may indicate the resource used for sidelink transmission, the quality of service (QOS) of the transmission (e.g., priority), demodulation reference signal (DMRS), phase tracking reference signal (PTRS) used for the sidelink transmission, and the second SCI format, and/or any appropriate combination thereof. The second stage SCI may indicate the remaining control information. The SCI may be used to reserve the resource for future transmissions within a resource pool.

A sidelink resource may be scheduled by a network, referred to herein as Mode 1, and/or autonomously selected by a WTRU, referred to herein as Mode 2). If the WTRU performs Mode 2, it may perform sensing by decoding the SCI from other WTRUs before selecting the sidelink resources to avoid selecting the resources reserved by other WTRUs.

A sidelink channel state information reference signal (SL-CSI-RS) may be supported for unicast to support a transmitting WTRU (Tx WTRU) in determination of transmission (Tx) parameters (e.g., power and rank). A Tx WTRU may indicate the presence of a SL-CSI-RS by using SCI. A channel state information reference signal (CSI-RS) transmission may trigger channel state information (CSI) reporting. PC5-RRC may configure CSI reporting latency. Each reporting may be associated with one SL-CSI-RS transmission.

Positioning techniques (e.g., determining locations/positions of WTRUs) may be new radio (NR) universal mobile telephone system (UMTS), air interface positions, specified download (DL)-based, uplink (UL)-based, DL+UL-based, timing and/or angle based, round trip time (RTT) based, and/or any appropriate combination thereof. A geographical coordinate system (GCS), a local coordinate system, or the like, and/or any appropriate combination thereof may express the absolute position of a WTRU. The relative position of a WTRU (e.g., target WTRU) may be expressed in terms of distance, angle from another WTRU (e.g., anchor WTRU), a reference point with a known location, or the like, and/or any appropriate combination thereof.

In the DL-based positioning, downlink positioning reference signals (DL-PRSs) may be sent from multiple transmission/reception points (TRPs) to a WTRU. And, the WTRU may observe measure downlink signals from the TRPs. In an example, referred to herein as the WTRU-B method, the WTRU may calculate its position. In another example, referred to herein as the WTRU-A method, the WTRU may return the downlink measurement to the network. In another example, referred to herein as the angle-based method, the WTRU may report the angle of arrival (AoA) and reference signal receive power (RSRP) of the downlink signals from the TRPs. In another example, referred to herein as the timing-based method, the WTRU may report the reference signal time difference (RSTD). The above methods may depend upon the transmission timing synchronization among the TRPs. Positioning calculation errors may be a result of synchronization errors and multipath.

In the UL-based positioning (e.g., UL-based), a WTRU may send at least one uplink positioning reference signal (UL-PRS) for positioning, configured by RRC, to the TRP. The network may then calculate the position of the WTRU based on the coordination of all the TRPs receiving UL-PRS from the WTRU.

In the UL and DL-based methods (e.g., DL+UL-based), A WTRU may measure receive-transmit (Rx-Tx) time difference between a received DL-PRS and a transmitted UL-PRS. The Rx-Tx time difference and RSRP may be reported to the network. The network may then coordinate the TRPs to calculate the position of the WTRU.

Other example SL position methods may include timing/angle positioning and round trip time (RTT) positioning. Timing/angle positioning may refer to any positioning method that uses reference signals such as SL-PRS. The WTRU may receive multiple reference signals from WTRU(s) and may measure RSTD, RSRP, and/or AoA. Examples of angle/timing positioning may include angle of departure (SL-AoD) or sidelink-time difference of arrival (SL-TDOA) positioning. In another example, the WTRU may transmit SL-PRS to WTRU(s) and receiver performance measurements (e.g., RSTD, AoA, RSRP) for determination of the locations of the WTRU which transmitted SL-PRS.

RTT positioning may refer to any positioning method that requires two WTRUs to transmit SL-PRSs to each other. In an example, an anchor WTRU may transmit a SL-PRS to a target WTRU. Once the target WTRU receives the SL-PRS from the anchor WTRU, the target WTRU may transmit the SL-PRS to the anchor WTRU. The target WTRU may measure the WTRU Tx-Rx time difference which is the difference between transmission time of SL-PRS from the target WTRU and reception time of SL-PRS transmitted from the anchor WTRU. The target WTRU may report the WTRU Tx-Rx time difference to the anchor WTRU.

Sidelink positioning may be applicable to WTRUs covered by a network, partially covered by a network, out of coverage, and/or any appropriate combination thereof. Metrics used to express sidelink positions may include absolute positioning, relative positioning, and/or any appropriate combination thereof. In examples, sidelink positioning may be SL-PRS transmission-based, SL-PRS reception-based, round trip time (RTT)-based sidelink positioning, and/or any appropriate combination thereof. Regarding resource allocation for sidelink positioning, network scheduled resources, in which a network may perform resource allocation for sidelink resource for sidelink positioning, may be utilized. Supporting network scheduling resource allocation mode may allow the network to have full control the sidelink resources.

Regarding resource allocation for sidelink positioning, using the existing dynamic scheduling procedure may require each individual WTRU to request the sidelink resources for SL-PRS transmission and/or sidelink measurement reporting separately. Therefore, the existing dynamic scheduling procedure may require excessive signaling overhead especially for a large positioning group and/or the low latency positioning requirements. Moreover, the existing dynamic scheduling procedure may require the anchor WTRUs to be in the CONNECTED state during the sidelink procedure.

Also described herein are scheduling procedures for a group of WTRUs, such as a target WTRU and at least one anchor WTRU. Under these procedures, the group of WTRUs may perform sidelink positioning to reduce signaling overhead between a gNB and the WTRUs in the group.

Described herein are methods and systems for improving the existing scheduling procedure for a group of WTRUs (e.g., the target WTRU and/or the anchor WTRUs) to perform sidelink positioning to reduce signaling overhead between network entities (e.g., gNB, network nodes, server WTRU, WTRU with LMF capability, WTRU with capabilities to process measurements and determine location information of other WTRUs, WTRU with capabilities to configure SL-PRS to other WTRUs and/or servers, etc.) and/or the WTRUs in the group. An example of the server WTRU may be a WTRU which provide SL-PRS configurations to other WTRUs and/or receive measurement reports from WTRUs and determine location information of the other WTRUs based on the measurement reports. As described herein, positioning may be used for ranging without any limitation. Positioning may be referred to as a method/scheme to estimate a geographical location of a WTRU. Ranging may be referred to as a method/scheme to estimate a distance between WTRUs. The terms “positioning of a WTRU” and/or “location information of a WTRU” may be interchangeably used with “a distance between WTRUs.” Positioning of a WTRU and sidelink positioning may be applicable to ranging. Positioning of the WTRU may include absolute position which may include the coordinates and/or the zone ID, etc. Positioning of the WTRU may include the relative position which may include the range, distance, propagation time, RTT to another entity and/or node (e.g., another WTRU, roadside unit (RSU), positioning reference unit (PRU), gNB, and/or any appropriate combination thereof.

A WTRU, as described herein, may indicate any type of device such as an anchor WTRU, a target WTRU, an assistant WTRU, a server WTRU, a PRU, and/or a RSU, etc. In examples, the WTRU may be scheduled with one or more resources wherein the one or more resources may be used interchangeably with the WTRU. The WTRU may select the one or more resources.

Any solution applicable for the WTRU to select one or more resources may be used for the WTRU to request one or more resources from another node. Additionally or alternatively, any solution applicable for the WTRU to request one or more resources may be used for the WTRU to request one or more resources. For example, any triggering condition for the WTRU to select one or more resources may be used for the WTRU to request one or more resources from another node. Any triggering condition for the WTRU to request one or more resources from another node may be used for the WTRU to select one or more resources by itself.

As used herein the word scheduled may be used for the case that the resource may be determined by another entity (e.g., other than the WTRU itself). As used herein, the word select may be used for the case that the resource may be determined by the WTRU itself. However, any applicable solution described for the case of the WTRU being scheduled with a resource may be used interchangeably to the case of the WTRU doing its own resource selection.

The SL-PRS resource for one WTRU's reception (e.g., target WTRU) may be used interchangeably to the SL-PRS for other WTRU(s) (e.g., anchor WTRU(s)) transmission.

One resource may be used interchangeably with one set of resources. For example, one resource for SL-PRS transmission/reception may be used interchangeably with one set of resources for SL-PRS transmission/reception. The WTRU not performing SL-PRS reception in one SL-PRS resource may be equivalent to the WTRU noting obtain SL-PRS measurement result from the resource.

As used herein, the terms indicating, reporting, and/or transmitting a message to another WTRU may be used interchangeably with the terms indicating, reporting, and/or transmitting the message to another entity or node (e.g., gNB, and/or RSU, etc.). As used herein, a WTRU receiving a message from another WTRU may be used interchangeably with the WTRU receiving a message from any other node (e.g., gNB, and/or RSU, etc.). The SL-PRS reception time and/or duration may include the SL-PRS signal reception and/or the SL-PRS processing time after receiving the SL-PRS signal.

As used herein, the term SCI may be used interchangeably with the terms first stage SCI, second stage SCI, and/or both the first stage SCI and the second stage SCI. As used herein, the term SCI may be used interchangeably with the term PSCCH.

As used herein, a group of WTRUs may refer to one or more WTRUs. A positioning group may refer to a group of two or more WTRUs. A SL-PRS reception resource of one WTRU (e.g., target WTRU) may be used interchangeably with SL-PRS transmission of another WTRU (e.g., anchor WTRU). A SL-PRS Tx-based positioning method and/or SL-Rx based positioning method may be used interchangeably with SL-TDOA position method. A SL-TDOA method may be used to describe a timing-based positioning method in which the target WTRU may be the transmitter of SL-PRS only (e.g., UL-like SL-TDOA) and/or is a receiver of SL-PRS only (e.g., DL-like SL-TDOA).

A WTRU may use as a SL-PRS a DMRS of PSSCH and/or PSCCH, sidelink synchronization signals (SLSS), sidelink primary synchronization signal (S-PSS), sidelink secondary synchronization signal (S-SSS), a phase tracking reference signal (PTRS), a sidelink channel state information reference signal (SL-CSI-RS), a physical sidelink feedback channel (PSFCH), a reference signal (RS) designed for positioning purposes, or the like, and/or any appropriate combination thereof.

A WTRU may be configured and/or preconfigured. As used herein, the WTRU being prefigured and/or (pre-) configured may refer to the WTRU being preconfigured, the WTRU receiving the configuration from another entity, such as a node, gNB, another WTRU, or the like, and/or any appropriated combination thereof. In examples, a resource pool(s) for sidelink positioning may configure/preconfigure the WTRU.

One or any combination of the following resource pools for SL-PRS transmission/reception may configure/preconfigure the WTRU: one or more dedicated resource pools for SL-PRS transmission/reception, one or more shared resource pools with data for SL-PRS transmission/reception, one or more network scheduled resource pool dedicated for SL-PRS transmission/reception, one or more network scheduled resource pools for SL-PRS transmission sharing with sidelink data communication, one or more WTRU autonomous selection resource pools dedicated for SL-PRS transmission/reception, one or more WTRU autonomous selection resource pools for SL-PRS transmission sharing with sidelink data communication, one or more WTRU autonomous selection resource pools for sidelink communication to facilitate sidelink positioning, one or more network scheduled resource pools for sidelink communication to facilitate sidelink positioning, one or more resource pool(s) for sidelink communication having SL-PRS in transmissions with data communication, and/or any appropriate combination thereof.

A WTRU may configure itself for SL-PRS positioning and/or location determination. A WTRU may receive the configuration from another entity (e.g., another WTRU, a network node such as a gNB, and/or the like). The SL-PRS configuration may include any of the following either individually, or in any appropriate combination. The resource pool for SL-PRS transmission, reception, and/or sidelink measurement reporting; SL-PRS resource ID; SL-PRS sequence ID, or other IDs used to generate SL-PRS sequence; time-frequency of SL-PRS resource; SL-PRS resource element offset; SL-PRS resource slot offset; SL-PRS symbol offset

SL-PRS QCL information; SL-PRS resource set ID; list of SL-PRS resources in the resource set

Number of SL-PRS symbols; muting pattern for SL-PRS, muting parameters such as repetition factor, muting options; SL-PRS resource power; periodicity of SL-PRS transmission

The number of periods for SL-PRS transmission; spatial direction information of SL-PRS transmission (e.g., beam information, angles of transmission); spatial direction information of SL-RS reception (e.g., beam ID used to receive SL-RS, angle of arrival); frequency layer ID; WTRU ID and/or SL-PRS ID.

A WTRU may determine whether to multiplex sidelink control information (SCI) in one transmission with sidelink positioning referencing signals (SL-RPSs). In examples, the WTRU may determine whether to multiplex SCI with the SL-PRS in one transmission (e.g., the transmission having SCI and SL-PRS in the same slot, wherein the SCI may occur in the first serval symbols of the transmission).

The WTRU may determine whether to multiplex SCI with the SL-PRS based on the resource pool used for SL-PRS transmission. For example, the WTRU may determine to multiplex SCI with SL-PRS in one transmission if the WTRU uses a shared resource pool with sidelink data communication. Otherwise, if the WTRU uses a dedicated resource pool for SL-PRS transmission, the WTRU may not multiplex SCI with SL-PRS in one transmission.

A WTRU may determine whether to multiplex SCI with the SL-PRS based on the scheduling mode of the SL-PRS resource. For example, the WTRU may determine to multiplex SCI with SL-PRS in one transmission if the WTRU performs autonomous resource allocation for SL-PRS. Otherwise, if the SL-PRS is scheduled by the network, the WTRU may not need to multiplex SCI with SL-PRS.

A WTRU may determine whether to multiplex sidelink control information (SCI) in one transmission with sidelink positioning referencing signals (SL-RPSs) based on whether another WTRU indicates the resource. For example, the WTRU may determine whether to multiplex SCI in one SL-PRS transmission based on whether the WTRU itself selects the SL-PRS and/or another WTRU selects the SL-PRS. The WTRU may determine to multiplex SCI in the SL-PRS transmission if the WTRU autonomously selects the SL-PRS resource. Otherwise, if the another WTRU indicates the resource, the WTRU may not multiplex SCI in the SL-PRS transmission.

A WTRU may determine whether to multiplex sidelink control information (SCI) in one transmission with sidelink positioning referencing signals (SL-RPSs) based on the time/frequency location of the SL-PRS resource. For example, the WTRU may determine to multiplex SCI in the SL-PRS transmission if the SL-PRS resource is in the first several symbols of a slot. Otherwise, the WTRU may not multiplex SCI in the SL-PRS transmission if the SL-PRS is in the last several symbols of the slot. Such SL-PRS resource may be indicated by another WTRU.

A WTRU may determine whether to multiplex sidelink control information (SCI) in one transmission with sidelink positioning referencing signals (SL-RPSs). The WTRU may base this determination on whether the SL-PRS resource is an initial and/or a repeated SL-PRS resource in the same and/or different slot. For example, the WTRU may multiplex SCI for the initial SL-PRS transmission. Otherwise, for the repeated SL-PRS transmission in the same or future slot, the WTRU may not multiplex SCI. The SCI associated with the initial SL-PRS transmission may indicate the information associated with the repeated SL-PRS.

In examples, a WTRU may determine not to multiplex SCI with SL-PRS in one transmission in a network scheduled resource pool dedicated for SL-PRS transmission. The WTRU may determine to multiplex SCI with SL-PRS in one transmission in a WTRU autonomous selection resource pool sharing with sidelink data communication.

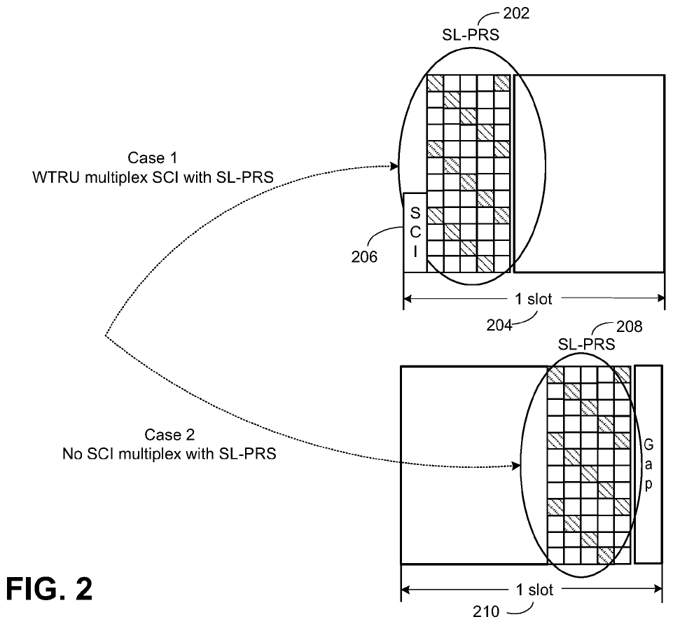

FIG. 2 depicts an example of an RTT-based sidelink positioning method, wherein a WTRU (e.g., anchor WTRU) may be indicated by another WTRU (e.g., target WTRU) to transmit SL-PRS in one SL-PRS resource. The anchor WTRU may determine whether to multiplex SCI with a SL-PRS based on whether the indicated resource is in the first several symbols of a slot or in the last several symbols of the slot. For example, if the indicated SL-PRS 202 is in the first several symbols of a slot 204 as depicted in Case 1 of FIG. 2, the WTRU may multiplex the SCI 206 with the SL-PRS 202. Otherwise, if the indicated SL-PRS 208 is in the last several symbols of a slot 210, the WTRU may not multiplex the SCI with the SL-PRS 208 as depicted in Case 2 of FIG. 2.

In examples, the WTRU may determine whether to multiplex SCI with SL-PRS based on whether there is any prior SL-PRS transmission in the same slot from a peer WTRU (e.g., for RTT-based positioning method). Specifically, if one or more prior SL-PRS from a peer WTRU exists in the slot, the WTRU may not multiplex SCI in with SL-PRS transmission. Otherwise, if no prior SL-PRS transmission from a peer WTRU exists in the slot, the WTRU may multiplex SCI in the SL-PRS transmission.

In examples, the WTRU may determine whether to multiplex SCI with SL-PRS based on whether there is any prior SL-PRS transmission in the same slot from a peer WTRU (e.g., for RTT-based positioning method). For example, if one or more prior SL-PRS from a peer WTRU exists in the slot, the WTRU may not multiplex SCI in with SL-PRS transmission. Otherwise, if no prior SL-PRS transmission from a peer WTRU exists in the slot, the WTRU may multiplex SCI in the SL-PRS transmission.

A WTRU may determine the time gap between initial transmission and retransmission of a SL-PRS. The WTRU may select resources for initial transmission and retransmission(s) of a SL-PRS. The WTRU may be (pre-) configured the minimum time gap between any two transmission of SL-PRS. The WTRU may then select resources for SL-PRS transmission to satisfy the (pre-) configured minimum gap. For example, the WTRU may be (pre-) configured, in a slot, with multiple SL-PRS resources in time domain. The WTRU may then select SL-PRS resources such that no two resources occupy in the same slot. This approach may reduce the half-duplex problem wherein the WTRU may not miss two SL-PRS reception if the WTRU prioritizes other sidelink transmission and/or reception in the same slot.

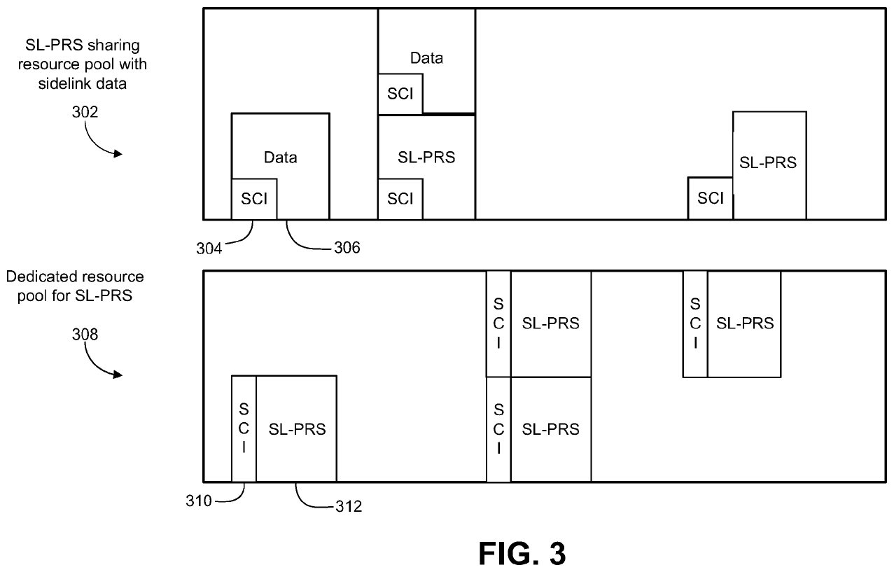

FIG. 3 depicts an example of SCI multiplexing with SL-PRS in a shared and dedicated resource pool. A WTRU may determine the location of the sidelink control information (SCI) in a transmission. For example, the WTRU may determine to multiplex SCI (e.g., the first stage SCI) with SL-PRS in one transmission. The WTRU may then determine the location of the SCI (e.g., the first stage SCI) in the transmission based on one or any combination of the following: The WTRU may determine the location of the SCI based on the resource pool used for transmission of SL-PRS. At 302, the WTRU may put SCI 304 associated with SL-PRS in the same location of a subchannel as SCI of other sidelink data 306 communication in a resource pool sharing with sidelink communication. At 308, the WTRU may place SCI (e.g., a first SCI) TDM with SL-PRS in a resource pool dedicated to SL-PRS. The SCI 310 may occupy only one first symbol 312 of the transmission.

A WTRU may determine the location of the SCI in a transmission based on the scheduling mode for SL-PRS. For example, the WTRU may put SCI associated with SL-PRS in the same location of a subchannel as SCI of other sidelink communication if the TRU autonomously selects SL-PRS. Otherwise, if the network schedules SL-PRS, the WTRU may place SCI (e.g., a first SCI) time division multiplexed (TDMed) with SL-PRS. In this case, the SCI may occupy only one first symbol of the transmission.

For each SL-PRS transmission, a WTRU may transmit an associated PSCCH and/or PSSCH to indicate the information of the SL-PRS (e.g., the SL-PRS pattern, QoS associated with the SL-PRS). The WTRU may determine the location (e.g., the time-frequency resources) of PSCCH and/or PSSCH to indicate the information of the associated SL-PRS. For example, the WTRU may determine the time-frequency resource to transmit PSCCH and/or the time-frequency resource to transmit PSSCH to indicate the information of the associated SL-PRS. The WTRU may transmit PSCCH and/or PSSCH associated with SL-PRS.

The WTRU may determine the location of PSCCH and/or PSSCH based one or any combination of the following information for SL-PRS: the SL-PRS pattern (e.g., the comb value, the number of symbols used, and/or RE offset pattern in each symbol, etc.). The WTRU may be (pre-) configured to multiplex multiple SL-PRS patterns in a time and/or frequency resource, in which each pattern may have one associated PSCCH and/or PSSCH. The WTRU may then determine which location to put PSCCH and/or PSSCH based on the pattern of the SL-PRS and/or the time-frequency location of the SL-PRS. The WTRU may have one PSCCH and/or PSSCH resource to indicate one or more SL-PRS patterns. In that instance, each SL-PRS pattern may be within a range of time and frequency resources. The WTRU may then indicate which SL-PRS pattern the WTRU transmits in the SCI which is transmitted in the associated PSCCH and/or PSSCH.

The WTRU may be (pre-) configured one PSCCH and/or PSSCH to indicate a SL-PRS pattern of up to M symbols. The WTRU may then indicate any SL-PRS transmission having duration from one to M symbols. This may help the WTRU indicate more SL-PRS patterns for one (pre-) configured PSCCH/PSSCH occasion.

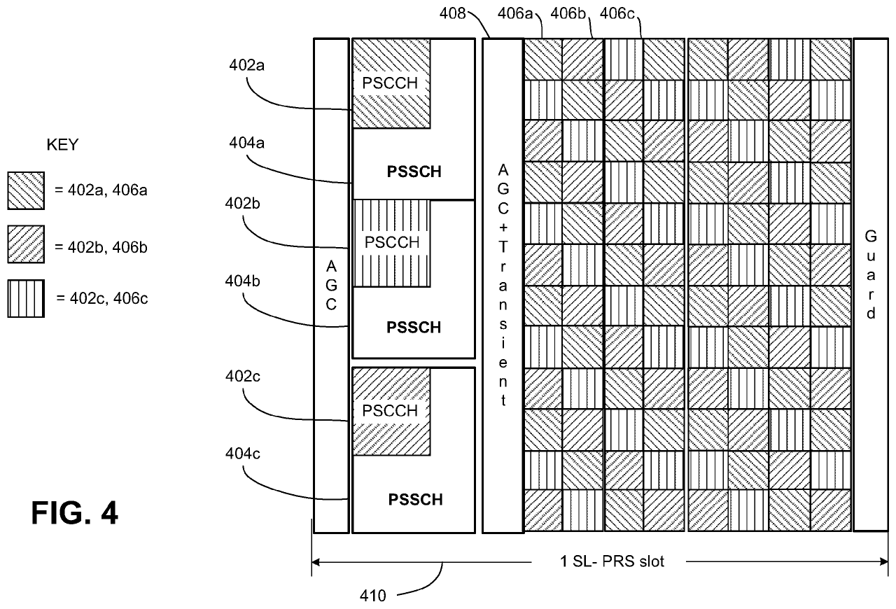

FIG. 4 depicts an example illustration of pattern based PSCCH and/or PSSCH and SL-PRS multiplexing. The WTRU may be (pre-) configured with three SL-PRS patterns in a slot, in which each SL-PRS pattern may have one associated PSCCH 402a-c and/or PSSCH 404a-c. The WTRU may then determine the location of the PSCCH 402a-c and/or PSSCH 404a-c based on the selected SL-PRS pattern. If the WTRU transmits in the first pattern 406a, the WTRU may transmit PSCCH 402a and/or PSSCH 404a in a first region (e.g., the first subchannel). If the WTRU uses the second pattern 406b, the WTRU may transmit in a second region (e.g., the second subchannel). If the WTRU selects the third pattern 406c, the WTRU may transmit PSCCH 402c and/or PSSCH 404c in the third region (e.g., the third subchannel). The WTRU may reserve a period for ACG and transient time 408 between PSCCH 402a-c and/or PSSCH 404a-c and SL-PRS 410. The transient time may be (pre-) configured in the resource pool, which may be the function of the SCS of the resource pool.

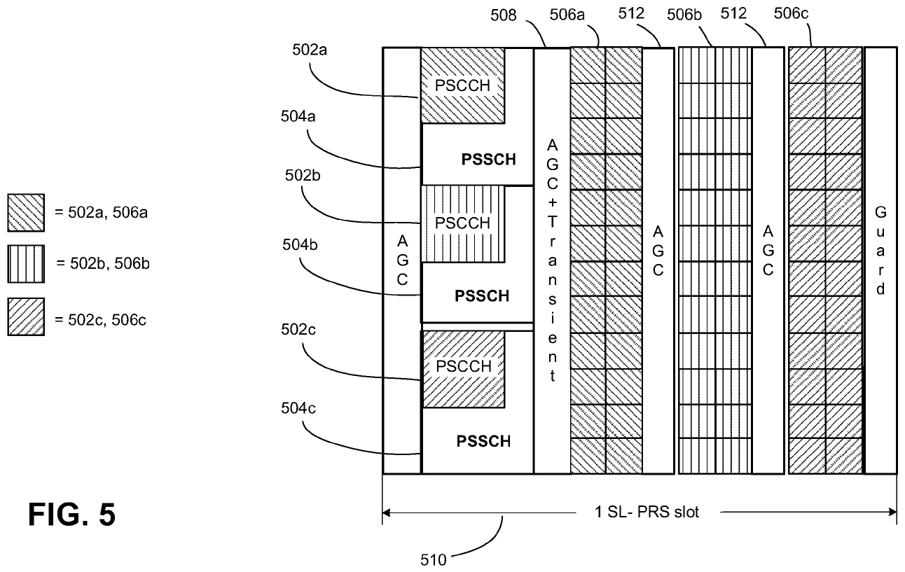

FIG. 5 depicts an example illustration of time-frequency-based PSCCH/PSSCH and SL-PRS multiplexing. In the examples shown in FIG. 5, the WTRU may be (pre-) configured with three time-locations of SL-PRS 510 in a slot, in which each SL-PRS location may have one associated PSCCH 502a-c and/or PSSCH 504a-c. The WTRU may then determine the location of PSCCH 502a-c and/or PSSCH 504a-c based on the selected SL-PRS 510 location. If the WTRU transmits in the first symbols 506a, the WTRU may need to transmit PSCCH 502a and/or PSSCH 504a in a first PSCCH/PSSCH region (e.g., the first subchannel). If the WTRU uses the second symbols 506b, the WTRU may transmit PSCCH 502b and/or PSSCH 504b in the second region (e.g., the second subchannel). If the WTRU selects the third symbols 506c, the WTRU may transmit PSCCH 502c and/or 504c PSSCH in the third region (e.g., the third subchannel). The WTRU may reserve a period for ACG and transient time 508 between PSCCH 502a-c and/or 504a-c PSSCH and SL-PRS 510. The transient time may be (pre-) configured in the resource pool, which may be the function of the SCS of the resource pool. The WTRU may put the ACG slot between SL-PRS patterns of different WTRUs.

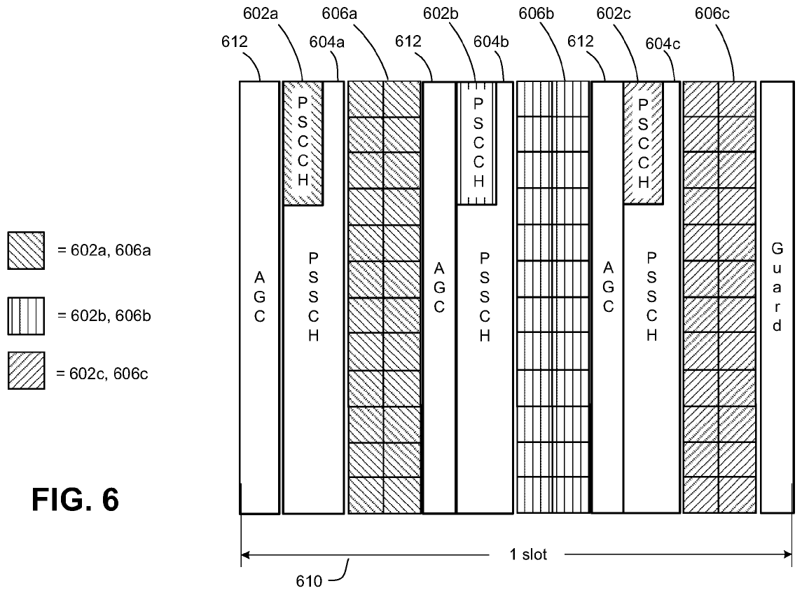

FIG. 6 depicts an example illustration of a PSCCH/PSSCH having an associated SL-PRS. In the example shown in FIG. 6, the WTRU may be (pre-) configured with three time-locations of SL-PRS 610 in a slot, in which each SL-PRS location may have one associated PSCCH 602a-c and/or PSSCH 604a-c. The WTRU may then determine the location of PSCCH 602a-c and/or PSSCH 504a-c based on the selected SL-PRS 610 location. If the WTRU transmits in the first symbols 606a, the WTRU may need to transmit PSCCH 602a and/or PSSCH 604a in a first PSCCH/PSSCH region (e.g., the first subchannel). If the WTRU uses the second symbols 606b, the WTRU may transmit PSCCH 602b and/or PSSCH 604b in the second region (e.g., the second subchannel). If the WTRU selects the third symbols 606c, the WTRU may transmit PSCCH 602c and/or 604c PSSCH in the third region (e.g., the third subchannel). The WTRU may reserve a period for ACG and transient time between PSCCH 602a-c and/or 604a-c PSSCH and SL-PRS 610. The transient time may be (pre-) configured in the resource pool, which may be the function of the SCS of the resource pool. The WTRU may put the ACG 612 slot between SL-PRS patterns of different WTRUs.

In examples, the WTRU may be (pre-) configured with multiple cyclic shifts to transmit one SL-PRS pattern, in which each cyclic shift may have an associated PSCCH and/or PSSCH location. The WTRU may determine the location of the PSCCH and/or PSSCH based on the cyclic shift the WTRU selected to transmit the associated SL-PRS.

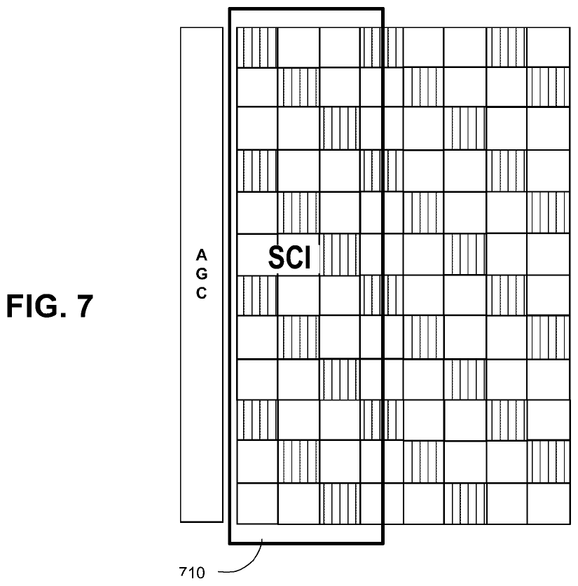

A WTRU may embed SCI in the SL-PRS pattern as depicted in FIG. 7. The WTRU may embed its SCI 710 in the pattern. The WTRU may be (pre-) configured a region (e.g., time-frequency) for SCI 710. The WTRU may then use the REs associated with the SL-PRS pattern in the (pre-) configured SCI region to convey SCI 710 information. The WTRU may then use the remaining to transmit SL-PRS. In one example shown in FIG. 5, the WTRU may use the first three symbols to convey SCI for a SL-PRS pattern.

A WTRU may determine the parameters for a SL-PRS transmission. A WTRU may determine one or any combination of the following parameters for SL-PRS transmission: the number of subchannels used for each SL-PRS resource, the number of symbols and/or slots used for each SL-PRS transmission resource, comb value, and/or the number of repetitions. The WTRU may determine one or any combination of these parameters based on the (pre-) configured transmission power parameters for SL-PRS transmission. In examples, the WTRU may perform SL-PRS in a maximum allowed bandwidth if the WTRU is allowed to transmit full power (e.g., no open loop power control (OLPC) is (pre-) preconfigured in the resource pool). Additionally or alternatively, the WTRU may perform SL-PRS in a smaller bandwidth if the WTRU is not allowed to transmit full power (e.g., OLPC is (pre-) configured in the resource pool). In examples, the WTRU may use Comb-1 (e.g., the WTRU transmits SL-PRS in all REs of the SL-PRS bandwidth) if OLPC is not configured in the resource pool. Otherwise, the WTRU may use Comb-N (e.g., N>1) if OLPC is configured in the resource pool.

Regarding the maximum number of subchannels allowed in the resource pool the WTRU may be (pre-) configured with a maximum number of subchannels to use for SL-PRS transmission. The WTRU may then perform SL-PRS transmission within the maximum allowed bandwidth.

A WTRU may determine which resource pool to transmit SL-PRS for sidelink positioning. The WTRU may determine which resource pool (e.g., which type of resource pool) for SL-PRS sidelink communication based on the QoS (e.g., latency, accuracy requirements) of the positioning service. The WTRU may use a sidelink resource pool requiring SL-PRS within sidelink data for low latency and/or low accuracy requirement sidelink positioning service. The WTRU may use a dedicated resource pool for SL-PRS for high accuracy and/or stringent latency requirements sidelink positioning services.

A WTRU may determine which SL-PRS configuration to use. For example, a WTRU may be (pre-) configured or receive multiple SL-PRS configurations. The WTRU may receive SL-PRS configuration from another WTRU, a gNB (e.g., via a RRC, SIB, and/or location management function (LMF), etc.), from a (pre-) configuration, or the like, and/or any appropriate combination thereof.

A WTRU may determine which SL-PRS configuration to use based on the (pre-) configured priority associated with each configuration or the predefined priority/precedence associated with each configuration. For example, the WTRU may prioritize the SL-PRS configuration indicated by a peer WTRU. The WTRU may then prioritize a SL-PRS configuration from SIB followed by (pre-) configured SL-PRS configuration. The WTRU may prioritize the SL-PRS configuration sent from the network via RRC. The WTRU may then prioritize SL-PRS configuration provided by another WTRU followed by SL-PRS configuration from SIB and then the (pre-) configured SL-PRS configuration. The WTRU may request another WTRU (e.g., anchor WTRU) to provide SL-PRS configuration instead of reading SIB. The WTRU may then prioritize using the SL-PRS received from the peer WTRU.

A WTRU may determine which SL-PRS configuration to use based on coverage status (e.g., whether the WTRU is in coverage or out of coverage). For example, if the WTRU is out of coverage, the WTRU may prioritize SL-PRS configuration received from the peer WTRU. If peer WTRU does not provide SL-PRS configuration, the WTRU may use the (pre-) configured SL-PRS configuration. If the WTRU is in coverage, the WTRU may prioritize any SL-PRS configuration provided by the network. The WTRU may then prioritize SL-PRS configuration from another WTRU. If there are no such SL-PRS configurations, the WTRU may use the (pre-) configured SL-PRS configuration.

A WTRU may prioritize the resource pool used by a peer WTRU. A WTRU may be (pre-) configured with multiple resource pools for SL-PRS transmission. The WTRU may determine which resource pool to select based on the priority and/or precedence of each resource pool. In examples, the WTRU may be (pre-) configured to two resource pools, wherein one resource pool is prioritized for use. The WTRU may use the prioritized resource pool for SL-PRS transmission. In examples, The WTRU may be (pre-) configured two type of resource pools for SL-PRS: a dedicated resource pool and a shared resource pool. The WTRU may prioritize a dedicated resource pool over a shared resource pool.

A WTRU may prioritize the resource pool based on the resource pool used by the peer WTRU. For example, the WTRU may prioritize the resource pool used by the peer WTRU for SL-PRS for its SL-PRS transmission.

A WTRU may determine which ID may generate/scramble the SL-PRS sequence. The WTRU may determine that a N_ID) may generate/scramble a SL-PRS sequence. The WTRU may use one or any combination of the following IDs to generate/scramble the SL-PRS sequence as N_ID, the group ID, the link ID, the destination ID, the source ID, a generated ID (e.g., from upper layer), or the like, and/or any appropriate combination thereof. The WTRU may indicate to the other WTRU (e.g., peer WTRU or group member) the ID to generate/scramble the SL-PRS sequence.

A WTRU may determine when to monitor a SL-PRS resource pool. The WTRU may trigger monitoring SL-PRS (e.g., monitor a dedicated resource pool for SL-PRS) based on whether a positioning group and/or a positioning session is established. The WTRU may start monitoring SL-PRS (e.g., start monitoring dedicated resource pool for SL-PRS) when the positioning session and/or the positioning group is established. The WTRU may stop monitoring SL-PRS (e.g., stop monitoring dedicated resource pool for SL-PRS) when the positioning session terminates and/or RLF is detected and/or indicated from another node.

A WTRU may receive the SL-PRS scheduling information from another node. For example, for the SL-PRS reception-based method, the WTRU may receive information regarding the SL-PRS resource for the group. The WTRU may then trigger monitoring dedicated SL-PRS resource pool based on the reception of SL-PRS scheduling information.

A WTRU may determine to transmit multiple SL-PRS in one slot, in which each SL-PRS may consist of M symbols. The WTRU may then perform SL-PRS repetition in one slot, in which the WTRU may transmit multiple SL-PRS, each of which consist of M symbols. The WTRU may then determine the number of repetition to transmit within a slot based on the number of symbols (pre-) configured for SL-PRS in one slot and the duration of each SL-PRS (i.e., the value of M). The WTRU may transmit SL-PRS until it fills all the symbols (pre-) configured for SL-PRS. In one example, the WTRU may perform one SL-PRS consisting of three symbols in a slot of nine symbols configured for SL-PRS. The WTRU may then repeat SL-PRS three times to fulfill the slot (pre-) configured for SL-PRS.

A WTRU may perform multiple transmission of one SL-PRS in a slot. The WTRU may use one PSCCH and/or PSSCH to indicate and/or reserve all transmission of SL-PRS in the slot. The WTRU may indicate the number of repetitions and the SL-PRS pattern associated with the SL-PRS transmission. This approach may be motivated to reduce the number of PSCCH/PSSCH transmitted in one slot to indicate multiple repetitions of SL-PRS.

A WTRU may be configured/preconfigured for sidelink positioning. The WTRU may receive configuration(s) of sidelink positioning from the network via broadcast (e.g., via SIB) or unicast (e.g., by an access stratum (AS) message (e.g., RRC) or a non-access stratum (NAS) message (e.g., location positioning protocol (LPP)). The WTRU may receive one or any combination of the following configurations for sidelink positioning: the resource pool(s) for sidelink communication to facilitate sidelink positioning, the resource pool(s) for SL-PRS transmission/reception, the positioning method, or any appropriate combination thereof. For example, the WTRU may be (pre-) configured via one resource pool for both SL-PRS and sidelink communication to facilitate sidelink positioning (e.g., sidelink transmission to indicate and/or reserve other sidelink transmission(s), SL-PRS measurement reporting, and/or SL-PRS resource usage reporting).

In examples, the WTRU may be (pre-) configured with two resource pools, wherein one resource pool may be used for sidelink communication to facilitate SL-PRS transmission and/or reception and another resource pool may be used for SL-PRS transmission and/or reception. When the WTRU is configured with two resource pools for sidelink positioning, the WTRU may use the sidelink communication resource pool.

A WTRU may determine whether the network (e.g., gNB, location management function (LMF), etc.) supports sidelink positioning. The WTRU (e.g., target WTRU) may determine whether the network supports sidelink positioning based on the availability of sidelink positioning SIB and/or the resource pools for SL-PRS transmission/reception in the SIB. the WTRU may use (pre-) configured resource pool(s) for sidelink positioning if the network does not support sidelink positioning. Additionally or alternatively, the WTRU may use the configured resource pool in the unicast/broadcast message (e.g., SIB, RRC, and/or LPP) if the network supports sidelink positioning.

A WTRU may determine the resource location mode for sidelink positioning. For example, a WTRU (e.g., target WTRU) may determine the resource allocation mode for sidelink positioning. The WTRU may determine whether to request resources from another node (e.g., the network or another WTRU) and/or perform autonomous resource allocation for sidelink positioning. The WTRU may determine the resource allocation mode for one or any combination of the following: the sidelink resource to indicate and/or request other resource(s) for sidelink positioning, SL-PRS transmission, SL-PRS reception, SL-PRS resource usage reporting and/or indication, and/or SL-PRS measurement report.

The resource allocation mode for each type of resource for sidelink positioning may be based on one or any combination of factors. For example, the resource allocation mode for each type of resource for sidelink positioning may be determined based on an indication from the network. The WTRU may request the network to provide service for sidelink positioning (e.g., via LPP and/or RRC). The network may then determine the resource allocation mode for one or more type of resource for sidelink positioning. The WTRU may request WTRU to perform autonomous resource allocation mode for SL-PRS transmission and/or reception. The WTRU may request WTRU to perform network scheduling mode for SL-PRS measurement reporting. The resource allocation mode for each type of resource for sidelink positioning may be based on the coverage status of each WTRU in the sidelink positioning group. For example, the WTRU (e.g., target WTRU) may perform network scheduled mode if the WTRU exists in the network coverage. Otherwise, if the WTRU exists out of coverage, the WTRU may perform autonomous resource allocation.

The WTRU (e.g., anchor WTRU) may perform network scheduled resource allocation if the WTRU exists in the network coverage. Otherwise, if the WTRU exists out of network coverage, the WTRU may receive scheduling information from another WTRU (e.g., a target WTRU) if the network supports and/or allows forwarding scheduling resources for sidelink positioning. The resource allocation mode for each type of resource for sidelink positioning may be based on whether the network supports and/or allows forwarding scheduling resources for sidelink positioning. For example, for out of coverage scenario, the WTRU may perform WTRU autonomous resource allocation if the network does not support and/or allow forwarding scheduling resources for sidelink positioning. Otherwise, if the network supports and/or allows forwarding scheduling resources for sidelink positioning, the WTRU may receive scheduling from another WTRU.

The resource allocation mode for each type of resource for sidelink positioning may be based on the RRC status of a WTRU. For example, the WTRU may perform autonomous resource allocation or receive scheduling from another WTRU if the WTRU exists in RRC Inactive and/or Ile status. Otherwise, if the WTRU exists in RRC Connected status, the WTRU may perform network scheduling resource allocation for sidelink positioning.

The resource allocation mode for each type of resource for sidelink positioning may be determined based on the role of the WTRU in sidelink positioning. For example, the WTRU may determine the resource allocation mode based on whether the WTRU is the target WTRU or the anchor WTRU. For in coverage scenarios, the WTRU may perform network scheduling mode if it is a target WTRU. Otherwise, if the WTRU is the anchor WTRU, the WTRU may receive scheduling from another WTRU (e.g., from a target WTRU).

A WTRU may determine a resource for sidelink positioning. For example, the WTRU may determine resource(s) (e.g., sidelink resource, uplink resource) for sidelink positioning. The resource(s) may be one or any combination of factors, including a sidelink resource to indicate and/or request other resource(s) for sidelink positioning. The indicated and/or reserved resource may be one or any combination of the following resources: SL-PRS transmission, SL-PRS reception, SL-PRS resource usage reporting/indication, SL-PRS measurement report, uplink resource(s) to indicate and/or report the usage of the scheduled sidelink resource for sidelink positioning, and/or any appropriate combination thereof.

The resource(s) may be sidelink resource(s) for SL-PRS transmission, SL-PRS reception, used to report the SL-PRS positioning measurement, and/or used to indicate and/or report the usage of the scheduled sidelink resources for sidelink positioning (e.g., the SL-PRS transmission, SL-PRS reception, and/or SL-PRS measurement reporting resources).

A WTRU may receive scheduled resource(s) for sidelink position. For example, a WTRU (e.g., target WTRU) may receive one or any combination of the following scheduled resources (e.g., sidelink resource and uplink resource), which may be from the network (e.g., gNB, LMF) or from another WTRU (e.g., an anchor WTRU) for sidelink positioning.

The sidelink transmission resource to indicate and/or reserve other resource(s) for sidelink positioning may include the resource for SL-PRS transmission, SL-PRS reception, SL-PRS resource usage reporting and/or indication, and/or SL-PRS measurement report. The message transmitted in this type of resource may be herein referred as a sidelink positioning requesting and/or a requesting message. The WTRU may use one or any combination of AS message (e.g., SCI, MAC control element (MAC CE), and/or PC5-RRC message) or NAS message (e.g., LTE positioning protocol (LPP) message) to indicate/reserve the resource(s) for the sidelink resource(s).

A WTRU may be scheduled a sidelink transmission resource to indicate the SL-PRS transmission resource. The sidelink transmission resource may occur in the same slot with the associated SL-PRS transmission resource. The WTRU may further use the scheduled sidelink resource to indicate the SL-PRS reception resource, and/or the associated SL-PRS measurement reporting resource. For example, the WTRU may use SCI to indicate the SL-PRS transmission if the scheduled sidelink transmission and its associated SL-PRS transmission occupy the same slot. Additionally or alternatively, the WTRU may use SCI, MAC CE, RRC, and/or NAS (e.g., LPP) to indicate the associated SL-PRS reception resource, and/or the associated SL-PRS measurement reporting resource, which may occur in different slot compared to the scheduled sidelink SL-PRS transmission resource.

A WTRU may schedule one sidelink transmission resource to indicate the SL-PRS transmission in another slot and/or resource. The WTRU may use any combination of the SCI, MAC CE, PC5-RRC, and/or NAS (e.g., LPP) to indicate the sidelink positioning resource (e.g., the SL-PRS transmission, SL-PRS reception, and/or the SL-PRS measurement reporting resource).

A WTRU (e.g., target WTRU) may receive one or more SL-PRS resources from the network (e.g., gNB or LMF) for SL-PRS transmission. In examples, a WTRU (e.g., anchor WTRU) may receive one or more SL-PRS resources from another WTRU (e.g., target WTRU) for SL-PRS transmission. The target WTRU may receive the SL-PRS resources from network (e.g., gNB or LMF). Additionally or alternatively, the target WTRU may perform autonomous resource selection for SL-PRS resources and/or indicate and/or forward them to the anchor WTRU(s).

A WTRU (e.g., target WTRU) may be indicated by the network the sidelink resource(s) for SL-PRS reception. The network may also schedule the same sidelink resource(s) for the anchor WTRU(s) to perform SL-PRS transmission.

A WTRU (e.g., target WTRU) may be indicated and/or scheduled by the network (e.g., gNB, LMF) the sidelink resource(s) for SL-PRS reception. The WTRU may then forward and/or indicate the scheduled SL-PRS reception resource(s) to the anchor WTRU(s) to perform SL-PRS transmission. The anchor WTRU(s) may then perform SL-PRS transmission in the indicated/forward SL-PRS resource(s) and the target WTRU may then perform SL-PRS reception in the SL-PRS resource(s).

In examples, a WTRU (e.g., anchor WTRU) may indicate another WTRU (e.g., target WTRU) the sidelink resource(s) for SL-PRS reception. The network may schedule SL-PRS resource(s) from the anchor WTRU. The anchor WTRU may autonomously select SL-PRS resource(s).

A WTRU may be scheduled a sidelink resource before the SL-PRS transmission and/or reception resource. The scheduled sidelink resource may indicate whether the WTRU performs SL-PRS transmission and/or reception in the scheduled SL-PRS resources.

A target WTRU may be indicated and/or scheduled two sidelink resources. The first resource may be used for SL-PRS reception (e.g., the sidelink resource for the anchor WTRU to perform SL-PRS transmission). The second sidelink resource may be used for the anchor WTRU to indicate whether the anchor WTRU performs SL-PRS transmission or not. The second resource may occur before the first resource. The anchor WTRU may then use the second resource to indicate whether it performs SL-PRS transmission or not.

A target WTRU may be indicated and/or scheduled two sidelink resources. The first resource may be used for SL-PRS transmission. The second resource may be used for the anchor WTRU to indicate whether the anchor WTRU performs SL-PRS reception or not (e.g., whether the WTRU performs SL-PRS measurement in the indicated resource or not). The second resource may occur before SL-PRS transmission resource. The anchor WTRU may then use the second resource to indicate whether the WTRU performs SL-PRS reception or not.

A WTRU may be scheduled a sidelink resource after the SL-PRS transmission and/or reception resource. The scheduled sidelink resource may indicate whether the WTRU performs SL-PRS transmission and/or reception in the scheduled SL-PRS resources.

A target WTRU may be indicated and/or scheduled two sidelink resources. The first resource may be used for SL-PRS reception (e.g., the sidelink resource for the anchor WTRU to perform SL-PRS transmission). The second sidelink resource may be used for the anchor WTRU to indicate whether the anchor performs SL-PRS transmission or not. The second resource may occur after the first resource. The WTRU may then determine whether to perform SL-PRS transmission in the first resource or not. The WTRU may use the second resource to indicate whether the WTRU performs the SL-PRS transmission in the first resource or not. For example, if the WTRU performs SL-PRS transmission in the first resource, the WTRU may indicate that it has transmitted SL-PRS in the first resource. Otherwise, if the WTRU deprioritizes the SL-PRS transmission in the first resource, the WTRU may indicate that it has not transmitted SL-PRS in the first resource.

A target WTRU may be indicated and/or scheduled two sidelink resources. The first resource may be used for SL-PRS transmission, and the second resource may be used for the anchor WTRU to indicate whether the anchor WTRU performs SL-PRS reception or not (e.g., whether the WTRU performs SL-PRS measurement in the indicated resource or not). The second resource may occur after SL-PRS transmission resource. The anchor WTRU may then use the second resource to indicate whether the WTRU performs SL-PRS reception or not. For example, if the WTRU performs SL-PRS reception and/or measurement in the first SL-PRS resource, the WTRU may indicate that it has performed SL-PRS reception in the second resource. Otherwise, if the WTRU deprioritizes SL-PRS reception in the first resource, the WTRU may indicate that it has not performed SL-PRS reception in the second sidelink resource.

A WTRU (e.g., target WTRU) may be scheduled and/or indicated two sidelink resources in which one resource may be used for its own SL-PRS transmission and another sidelink resource may be used for SL-PRS measurement reporting. The anchor WTRU may use the sidelink resource used for SL-PRS measurement reporting to perform such report. SL-PRS transmission-based positioning may employ this method. In the SL-PRS transmission-based positioning method, the target WTRU may perform SL-PRS transmission and/or receive the measurement report from the anchor WTRU(s).

A WTRU (e.g., target WTRU) may be indicated and/or scheduled two sidelink resources (e.g., from an anchor WTRU). The target WTRU may use the first resource to perform SL-PRS reception. The target WTRU may use the second resource to perform SL-PRS measurement reporting. This approach may be used for The Network-Initiated Location Request (NI-LR) sidelink positioning method may employ this approach. In the NI-LR, the network may indicate and/or request an anchor WTRU to locate the target WTRU.

A WTRU (e.g., target WTRU) may be indicated/scheduled three sidelink resources (e.g., from gNB, LMF), in which the first two resources may be used for SL-PRS transmission and SL-PRS reception and the third resource may be used for reception of SL-PRS measurement reporting (e.g., Tx-Rx difference report from an anchor WTRU). This approach may be used for Round Trip Time (RTT) sidelink positioning method, in which the target WTRU may perform SL-PRS transmission, reception, and SL-PRS measurement report reception.

A WTRU (e.g., target WTRU) may be indicated and/or scheduled three sidelink resources (e.g., from gNB and/or LMF), in which the first two resources may be used for SL-PRS transmission and SL-PRS reception and the third resource may be used for transmission of SL-PRS measurement reporting (e.g., Tx-Rx difference report from the target WTRU). Round Trip Time (RTT) sidelink positioning may employ this method In RTT, the target WTRU may perform SL-PRS transmission, reception, and/or SL-PRS measurement report transmission. The target WTRU may transmit the SL-PRS measurement report (e.g., Tx-Rx difference from the target WTRU which is the time difference between the transmission of SL-PRS from the target WTRU and reception time of SL-PRS from an anchor WTRU) to one of the anchor WTRU(s). The target WTRU may receive an indication and/or configurations from the network and/or an anchor WTRU which directs where the target WTRU may transmit its report. Additionally or alternatively, the target WTRU may transmit the SL-PRS measurement report to the network (e.g., LMF and/or gNB).

The uplink resource(s) used to indicate and/or report the usage of the scheduled sidelink resources for sidelink positioning may include any combination of the following factors: the WTRU may be scheduled one uplink resource after one or more scheduled SL-PRS transmission, SL-PRS reception, and/or SL-PRS measurement reporting resources to indicate and/or report the usage of the scheduled sidelink resources. The WTRU may indicate whether to use the scheduled sidelink resources for sidelink positioning. For example, the WTRU may indicate whether the scheduled sidelink resources for SL-PRS transmission, reception, and/or SL-PRS measurement reporting are used. The WTRU may indicate and/or report whether the WTRU properly receives SL-PRS measurement report from another WTRU (e.g., the anchor WTRUs) in the scheduled sidelink resource. The WTRU may indicate and/or report whether the WTRU needs more sidelink resources for sidelink positioning.

The uplink resource(s) for sidelink positioning reporting (e.g., sidelink positioning and/or Uu positioning reporting). For example, the WTRU may be scheduled with uplink resource to perform sidelink positioning reporting. The sidelink positioning reporting may be the sidelink positioning measurement reporting and/or the relative location of the WTRU (e.g., target WTRU) to other WTRU(s) (e.g., anchor WTRUs).

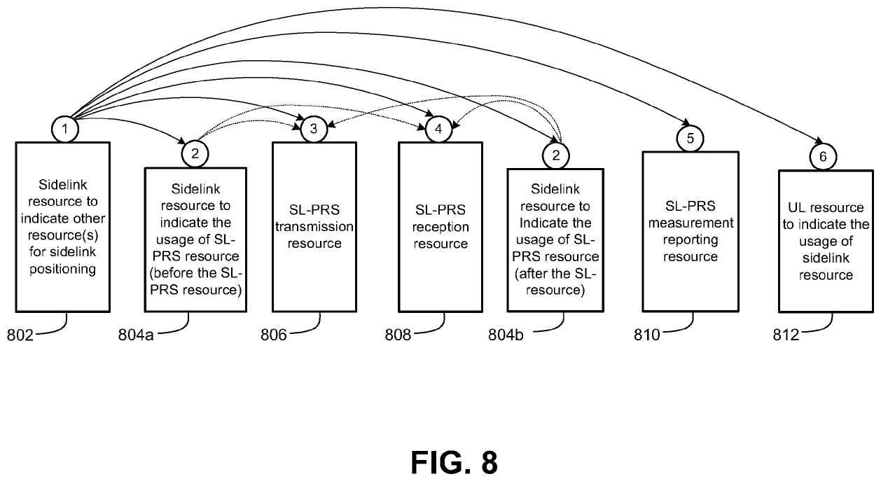

FIG. 8 depicts an example illustration of potential scheduled and/or selected resources for sidelink positioning. As shown in FIG. 8, the sidelink resource may indicate and/or reserve other resources for sidelink communication (e.g., the resource(s) for SL-PRS transmission, SL-PRS reception, SL-PRS resource usage reporting/indication, and/or SL-PRS measurement report), occupies a different slot than the SL-PRS transmission resource. In this example, the WTRU (e.g., target WTRU) may be scheduled one or any combination of six types of resources for sidelink positioning. The first type of resource 802 (e.g., resource with index 1) may indicate implicitly and/or explicitly one or any combination of the remaining types of resources. The second type of resource 804a-b (e.g., resource with index 2) may (e.g., by the anchor WTRU) indicate the SL-PRS resource usage. The second type of resource 804a-b may occur before (804a) or after (804b) SL-PRS transmission and/or reception. The third and fourth types of resources 806 and 808 (e.g., the resources with index 3 or 4) may be used (e.g., by the target WTRU) for SL-PRS transmission and reception, respectively. The fifth type of resource 810 (e.g., the resource with index 5) may (e.g., by the anchor WTRU) report SL-PRS measurement. Finally, the sixth type of resource 812 (e.g., the resource with index 6), which may be the UL resource, may (e.g., by the target WTRU) indicate the sidelink resource usage for sidelink positioning.

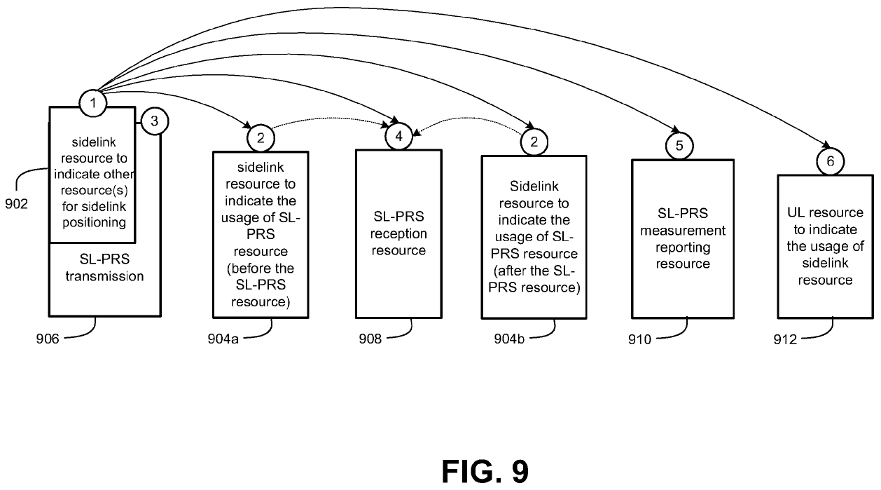

FIG. 9 depicts an example of potential scheduled/selected resources for sidelink positioning, in which SL-PRS transmission resource 906 is in the same slot with its indication 902. The sidelink resource used to indicate and/or reserve other resources for sidelink communication may transmit the same slot and/or resource with the SL-PRS transmission. In this example, the second type of resource 904a-b (e.g., resource with index 2) may (e.g., by the anchor WTRU) indicate the SL-PRS resource usage (e.g., whether the WTRU performs SL-PRS transmission and/or reception of the resource with index 3 or 4 at 906 and 908, respectively). The second type of resource 904a-b may occur before (904a) or after (904b) SL-PRS reception resource 908. Similar to the example shown in FIG. 8, the fifth type of resource 910 may report SL-PRS measurement. The sixth type of resource 912 may indicate the sidelink resource usage for sidelink positioning.

A WTRU (e.g., target WTRU) may determine the positioning method for the positioning group. For example, the WTRU may determine one or any combination of sidelink positioning methods, including SL-PRS transmission-based method, SL-PRS reception-based method, and/or sidelink RTT-based method.

Based on the determined positioning method, the WTRU (e.g., target WTRU) may further request other WTRU(s) (e.g., the anchor WTRU(s) to perform SL-PRS transmission. For example, the WTRU may determine to perform SL-PRS reception-based sidelink positioning method. The WTRU may then request the anchor WTRU(s) to perform SL-PRS transmission.

Based on the determined positioning method, the WTRU (e.g., target WTRU) may further determine to request other WTRU(s) (e.g., the anchor WTRU(s) to perform SL-PRS reception. For example, the WTRU may determine to perform SL-PRS transmission-based sidelink positioning method. The WTRU may then request the anchor WTRU(s) to perform SL-PRS reception.

Based on the determined positioning method, the WTRU (e.g., target WTRU) may further determine to request other WTRU(s) (e.g., the anchor WTRU(s) to perform both SL-PRS transmission and/or reception. The WTRU may determine to perform SL RTT-based positioning method. The WTRU may then request the anchor WTRU(s) to perform both SL-PRS transmission and/or reception. Based on the determined positioning method, the WTRU (e.g., target WTRU) may further determine to request other WTRU(s) (e.g., the anchor WTRU(s)) to perform SL-PRS measurement reporting.

The WTRU may request the anchor WTRUs to report different measurement parameters based on the selected sidelink positioning method. The WTRU may request the anchor WTRU(s) to report reference signal time difference (RSTD), time of arrival (ToA), angle of arrival (AoA), phase of arrival (PoA), difference phase of arrival (DPoA), and/or SL-RSRP of the SL-PRS transmitted from the target WTRU for SL-PRS transmission-based method. The WTRU may request the anchor WTRU to report time of departure (ToD), angle of departure (AoD), phase of departure (PoD), and/or difference phase of departure (DPoD) of the SL-PRS for SL-PRS reception-based sidelink positioning method. The WTRU may request the anchor WTRU to report Tx-Rx difference, SL-RSRP, TOD, AoD, ToA, TOD, PoA, POD, DPOA, RSTD and/or DPoD for the RTT-based sidelink positioning method.

The WTRU may determine the positioning method for the sidelink positioning group based on one or any combination of the following factors, including the scheduled sidelink resources (e.g., SL-PRS resource and/or SL-PRS measurement reporting resource) from the network (e.g., gNB and/or LMF). The WTRU may receive the scheduled sidelink resource from the AS and/or NAS messages. The AS and/or NAS messages may include one or any combination of DCI, DL MAC CE, RRC, and/or LPP messages.

If the scheduled resources have both SL-PRS transmission and SL-PRS reception resources, the WTRU may perform RTT-based sidelink positioning. If the scheduled resources have SL-PRS transmission resources, the WTRU may perform SL-PRS transmission-based method. If the scheduled resources have SL-PRS reception resources, the WTRU may perform SL-PRS reception-based method.

A WTRU may determine the position method based on the set of SL-PRS scheduled by the network. The WTRU (e.g., target WTRU) may determine the positioning method for the group. The WTRU may indicate the determined position method to the WTRUs in the group. The WTRU may determine which position method to use for the sideline positioning group based on one or any appropriate combination of the following factors: the set of scheduled SL-PRS resources scheduled by the network (e.g., the number of SL-PRS resources), the number of anchor WTRUs to transmit SL-PRS and/or the property of the scheduled SL-PRS resources. The number of anchor WTRUs to transmit SL-PRS and/or the property of the scheduled SL-PRS resources may include the time gap between the first and the last SL-PRS resources and/or the time gap between two resources, etc.

The WTRU may determine to perform SL-PRS SL-TDOA if the number of resources is smaller than two times the number of anchor WTRUs. The WTRU may determine to perform the RTT method if the number of SL-PRS resources is higher than two times the number of anchor WTRUs.

The WTRU may determine to perform UL-like SL-TDOA positioning method if the time gap between the first and the last SL-PRS resources is smaller than a threshold. The WTRU may determine to perform RTT method if the time gap between a pair of SL-PRS resources is smaller than a threshold.

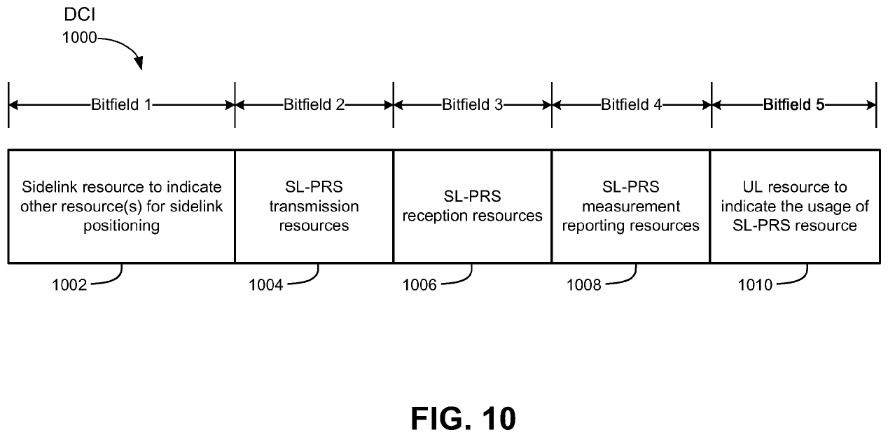

FIG. 10 depicts an example illustration of downlink control information (DCI) for scheduling resources for sidelink positioning. As shown in FIG. 10, in one resource scheduling message (e.g., a DCI 1000) the WTRU may be indicated one or any combination of the bitfields to decode one type of resource. The combination of the bitfields may include sidelink resource(s) for indicating and/or reserving resource(s) for sidelink positioning 1002, sidelink resource(s) for SL-PRS transmission 1004, sidelink resource(s) for SL-PRS reception 1006, sidelink resource(s) for SL-PRS measurement reporting 1008, and/or uplink resource(s) for reporting the usage of the scheduled SL-PRS resource(s) in uplink.

The WTRU may be (pre-) configured one value and/or codepoint in each bitfield to indicate the unavailability of each type of resource in the scheduled message. The WTRU may then determine whether there is a scheduled resource(s) in each bitfield and/or any combination of bitfields for each type of resource in the scheduled message. In examples, in a scheduled message, the WTRU may determine that there are both SL-PRS transmission and reception resources. The WTRU may then determine to perform RTT-based sidelink positioning method. In examples, in a scheduled message, the WTRU may determine that there is SL-PRS transmission (e.g., there is no SL-PRS reception resource). The WTRU may then determine to perform SL-PRS transmission-based sidelink positioning method. In examples, in a scheduled message, the WTRU may determine that there is SL-PRS reception (e.g., there is no SL-PRS transmission resource). The WTRU may then determine to perform SL-PRS reception-based sidelink positioning method.

The WTRU (e.g., target WTRU) may be (pre-) configured with multiple resource scheduling formats (e.g., multiple DCI formats). Each format may contain one or more types of resources for sidelink positioning. One type of resource for sidelink positioning may be the sidelink resource(s) for indicating/reserving resource(s) for sidelink positioning, sidelink resource(s) for SL-PRS transmission, sidelink resource(s) for SL-PRS reception, sidelink resource(s) for SL-PRS measurement reporting, and/or uplink resource(s) for reporting the usage of the scheduled SL-PRS resource(s) in uplink.

The WTRU may then decode (e.g., via RRC) one DCI format for one or more types of resources for sidelink positioning. The WTRU may decode one DCI format for SL-PRS transmission-based method, in which the WTRU may decode a DCI format scheduling sidelink resource for SL-PRS transmission and sidelink resource for SL-PRS measurement reporting. The WTRU may decode one DCI format for SL-PRS reception-based method. The WTRU may decode a DCI format scheduling sidelink resource for SL-PRS reception. The WTRU may decode one DCI format for SL-PRS transmission-based method. The WTRU may decode a DCI format scheduling sidelink resource for SL-PRS transmission and/or sidelink resource for SL-PRS measurement reporting.

The WTRU may be (pre-) configured with different scrambling code (e.g., radio network temporary identifier—RNTI) for different types of resource allocation for sidelink positioning. The WTRU may determine which type of resource allocation for sidelink positioning based on the decoded scrambling code. For example, the WTRU may be (pre-) configured (e.g., via RRC) three scrambling codes, with one scrambling code used for DCI scheduling SL-PRS transmission, SL-PRS reception, and/or SL-PRS measurement reporting. Another scrambling code may be used for SL-PRS reception. Another scrambling code may be used for SL-PRS transmission.

The WTRU may be (pre-) configured two scrambling codes (e.g., via RRC). One scrambling code may be used for dynamic SL-PRS transmission, SL-PRS reception, and/or SL-PRS measurement reporting. Another scrambling code may be used for semi-static SL-PRS transmission, SL-PRS reception, and/or SL-PRS measurement reporting.

The WTRU may be (pre-) configured one or more resource scheduling formats (e.g., DCI format). Each format may contain one or more types of resources for sidelink positioning. The WTRU may then determine the resource scheduling format based on the format indicator in the message. The message may implicitly indicate the sidelink positioning method to use. For example, the WTRU may be configured three resource scheduling formats. Each format may be associated with one sidelink positioning method including SL-PRS transmission-based, SL-PRS reception-based, and/or sidelink RTT-based.

A WTRU may determine whether the DCI is for SL-PRS, or data transmission based on RNTI. For example, the WTRU may be (pre-) configured with different scrambling codes (e.g., RNTI) for different type of DCIs. One type of DCI may be used for scheduling SL-PRS transmission and/or reception and another type of DCI may be used for scheduling normal data transmission. The WTRU may then determine whether to use DCI for SL-PRS scheduling and/or normal data scheduling based on the associated RNTI.

A WTRU may determine whether the DCI is for SL-PRS and/or data transmission based on a search space set. For example, the WTRU may be (pre-) configured with different search space sets for different type of DCIs. One search space set may be used for DCI scheduling SL-PRS transmission/reception and another search space set may be used for DCI scheduling normal sidelink data transmission.

A WTRU may determine whether the DCI is for SL-PRS and/or data based on the indicated codepoint in a bitfield. For example, the WTRU may be configured with one bitfield in DCI. One codepoint may be used for SL-PRS scheduling and another codepoint may be used for normal data scheduling. The WTRU may then determine whether the DCI is used for SL-PRS transmission/reception or sidelink data based on the codepoint indicated in DCI.

A WTRU may determine the DCI for SL-PRS based on an indication in the DCI. The WTRU may be configured with a one bit indicator in the DCI. The bit indicator may explicitly indicate whether the DCI is used for scheduling SL-PRS or not. The WTRU may use the scheduled SL-PRS transmission in the DCI. The DCI may indicate that the resource is used for SL-PRS. Otherwise, the WTRU may not use the resource for SL-PRS.

A WTRU may determine whether the DCI for SL-PRS based on an indication in the DCI. The WTRU may be configured with a one bit indicator in the DCI in which the bit indicator may explicitly indicate whether the DCI is used for scheduling SL-PRS or not. The WTRU may use the scheduled SL-PRS transmission in the DCI. The DCI may indicate that the resource is used for SL-PRS. Otherwise, the WTRU may not use the resource for SL-PRS.

A WTRU may determine whether to transmit data and/or SL-PRS in a scheduled sidelink resource. The WTRU may be scheduled a sidelink resource (e.g., in a shared resource pool between SL-PRS and data). The WTRU may perform resource selection to select a sidelink resource. The WTRU may determine whether to transmit SL-PRS and/or sidelink data in the scheduled/selected resource based on one or any combination of the following factors, including the priority associated with the SL-PRS, the priority of the data, the relative priority between SL-PRS and sidelink data.

The WTRU may determine whether to transmit SL-PRS and/or sidelink data in the scheduled/selected resource based on the property of the scheduled sidelink resources (e.g., number of retransmission and/or repetitions, the bandwidth of the resources, the time-gap between the first and the last resources, the time-gap between two consecutive resources, etc.). For example, the WTRU may determine whether to put SL-PRS in a sidelink resource based on the property of the scheduled/selected sidelink resource. The WTRU may transmit SL-PRS having bandwidth being greater than a (pre-) configured threshold, and/or the number of repetition being greater than a (pre-) configured threshold. If the (pre-) configured conditions are satisfied, the WTRU may prioritize transmitting SL-PRS. Otherwise, if the (pre-) configured condition are not satisfied, the WTRU may not transmit SL-PRS. The WTRU may then transmit sidelink data. If the (pre-) configured conditions are satisfied, the WTRU may determine whether to transmit SL-PRS and/or sidelink data based on the relative priority between SL-PRS. The WTRU may transmit the one having higher priority.

The WTRU may determine whether to transmit SL-PRS and/or sidelink data in the scheduled/selected resource based on the destination associated with the data in the buffer. For example, when the WTRU puts SL-PRS in the sidelink resource, the WTRU may put sidelink data to the sidelink resource to transmit SL-PRS with the data. The WTRU may be (pre-) configured with a set of destination IDs to multiplex with the SL-PRS. For unicast SL-PRS, the WTRU may transmit data with SL-PRS if both data and/or SL-PRS target the same WTRU. The WTRU may transmit data with SL-PRS if the receiver of SL-PRS receives sidelink data. For groupcast SL-PRS, the WTRU may transmit data with SL-PRS if the receiver of sidelink data receives SL-PRS.

The WTRU may determine whether to transmit SL-PRS and/or sidelink data in the scheduled/selected resource based on the destination associated with SL-PRS. For example, when the WTRU determines to put sidelink data in the sidelink resource, the WTRU may determine to opportunistically put SL-PRS to the sidelink resource to transmit SL-PRS with data. For each destination ID associated with sidelink data, the WTRU may be (pre-) configured with a set of destination IDs associated with SL-PRS to multiplex with the sidelink data. For unicast sidelink data, the WTRU may transmit data with SL-PRS if both data and SL-PRS target the same WTRU. In another approach, the WTRU may transmit data with SL-PRS if the receiver of sidelink data receives SL-PRS. For groupcast sidelink data, the WTRU may transmit data with SL-PRS if the receiver of SL-PRS receives sidelink data. For broadcast sidelink data, the WTRU may transmit SL-PRS with sidelink data if both sidelink data and/or SL-PRS have the same destination ID (e.g., the same broadcast service).

The WTRU may determine whether to transmit SL-PRS and/or sidelink data in the scheduled/selected resource based on cast type associated with SL-PRS and/or sidelink data. In examples, if the WTRU determines to transmit SL-PRS in a sidelink resource, the WTRU may determine to multiplex sidelink data in the resource based on the cast type associated with the SL-PRS and/or the cast type associated with sidelink data. If the WTRU determines to transmit SL-PRS using broadcast, the WTRU may transmit sidelink data if the sidelink data is broadcast. The WTRU may transmit broadcast sidelink data if they belong to the same service. If the WTRU determines to transmit SL-PRS using groupcast, the WTRU may transmit sidelink data if sidelink data target the same group. If the WTRU determines to transmit sidelink data in a sideink resource, the WTRU may determine to multiplex SL-PRS in the resource based on the cast type associated with the SL-PRS and/or the cast type associated with sidelink data. If the WTRU determines to transmit sidelink data using unicast, the WTRU may transmit SL-PRS if both SL-PRS and/or data target the same receiver.

The WTRU may determine whether to transmit SL-PRS and/or sidelink data in the scheduled/selected resource based on a (pre-) configured restriction. For example, the WTRU may be (pre-) configured to multiplex SL-PRS with sidelink data in one transmission in the resource pool. In one (pre-) configuration, the WTRU may not allow SL-PRS to multiplex with sidelink data. In another (pre-) configuration, SL-PRS may be multiplexed with sidelink data.

The WTRU may determine whether to put data or SL-PRS in the resource first based on the priority associated with the data and/or the priority associated with the SL-PRS. For example, the WTRU may put the one with higher priority first. If SL-PRS and/or data have the same priority, the WTRU may prioritize one (pre-) configured precedence (e.g., either data or SL-PRS).

WTRU scheduling may be based on a group common DCI for SL-PRS. For example, the WTRU may be (pre-) configured to monitor a group common DCI (e.g., DCI for a group of WTRUs) and/or the scheduling for SL-PRS transmission and/or reception for a group of WTRUs. The WTRU may then receive DCI scheduling a group of SL-PRS resources for the group of WTRUs.

The WTRU may determine the receiver and/or transmitter of each scheduled SL-PRS resource based on the role of the WTRU in the group (e.g., whether the WTRU is the target WTRU or the anchor WTRU), based on the position method (e.g., whether the positioning method may be SL-PRS transmission-based, SL-PRS reception-based, and/or RTT-based), based on the sequence of SL-PRS transmission and/or reception, based on the member ID of the WTRU in the group (e.g., the WTRU may determine which of the resources indicated in DCI may be scheduled for the WTRU based on its member ID), and/or based on any appropriate combination thereof. For example, the WTRU (e.g., target WTRU) may be (pre-) configured SL-PRS reception-based positioning method for a group of five WTRUs. The WTRU as the target WTRU may receive SL-PRS from the other four anchor WTRUs. The group may be scheduled four resources for SL-PRS, wherein each anchor WTRU may select one resource based on the function of its member ID.

A WTRU may determine whether to forward the scheduled SL-PRS for the member WTRUs in the group. For example, the WTRU (e.g., target WTRU) may receive SL-PRS scheduling for its SL-PRS transmission from the network (e.g., gNB and/or LMF). The WTRU may then determine whether to forward the scheduled SL-PRS transmission for the WTRU in the group (e.g., peer WTRU or the member WTRUs in sidelink positioning group). The determination whether to forward the scheduled SL-PRS may be based on the coverage status of the peer WTRU and/or the member WTRU. For example, if the peer WTRU or one of more member WTRUs exists out of network coverage, the WTRU may forward the scheduled SL-PRS to the peer WTRU of the member WTRUs.

The determination whether to forward the scheduled SL-PRS may be based on the RRC state of the peer WTRU and/or member WTRUs. For example, if the peer WTRU or at least one member WTRU is not in RRC_CONNECTED state, the WTRU may forward the scheduled SL-PRS to the peer WTRU and/or member WTRUs. Otherwise, the WTRU may not forward the scheduled SL-PRS to the peer WTRU and/or member WTRUs.

A WTRU may determine to transmit the scheduled SL-PRS based on the acknowledgement (ACK) from member WTRUs. For example, the WTRU may be scheduled (e.g., by gNB or LMF) or select by itself one or more SL-PRS. The WTRU may send the information about the scheduled and/or selected SL-PRS resource. The WTRU may expect acknowledgement from the peer WTRU and/or member WTRUs. The WTRU may discard and/or release one or more SL-PRS resources if the WTRU does not receive acknowledgement from the peer WTRU and/or member WTRUs in the group. This approach may be help prevent the WTRU from sending a SL-PRS when there is no WTRU to receive it.

A WTRU may determine which WTRU to request resources for sidelink positioning. In one approach, a WTRU (e.g., target WTRU) may establish a group of WTRUs for sidelink positioning. The WTRU may then determine which WTRU to request resource (e.g., sidelink and/or uplink) for sidelink positioning for the group of WTRU. The WTRU may then indicate (e.g., by using group PC5-RRC and/or LPP) to the other WTRUs in the group (e.g., using the group ID) the WTRU performing resource requesting for a group. In one approach, a target WTRU may request resources for sidelink positioning (e.g., for mobile originating location request (MO-LR) positioning service). In examples, an anchor WTRU connecting to the network may request resources for sidelink positioning (e.g., for network induced location request (NI-LR) positioning service).

A WTRU may trigger resource allocation and/or requesting resource(s) for sidelink positioning. For example, a WTRU (e.g., target WTRU) may trigger resource allocation and/or requesting resource(s) for sidelink positioning, which may include one or more of the following resources: the sidelink resource to indicate and/or reserve other resource(s) for sidelink positioning (e.g., the sidelink resource to indicate and/or reserve the resources for SL-PRS transmission, SL-PRS reception, and/or SL-PRS measurement reporting), the sidelink resource(s) for SL-PRS transmission, the sidelink resource(s) for SL-PRS reception, the sidelink resource(s) for reporting SL-PRS resource(s) usage, the sidelink resource(s) for SL-PRS measurement reporting, the uplink resource(s) used to indicate and/or report the usage of the scheduled SL-PRS resource(s), and/or the uplink resource(s) for sidelink positioning reporting (e.g., sidelink positioning and/or Uu positioning reporting).

The WTRU may use one or any combination of AS message (e.g., one or any combination of scheduling request (SR), uplink medium access channel (UL MAC CE), RRC and/or NAS message (e.g., LPP) to transmit in the uplink direction to request resource(s) (e.g., sidelink resource or uplink resource) for sidelink positioning. The WTRU may use the information related to the group sidelink positioning (e.g., group ID, sidelink positioning service ID, and/or L2 destination index, etc.) to request resource for sidelink positioning. The WTRU may trigger resource allocation and/or requesting resource(s) for sidelink positioning based on one or any combination of the events described herein and/or one or any combination of the following events:

The WTRU may initiate the sidelink positioning service. For example, the WTRU may initiate the sidelink positioning service (e.g., for MO-LR service). The WTRU may then trigger resource allocation and/or request resource for sidelink positioning.

The WTRU may receive an indication and/or request from the network to potentially perform sidelink positioning. For example, the WTRU may receive a request and/or indication from the network (e.g., from LMF via a LPP message) to potentially initiate sidelink positioning. The WTRU may then trigger resource allocation and/or request resources for sidelink positioning.

The WTRU (e.g., target WTRU) may receive an indication and/or request from another WTRU (e.g., anchor WTRU) to perform sidelink positioning. For example, an anchor WTRU may initiate sidelink positioning service to locate the relative positioning of the target WTRU. The anchor WTRU may perform sidelink positioning by transmitting SL-PRS and/or request the target WTRU to transmit and/or receive SL-PRS. The target WTRU may then receive an indication and/or request from the anchor WTRU to perform sidelink positioning by transmitting and/or receiving SL-PRS and/or performing SL-PRS measurement reporting. The target WTRU may then trigger resource allocation and/or requesting resources for sidelink positioning.

The WTRU (e.g., anchor WTRU) receives an implicit and/or explicit request from another WTRU (e.g., target WTRU) to perform sidelink transmission and/or reception for sidelink positioning (e.g., SL-PRS transmission, SL-PRS reception, SL-PRS measurement reporting, and/or SL-PRS resource usage reporting). For sidelink RTT-based positioning method, the target WTRU may perform SL-PRS transmission. The anchor WTRU may then trigger resource allocation and/or requesting resource(s) for SL-PRS transmission and/or SL-PRS measurement reporting upon reception of the SL-PRS transmission from the target WTRU. A WTRU (e.g., anchor WTRU) may receive SL-PRS from another WTRU (e.g., target WTRU). Upon having the SL-PRS measurement result, the WTRU may then trigger resource allocation and/or requesting resources for SL-PRS measurement reporting. One WTRU (e.g., the target WTRU) may receive SL-PRS resource usage reporting from another WTRU (e.g., anchor WTRU), which may indicate that the WTRU does not perform SL-PRS reception and/or transmission in a scheduled and/or indicated sidelink resource. The target WTRU may then trigger resource allocation and/or requesting resources for SL-PRS transmission and/or reception, which may be used to increase the number of SL-PRS resources for sidelink positioning measurement.

The WTRU (e.g., target WTRU) may determine the existing sidelink resource is insufficient for the positioning service. For example, the WTRU (e.g., target WTRU) may trigger resource allocation and/or request additional resources for sidelink positioning if the WTRU does not receive an expected SL-PRS resource usage reporting, SL-PRS reception, and/or SL-PRS measurement reporting. For example, the WTRU (e.g., target WTRU) may trigger resource allocation and/or request additional resources for sidelink positioning if the WTRU or the peer WTRU (e.g., anchor WTRU) deprioritize a SL-PRS transmission, SL-PRS reception, SL-PRS resource usage reporting, and/or SL-PRS measurement reporting.

The WTRU (e.g., target WTRU) receives the SL-PRS resource usage reporting and/or SL-PRS measurement reporting from another WTRU implicitly and/or explicitly indicating the scheduled resource may not be used and/or not sufficient.

The WTRU (e.g., target WTRU) receives the SL-PRS measurement reporting from another WTRU (e.g., anchor WTRU) implicitly and/or explicitly indicating the scheduled resource may not be sufficient for SL-PRS measurement.

The WTRU may have SL-PRS positioning measurement result available. For example, the WTRU (e.g., anchor WTRU) may request (e.g., by the target WTRU) to perform SL-PRS measurement reporting. The WTRU may then trigger requesting (e.g., from the network) and/or resource allocation for SL-PRS measurement reporting if the WTRU has SL-PRS measurement results available. For example, the WTRU (e.g., target WTRU) may be (pre-) configured to perform SL-PRS measurement of at least N SL-PRS resources to generate the SL-PRS measurement report. The WTRU, upon successfully measuring N SL-PRS resources, may generate the SL-PRS measurement result. The WTRU may then trigger requesting resource and/or resource allocation for transmission of SL-PRS measurement report.

A WTRU may receive information for sidelink positioning from one node and may indicate the information to another node. For example, the WTRU may implicitly and/or explicitly receive information for sidelink positioning from one node (e.g., network node, LMF (location management function), gNB, another WTRU, etc.). For example, the WTRU may receive the information about sidelink positioning from a LMF via a LPP message. For example, the WTRU may receive the information about the sidelink positioning from another node via its SL-PRS transmission. The WTRU may then indicate one or any combination of the information received from the node to another node (e.g., network node, LMF, gNB, and/or another WTRU, etc.). The information the WTRU may receive from one node and/or indicating to another node may include information for sidelink positioning. The information may include one or any combination of the following:

The QoS associated with sidelink positioning (e.g., accuracy, latency, reliability, and/or availability of the sidelink positioning service).

The SL-PRS transmission and/or reception configuration, may include one or any combination of the following: the number of subchannels used for each SL-PRS resource, the number of symbols and/or slots used for each SL-PRS transmission resource, comb value, number of repetitions, the periodicity of SL-PRS transmission and/or reception, and/or the number of anchor WTRUs transmitting/receiving SL-PRS. The SL-PRS measurement reporting configuration, may include one or any combination of the following: the latency SL-PRS measurement reporting, and/or the periodicity of SL-PRS measurement reporting.

In examples, sidelink positioning may be initiated based on at least one or a combination of the following: an anchor WTRU may send a request to the network (e.g., gNB, LMF, or the like, etc.) to obtain the relative and/or absolute position of the target WTRU. If the anchor WTRU sends a request to the LMF, the request may be sent via a LPP message. In examples, the anchor WTRU may include the ID of the target WTRU to the network (e.g., LMF, gNB, etc.).

The target WTRU may send a request to the network to obtain its relative and/or absolute position. If the target WTRU sends a request to the LMF, the request may be sent via a LPP message. In examples, the target WTRU may include ID(s) of anchor WTRU(s) in the request with whom the relative location may be determined.

The target WTRU may send a request to one or more anchor WTRUs to determine its relative and/or absolute position. If the target WTRU sends a request to the anchor WTRUs, the request may be sent via an LPP message (e.g., SL-LPP) or AS layer message (e.g., PC5-RRC, and/or MAC CE). Such a request may be sent in sidelink via unicast, groupcast, and/or broadcast transmission. In one example associated with groupcast and/or broadcast transmission, the target WTRU may include the ID(s) of the anchor WTRU(s) in the request with whom the relative location may be determined.

The LMF and/or the gNB may send a request for the relative and/or absolute position target WTRU to anchor WTRU(s). The request may be sent to the anchor WTRU(s) via an LPP message. In one example, the anchor WTRU(s) receive the ID of the target WTRU.

The LMF and/or the gNB may send a request to the target WTRU to report its relative and/or absolute position. In one example, the LMF and/or gNB includes ID(s) of anchor WTRU(s) in the request with whom the relative location may be determined.

Location services (LCS) client and/or application in the WTRU and/or in the network may send a request for determining the relative and/or absolute position of a target WTRU. Such a request may be sent as an LCS (e.g., MO-LR and/or for mobile terminal location request (MT-LR)), LPP and/or AS-layer (e.g. RRC, PC5- and/or RRC) message to the gNB, LMF or anchor WTRU.

A WTRU may determine the information to indicate and/or report the SL-PRS resource usage. For example, a WTRU (e.g., anchor WTRU) may receive an indication and/or request (e.g., from a target WTRU) to perform SL-PRS transmission and/or SL-PRS reception. The WTRU may then determine to feedback the requesting WTRU regarding the SL-PRS resource usage. The WTRU may indicate the information related to the group sidelink positioning (e.g., requesting WTRU ID, sidelink positioning group ID, sidelink positioning service ID, etc.) to feedback the request for sidelink positioning.

The WTRU may use one or any combination of PSFCH, SCI, MAC CE, PC5-RRC, and/or NAS (e.g., LPP) to feedback implicitly and/or explicitly one or any combination of the following information: the WTRU has successfully decoded the sidelink positioning requesting message. For example, a target may receive a sidelink communication indicating and/or reserving SL-PRS resources for the anchor WTRU to perform SL-PRS transmission and/or reception. The anchor WTRU may feedback the SL-PRS resource usage based on the reception of such sidelink communication. The WTRU may feedback ACK/NACK based on the decoding status of the sidelink communication. For example, the WTRU may feedback ACK if the WTRU successfully receives the sidelink communication. Otherwise, the WTRU may feedback NACK.

The WTRU may perform SL-PRS transmission and/or reception. For this case, the WTRU may feedback to the requesting WTRU before the SL-PRS transmission and/or reception resource. For example, the WTRU (e.g., anchor WTRU) may receive an implicit and/or explicit request from another WTRU (e.g., target WTRU) to perform SL-PRS transmission and/or reception. The WTRU may then feedback to the target WTRU that it may perform SL-PRS transmission and/or reception. The feedback resource may be sent after the request message and/or before the SL-PRS transmission and/or reception resource.

The WTRU may not perform SL-PRS transmission and/or reception. For this case, the WTRU may feedback to the requesting WTRU before the SL-PRS transmission and/or reception resource. For example, the WTRU (e.g., anchor WTRU) may receive an implicit and/or explicit request from another WTRU (e.g., target WTRU) to perform SL-PRS transmission and/or reception. The WTRU may then feedback to the target WTRU that the WTRU may not perform SL-PRS transmission and/or reception. The feedback resource may be sent after the request message and/or before the SL-PRS transmission and/or reception resource. The WTRU may feedback such information due to the WTRU which may deprioritize the SL-PRS transmission and/or reception resource and/or may fail to decode the request message.

The WTRU may have performed SL-PRS transmission and/or reception. For this case, the WTRU may feedback to the requesting WTRU after the SL-PRS transmission and/or reception resource. For example, the WTRU (e.g., anchor WTRU) may receive an implicit and/or explicit request from another WTRU (e.g., target WTRU) to perform SL-PRS transmission and/or reception. The WTRU may then perform SL-PRS transmission and/or reception in the SL-PRS transmission and/or reception resource. The SL-PRS transmission and/or reception may be indicated in the request message. The WTRU may then feedback to the requesting WTRU that the WTRU has performed SL-PRS transmission and/or reception. The feedback message may occur after the SL-PRS transmission and/or reception resource.

The WTRU may have deprioritized one or more SL-PRS transmission and/or reception. For this case, the WTRU may feedback to the requesting WTRU after the SL-PRS transmission and/or reception resource. For example, the WTRU (e.g., anchor WTRU) may receive an implicit and/or explicit request from another WTRU (e.g., target WTRU) to perform SL-PRS transmission and/or reception.

The WTRU may then deprioritize SL-PRS transmission and/or reception in the SL-PRS transmission and/or reception resource. The SL-PRS transmission and/or reception may be indicated in the request message. The WTRU may then feedback to the requesting WTRU that the WTRU has deprioritized SL-PRS transmission and/or reception. The feedback message may occur after the SL-PRS transmission and/or reception resource.

The WTRU may need more resources for SL-PRS transmission and/or reception. In examples, the WTRU (e.g., anchor WTRU) may receive an implicit and/or explicit request from another WTRU (e.g., target WTRU) to perform SL-PRS transmission/reception. In examples, the WTRU may deprioritize SL-PRS transmission/reception. In another example, the WTRU may not receive enough SL-PRS resources to perform SL-PRS transmission and/or reception. The WTRU may then feedback to the requesting WTRU (e.g., target WTRU) to indicate that the WTRU may need more resources for SL-PRS transmission and/or reception.

A WTRU may determine whether to report and/or indicate the SL-PRS resource usage. For example, a WTRU (e.g., anchor WTRU) may receive an indication and/or request (e.g., from a target WTRU) to perform SL-PRS transmission and/or SL-PRS reception.

The WTRU may then determine whether to report and/or indicate the SL-PRS resource usage based on one or any combination of the following: the decoding status of the sidelink positioning requesting message.

In examples, the WTRU may determine not to report and/or indicate the SL-PRS resource usage if the WTRU successfully decodes the requesting message. Otherwise, if the WTRU fails to decode the requesting message, the WTRU may indicate and/or report the SL-PRS resource usage reporting to inform that the WTRU fails to decode the requesting message. In examples, the WTRU may determine to indicate and/or report SL-PRS resource usage to indicate that the WTRU successfully decodes the requesting message. Otherwise, if the WTRU fails to decode the requesting message, the WTRU may not perform SL-PRS resource usage reporting.

In examples, the WTRU may perform SL-PRS resource usage reporting regardless of whether the WTRU successfully decodes the requesting message or not. For example, the WTRU may indicate whether the WTRU successfully or failed to decode the requesting message. In examples, the WTRU may determine not to indicate and/or report SL-PRS resource usage reporting regardless of whether the WTRU fails or successfully decodes the requesting message.

The WTRU may determine whether to perform SL-PRS transmission and/or reception. For example, the WTRU may determine not to report and/or indicate the SL-PRS resource usage if the WTRU determines to perform SL-PRS transmission and/or reception. Otherwise, if the WTRU determines not to perform SL-PRS transmission and/or reception, the WTRU may indicate and/or report that the WTRU may not perform SL-PRS transmission and/or reception.

In examples, the WTRU may determine to indicate and/or report SL-PRS resource usage to indicate that it may perform SL-PRS transmission/reception if the WTRU determines to perform SL-PRS transmission/reception. Otherwise, if the WTRU determines not to perform SL-PRS transmission/reception, the WTRU may not perform SL-PRS resource usage reporting.

In examples, the WTRU may perform SL-PRS resource usage reporting regardless of whether the WTRU performs SL-PRS transmission and/or reception. For example, if the WTRU determines to perform SL-PRS transmission and/or reception, the WTRU may report SL-PRS resource usage to indicate to the requesting WTRU that the WTRU may perform SL-PRS transmission and/or reception. Otherwise, if the WTRU determines not to perform SL-PRS transmission and/or reception, the WTRU may report SL-PRS resource usage to indicate to the requesting WTRU that the WTRU may not perform SL-PRS transmission and/or reception. In examples, the WTRU may determine not to indicate and/or report SL-PRS resource usage reporting regardless of whether the WTRU performs SL-PRS transmission and/or reception.

The WTRU may determine whether to report and/or indicate the SL-PRS resource usage based on whether the WTRU has performed SL-PRS transmission and/or reception. In examples, the WTRU may determine not to report and/or indicate the SL-PRS resource usage if the WTRU has performed SL-PRS transmission and/or reception. Otherwise, if the WTRU has not performed SL-PRS transmission and/or reception, the WTRU may indicate and/or report that the WTRU has not performed SL-PRS transmission/reception.

In examples, the WTRU may determine to indicate and/or report SL-PRS resource usage if the WTRU has performed SL-PRS transmission and/or reception. Otherwise, if the WTRU has not performed SL-PRS transmission and/or reception, the WTRU may not perform SL-PRS resource usage reporting.

In examples, the WTRU may perform SL-PRS resource usage reporting regardless of whether the WTRU has performed SL-PRS transmission and/or reception. For example, if the WTRU has performed SL-PRS transmission and/or reception, the WTRU may report SL-PRS resource usage to indicate to the requesting WTRU that the WTRU has performed SL-PRS transmission and/or reception. Otherwise, if the WTRU has not performed SL-PRS transmission and/or reception, the WTRU may report SL-PRS resource usage to indicate to the requesting WTRU that the has not performed SL-PRS transmission/reception.

In examples, the WTRU may determine not to indicate and/or report SL-PRS resource usage reporting regardless of whether the WTRU has performed SL-PRS transmission/reception.

The WTRU may then determine whether to report and/or indicate the SL-PRS resource usage on whether the WTRU has deprioritized one or more SL-PRS transmission and/or reception.

In examples, the WTRU may determine not to indicate and/or report the SL-PRS resource usage if the WTRU has deprioritized one or more SL-PRS transmission and/or reception. Otherwise, if the WTRU has not deprioritized one or more SL-PRS transmission and/or reception, the WTRU may indicate and/or report that the WTRU has not deprioritized one or more SL-PRS transmission and/or reception.

In examples, the WTRU may determine to indicate and/or report SL-PRS resource usage if the WTRU has deprioritized one or more SL-PRS transmission and/or reception. Otherwise, if the WTRU has not deprioritized one or more SL-PRS transmission/reception, the WTRU may not perform SL-PRS resource usage reporting.

In examples, the WTRU may perform SL-PRS resource usage reporting regardless of whether the WTRU has deprioritized one or more SL-PRS transmission and/or reception. For example, if the WTRU has deprioritized one or more SL-PRS transmission and/or reception, the WTRU may report SL-PRS resource usage to indicate to the requesting WTRU that the WTRU has deprioritized one or more SL-PRS transmission and/or reception. Otherwise, if the WTRU has not deprioritized one or more SL-PRS transmission and/or reception, the WTRU may report SL-PRS resource usage to indicate to the requesting WTRU that the WTRU has not deprioritized one or more SL-PRS transmission and/or reception.

In examples, the WTRU may determine not to indicate and/or/report SL-PRS resource usage reporting regardless of whether the WTRU has deprioritized one or more SL-PRS transmission/reception.

The WTRU may then determine whether to report and/or indicate the SL-PRS resource usage based on whether WTRU needs more resources for SL-PRS transmission and/or reception.

In examples, the WTRU may determine not to report and/or indicate the SL-PRS resource usage if the WTRU does not need more SL-PRS transmission and/or reception resources. Otherwise, if the WTRU needs more SL-PRS transmission/reception resources, the WTRU may indicate and/or report needs more SL-PRS transmission and/or reception resources.

In examples, the WTRU may not perform SL-PRS resource usage reporting if the WTRU needs more SL-PRS transmission and/or reception resources. Otherwise, if the WTRU does not need more SL-PRS transmission and/or reception resources, the WTRU may perform SL-PRS resource usage reporting to indicate to the other WTRU that the WTRU does not need more SL-PRS transmission and/or reception resources.

A WTRU may determine the resource to indicate and/or report the SL-PRS resource usage. For example, the WTRU may determine the resource to feedback the usage of a SL-PRS transmission/reception resources. For example, the feedback resource may be determined based on one or any combination of the following, including: an indication from the requesting WTRU. For example, the requesting WTRU (e.g., target WTRU) may indicate and/or reserve the resource for the receiving WTRU to feedback the SL-PRS transmission and/or reception resources usage. The feedback resource may be indicated in a transmission indicating and/or reserving SL-PRS transmission and/or reception resource.

The feedback resource may be determined based on The resource indicating and/or reserving the SL-PRS transmission/reception resource.

In examples, the WTRU may be (pre-) configured (e.g., in a resource pool) with a mapping between the resource indicating and/or reserving SL-PRS transmission and/or reception and the associated feedback message. The WTRU may then determine to feedback the requesting message in the associated feedback resource. This approach may be used for the scenario in which the WTRU uses PSFCH to feedback the SL-PRS transmission and/or reception resource usage.

In examples, the WTRU (e.g., anchor WTRU) may trigger resource allocation and/or request sidelink resource (e.g., requesting the gNB and/or LMF) to feedback the request. If the WTRU requests the sidelink resource from the network, the WTRU may implicitly indicate the latency requirement (e.g., PDB) of the feedback message to help the network in scheduling the feedback resource properly. For example, the WTRU may implicitly indicate the priority of the feedback. Additionally or alternatively, if the WTRU performs resource allocation, the WTRU may determine the resource allocation window for the feedback message based on the latency requirement of the feedback message.

The latency requirement of the feedback may be determined based on one or any combination of the following: whether the WTRU is (pre-) configured. For example, the WTRU may be (pre-) configured with a fixed latency requirement for the time gap between the resource reserving and/or indicating SL-PRS transmission/reception and the feedback resource.

The latency of the feedback may be indicated from another WTRU. For example, the WTRU (e.g., anchor WTRU) may receive the latency requirement for the feedback message from another WTRU (e.g., target WTRU). The target WTRU may use PC5-RRC to convey the latency requirement to the feedback message.

The latency of the feedback may be indicated by the time gap between the resource indicating and/or reserving SL-PRS resource and/or the SL-PRS transmission and/or reception resource. For example, the WTRU may determine the maximum latency of the feedback message based on the time gap between the resource indicating and/or reserving SL-PRS resource and the actual SL-PRS resource. For example, the WTRU may transmit the feedback in the gap between two resources considering the WTRU processing (e.g., the WTRU may not be allowed to transmit the feedback in N slots before the SL-PRS resources, in which N may be based on the WTRU processing capability). Transmitting the feedback may allow the requesting WTRU to become aware of the potential SL-PRS transmission and/or reception WTRUs.

The feedback resource may be determined based on the SL-PRS transmission/reception resource. For example, the WTRU may be (pre-) configured (e.g., in the resource pool) with an implicit mapping between the SL-PRS transmission and/or reception resource and the feedback resource to indicate and/or report the SL-PRS resource usage. The WTRU may then transmit the feedback based on the SL-PRS transmission and/or reception resource and the implicit mapping rules between the SL-PRS and/or the feedback resources.

In examples, the WTRU may determine the feedback resource based on the SL-PRS transmission and/or reception resource and the latency requirement of the feedback. The WTRU may then feedback in the resource to satisfy the latency requirement.

The latency requirement of the feedback may be determined based on one or any combination of the following, including whether the WTRU is (pre-) configured. For example, the WTRU may be (pre-) configured (e.g., per sidelink positioning service) with a fixed latency requirement for the time gap between the SL-PRS resource and/or the feedback resource.

The latency requirement of the feedback may be indicated from another WTRU. For example, the WTRU (e.g., anchor WTRU) may receive the latency requirement from another WTRU (e.g., target WTRU) for a feedback to indicate the SL-PRS resource usage. For example, the target WTRU may use PC5-RRC to convey the latency requirement of the feedback message. The latency requirement may then be determined as the time gap between the SL-PRS resource and/or the feedback resource.

The latency requirement of the feedback may be indicated by the time gap between the SL-PRS resource and the measurement reporting resource. For example, the WTRU may determine the maximum latency of the feedback message based on the time gap between the SL-PRS resource and the SL-PRS measurement reporting resource. For example, the WTRU may transmit the feedback in the gap between two resources considering the WTRU processing (e.g., the WTRU may not be allowed to transmit the feedback in N slots before the SL-PRS measurement reporting resource, in which N may be based on the WTRU processing capability).

The feedback resource may be determined by the SL-PRS measurement reporting resource. For example, the WTRU may be (pre-) configured (e.g., in the resource pool) with an implicit mapping between the SL-PRS transmission and/or reception resource and the feedback resource to indicate and/or report the SL-PRS resource usage. The WTRU may then transmit the feedback to indicate and/or report the SL-PRS resource usage based on the SL-PRS transmission and/or reception resource and/or the implicit mapping rules between the SL-PRS and the feedback resources.

The feedback resource may be determined by the channel and/or message used to feedback the SL-PRS transmission/reception resource usage. The WTRU may be (pre-) configured with two or more types of channel and/or message to feedback the SL-PRS transmission and/or reception resource usage. The WTRU may then determine the resource to feedback the SL-PRS resource usage based on the type of channel/message used to feedback the SL-PRS resource usage.

In examples, the WTRU may use a (pre-) configured implicit mapping-based approach to feedback the SL-PRS resource usage for the first type of feedback channel (e.g., PSFCH feedback channel). For example, the WTRU may be (pre-) configured a mapping between the resource indicating the SL-PRS resource and the PSFCH resource or a mapping between SL-PRS resource and PSFCH feedback to report and/or indicate the SL-PRS resource usage. The WTRU may then determine the resource to feedback the SL-PRS resource usage based on the resource indicating the SL-PRS resource or the SL-PRS resource and the (pre-) configured mapping rule.

In examples, the WTRU may use the window-based approach to feedback the SL-PRS resource usage for the second type of feedback channel (e.g., the feedback using one or any combination of SCI, MAC CE, PC5-RRC, and/or LPP). For example, the WTRU may first determine the latency requirement of the feedback transmission. The WTRU may then request the sidelink resource and/or perform resource allocation for the feedback transmission in a time window. The time window may be within the latency requirement of the feedback to indicate and/or report the SL-PRS resource usage. The WTRU may then perform feedback transmission in the scheduled and/or selected feedback resource.

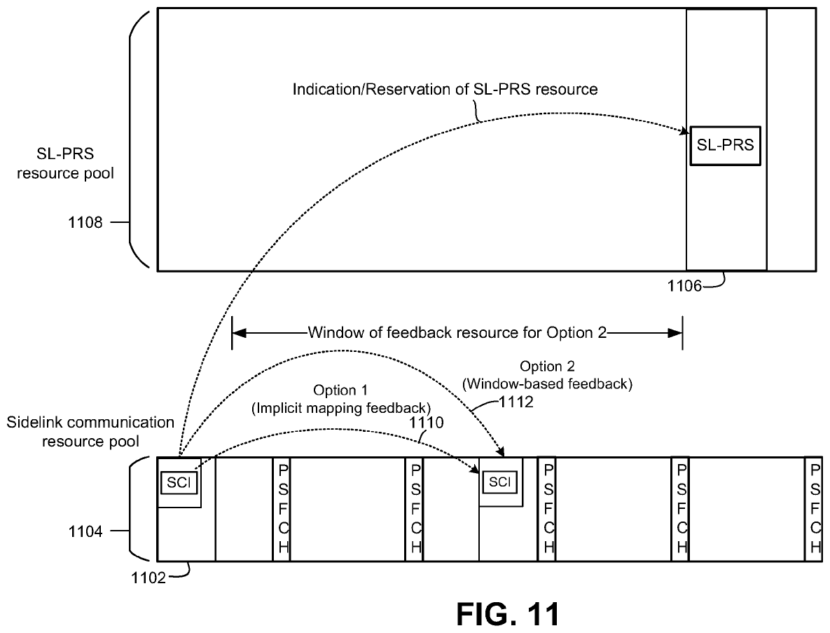

FIG. 11 depicts an example illustration of providing feedback of a SL-PRS resource usage before a SL-PRS resource. In examples, as shown in FIG. 11, the target WTRU may perform sidelink transmission 1102 in a sidelink communication resource pool 1104 to indicate and/or reserve SL-PRS resource 1106 in SL-PRS resource pool 1108. The anchor WTRU may have two options to feedback the SL-PRS resource usage. In Option 1 at 1110, the WTRU may use an implicit mapping between the sidelink transmission and the feedback resource. In Option 2 at 1112, the WTRU may transmit feedback in one of the resources in the window between the sidelink communication indicating and/or reserving the SL-PRS resource and the SL-PRS resource.

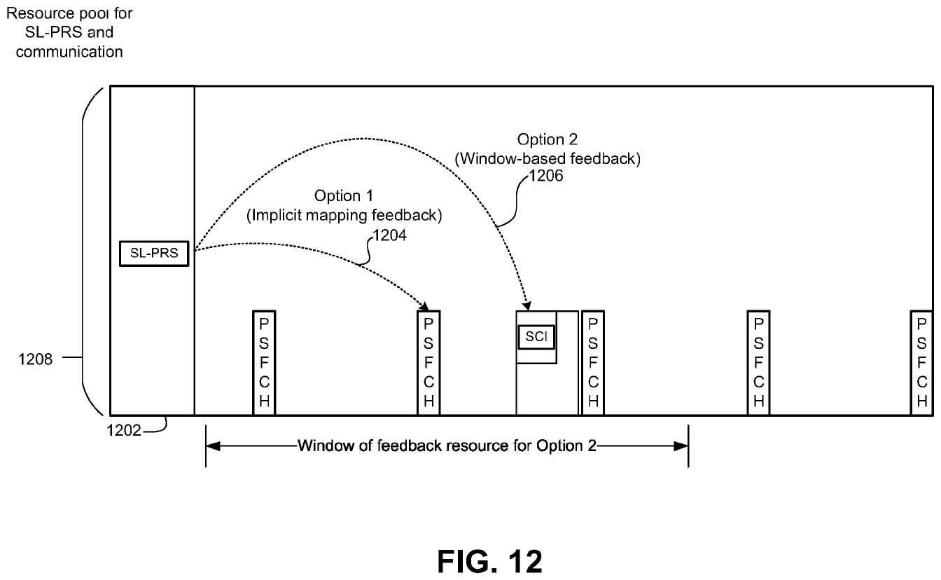

FIG. 12 depicts an example illustration of feeding back the SL-PRS resource usage after the SL-PRS resource. In the example depicted in FIG. 12, the target WTRU may perform sidelink transmission 1202. The anchor WTRU may have two options to feedback the SL-PRS resource usage. In Option 1 at 1204, the WTRU may use an implicit mapping between the sidelink transmission and the feedback resource. In Option 2 at 1206, the WTRU may transmit feedback in one of the resources in the window after the SL-PRS resource 1208.

A WTRU may determine the information to include in SL-PRS measurement reporting. For example, the WTRU may include one or any combination of the following information in SL-PRS measurement reporting:

The information related to the group sidelink positioning (e.g., anchor WTRU ID, target WTRU ID, group ID, and/or sidelink positioning service ID, etc.).

The information related to the SL-PRS resources may be used for measurement (e.g., SL-PRS transmission resources, and/or SL-PRS reception resources). The WTRU may indicate the resource index the WTRU uses to perform measurement and/or measurement reporting. The WTRU may indicate the number of resources the WTRU uses for SL-PRS measurement. The WTRU may indicate the SL-PRS window the WTRU uses for SL-PRS measurement.

SL-PRS positioning measurement parameters, which may be determined based on the sidelink positioning method. The WTRU may report RSTD, ToA, AoA, PoA, DPoA, and/or SL-RSRP of the SL-PRS transmitted from the target WTRU for SL-PRS transmission-based method. For example, the WTRU may report ToD, AoD, POD, DPoD, and/or SL-PRS of the SL-PRS reception-based sidelink positioning method. For example, the WTRU may report Tx-Rx difference, RSTD, SL-RSRP, TOD, AOD, TOA, TOD, PoA, POD, DPOA, and/or DPoD for the RTT-based sidelink positioning method.

The WTRU may include in its SL-PRS measurement reporting the accuracy of SL-PRS measurement. For example, the WTRU may indicate the error bound of the SL-PSR measurement (e.g., the maximum error and/or the deviation of the error, etc.).

The WTRU may include in its SL-PRS measurement reporting the necessity of additional SL-PRS resource. For example, the WTRU may implicitly and/or explicitly indicate whether the WTRU needs additional SL-PRS resource to perform SL-PRS measurement. The WTRU may determine whether to request more resource for SL-PRS measurement based on the accuracy and/or the availability of the SL-PRS measurement. For example, if the accuracy of the current SL-PRS measurement is smaller than a threshold and/or the WTRU does not have the SL-PRS measurement available, the WTRU may implicitly and/or explicitly request more SL-PRS resource for measurement.

The WTRU may include in its SL-PRS measurement reporting the sidelink positioning assistant information. For example, the WTRU (e.g., anchor WTRU) may indicate assistant information to help the reported WTRU in sidelink positioning. The assistant information may include: the location of the WTRU (e.g., the zone ID of the WTRU and/or the absolute position of the WTRU), the movement property of the WTRU (e.g., heading direction and/or speed, etc.), and/or the antenna placement of the WTRU.

A WTRU may drop scheduled resource for SL-PRS resource usage reporting. For example, a WTRU (e.g., anchor WTRU) may request the network to schedule sidelink resource to indicate and/or report SL-PRS resource usage reporting. The WTRU may determine not to perform transmission of SL-PRS resource usage reporting if the scheduled resource does not satisfy the latency requirement of the reporting.

A WTRU may determine the information to indicate and/or report the sidelink resource usage in the uplink transmission. For example, the WTRU may report sidelink resource usage for sidelink positioning to the network. The WTRU may include one or any combination of the following information to the network: the WTRUs has or has not received feedback to indicate SL-PRS resource usage from one or more WTRUs and/or resources. For example, the WTRU (e.g., target WTRU) may be scheduled sidelink resource for a group of WTRUs (e.g., a group of anchor WTRUs). The WTRU may perform a sidelink transmission to indicate and/or reserve the resource(s) for sidelink positioning. The WTRU may expect to receive feedback from all WTRUs in the group. The WTRU may then decode the feedback from WTRUs in the group indicating the SL-PRS resource(s) usage. The WTRU may then report to the network the set of WTRUs, to the network.

The feedback the WTRU may report to the network may have one or any combination of the following information: the set of WTRUs having ACK feedback, the set of WTRUs having NACK feedback, the set of WTRUs having with DTX, the set of WTRUs may perform SL-PRS transmission and/or reception, the set of WTRUs may not perform SL-PRS transmission and/or reception, the set of WTRUs has performed SL-PRS transmission and/or reception, the set of WTRUs has deprioritized SL-PRS transmission and/or reception.

The WTRU may include in the information to indicate and/or report to the sidelink resource usage in uplink whether the WTRU has or has not received SL-PRS from one or more WTRUs/resources. For example, the WTRU (e.g., target WTRU) may be scheduled a set of SL-PRS reception resources from one or more anchor WTRUs. The WTRU may then perform SL-PRS reception in the set of scheduled SL-PRS resources. The WTRU may then report the set of WTRUs transmitting SL-PRS and/or the set of SL-PRS resources having SL-PRS measurement result. The WTRU may report the set of WTRUs not transmitting SL-PRS and/or the set of SL-PRS resources not having SL-PRS measurement result.

The WTRU may include in the information to indicate and/or report to the sidelink resource usage in uplink whether the WTRU has or has not received SL-PRS measurement reporting from and/or for one or more WTRUs/resources. The WTRU may indicate to the network the set of WTRUs reporting SL-PRS measurement result. The WTRU may indicate to the network the set of WTRUs not reporting SL-PRS measurement results.

The WTRU may include in the information to indicate and/or report to the sidelink resource usage in uplink whether the WTRU may or may not perform SL-PRS transmission and/or reception in one or more SL-PRS resources. For example, the WTRU may be scheduled by the network a set of SL-PRS transmission and/or reception resource. The WTRU may then report to the network the set of SL-PRS resources, wherein the WTRU may perform SL-PRS transmission and/or reception. The WTRU may report the set of SL-PRS resources, wherein the WTRU may not perform SL-PRS transmission and/or reception. In this case, the uplink resource may occur before the SL-PRS transmission and/or reception resources.

The WTRU may include in the information to indicate and/or report to the sidelink resource usage in uplink whether the WTRU has or has not performed SL-PRS transmission and/or reception in one or more SL-PRS resources. For example, the WTRU may be scheduled by the network a set of SL-PRS transmission/reception resource. After performing SL-PRS transmission and/or reception in zero or more scheduled SL-PRS resources, the WTRU may then report to the network the set of SL-PRS resources, wherein the WTRU has performed SL-PRS transmission and/or reception. The WTRU may then report to the network the set of SL-PRS resources, wherein the WTRU has not performed SL-PRS transmission and/or reception. In this case, the uplink resource may occur after the SL-PRS transmission and/or reception resources.

The WTRU may include in the information to indicate and/or report to the sidelink resource usage in uplink whether the WTRU may or may not need additional sidelink resource for sidelink positioning. The WTRU may implicitly and/or explicitly indicate to the network that the WTRU may or may not need more sidelink resource for sidelink positioning. The WTRU may indicate ACK/NACK to the network whether the WTRU needs more sidelink resource for sidelink positioning. These needed sidelink resources may be associated with one sidelink positioning cycle. The WTRU may report ACK if the WTRU does not need more resource for sidelink positioning. Otherwise, the WTRU may report NACK if the WTRU needs more resources for sidelink positioning.

The WTRU may determine whether the WTRU needs more resources for sidelink positioning based on one or any combination of the following: the WTRU has received at least N ACK feedbacks from other WTRUs to transmit and/or receive SL-PRS. For example, the WTRU may report ACK. The WTRU may use the ACK to indicate to the network that the WTRU does need more resource for sidelink positioning if the WTRU receives at least N ACK feedbacks from other WTRUs to transmit and/or receive SL-PRS. Otherwise, the WTRU may report NACK, if the WTRU receives less than N ACK feedbacks from other WTRUs to transmit and/or receive SL-PRS. The value of N may be fixed, (pre-) configured based on the positioning accuracy requirements, and/or the total number of WTRUs in the sidelink positioning group.

The WTRU may determine whether it needs more resources for sidelink positioning based on whether the WTRU has performed/received SL-PRS transmission/reception from at least N WTRUs/resources. For example, the WTRU may report ACK to the network if it receives SL-PRS transmission and/or reception from at least N WTRUs and/or N resources. Otherwise, if the WTRU receives SL-PRS transmission and/or reception from fewer than N WTRUs and/or resources, the WTRU may report NACK. The value of N may be fixed, (pre-) configured based on the positioning accuracy requirements, the total number of WTRUs in the sidelink positioning group, and/or the total number of scheduled SL-PRS transmission and/or reception resources.

The WTRU may determine whether it needs more resources for sidelink positioning based on whether the WTRU has received ACK feedback to indicate and/or report SL-PRS resource usage from at least N WTRUs. For example, the WTRU may report ACK to the network if the ACK receives at least N ACK feedbacks from other WTRUs indicating and/or reporting SL-PRS resource usage. Otherwise, the WTRU may report NACK. The value of N may be fixed, (pre-) configured based on the positioning accuracy requirements, and/or the total number of WTRUs in the sidelink positioning group.

The WTRU may determine whether it needs more resources for sidelink positioning based on whether the WTRU has received SL-PRS measurement report (e.g., with valid/available measurement result) from at least N WTRUs. For example, the WTRU may report ACK to the network if the WTRU receives SL-PRS measurement report (e.g., with valid/available measurement result) from at least N WTRUs. Otherwise, the WTRU may report NACK to the network if the WTRU receives SL-PRS measurement report from less than N WTRUs. The value of N may be fixed, (pre-) configured based on the positioning accuracy requirements, and/or the total number of WTRUs in the sidelink positioning group.

A WTRU (e.g., target WTRU) may perform SL-PRS measurement reporting to the network. The WTRU may report its SL-PRS measurement and/or forward the SL-PRS measurement of other WTRUs to the network. The WTRU may use one or any combination of the MAC CE, RRC, and/or NAS (e.g., LPP) to report sidelink positioning to the network. In examples, the WTRU may transmit all SL-PRS measurement reporting from one or multiple WTRUs (e.g., including its SL-PRS measurement) in the sidelink positioning group to the network. In another approach, the WTRU may filter which SL-PRS measurement report, resources, and/or WTRUs from multiple WTRUs (e.g., including itself) to the network based on one or any combination of the following: the maximum and/or minimum number of WTRUs/reports to forward to the network. for example, the WTRU (e.g., target WTRU) may be (pre-) configured a maximum and/or minimum number of reports and/or WTRUs measurement reports in a message to the report to the network. The WTRU may then select the number of reports and/or WTRUs measurement reports to the network based on the (pre-) configured values.

The WTRU may filter which SL-PRS measurement report, resources, and/or WTRUs from multiple WTRUs based on the availability of one or more parameters in a SL-PRS measurement reporting. For example, the WTRU may forward a measurement report and/or WTRU's measurement report if the measurement report includes one or any combination of the following parameters, including the position of the reporting WTRU (e.g., anchor WTRU). For example, the WTRU may not report the SL-PRS measurement reporting of one anchor WTRU if the position information of the anchor WTRU is not available in the report.

The measurement report may include one or more SL-PRS measurement parameters from one or more WTRUs such as RSTD, Tx-Rx, SL-RSRP, SL Reference Signal power per path (SL-RSRPP), TOD, AoD, ToA, TOD, PoA, POD, DPoA, and/or DPoD for the RTT-based sidelink positioning method. For example, for RTT method, the WTRU may not forward SL-PRS measurement report (e.g., Tx-Rx) of one anchor WTRU if the Tx-Rx between SL-PRS transmission and/or reception measured from the target WTRU is not available.

A WTRU may filter which SL-PRS measurement report, resources, and/or WTRUs from multiple WTRUs based on whether one or more parameters in each SL-PRS measurement reporting is within a range. For example, the WTRU may forward SL-PRS measurement report of one WTRU if one or more measurement parameters are within a range. The parameters in range may be (pre-) configured. The measurement parameter may be one or more of the following: RSTD, Tx-Rx, SL-RSRP, TOD, AOD, TOA, TOD, PoA, POD, DPOA, and/or DPoD.

A WTRU may determine whether to request SL-PRS resource for another WTRU. In examples, each WTRU in the positioning group may request SL-PRS resource for itself. In examples, one WTRU may request SL-PRS resources for multiple WTRUs. The WTRU (e.g., target WTRU) may determine whether to request and/or select SL-PRS resources for another WTRU based on one or any appropriate combination of the following, including: positioning method. For example, the target WTRU may request SL-PRS resource for WTRUs in the group if the group uses SL-TDOA positioning method. Additionally and alternatively, if the group uses the RTT method, each WTRU may select its transmission resource independently. For example, when utilizing the angle-based positioning method, the WTRU may determine not to request SL-PRS resource for other WTRU.

A WTRU may determine whether to request and/or select SL-PRS resources for another WTRU based on coverage status of each WTRU in the group. For example, the WTRU (e.g., target WTRU) may request SL-PRS resource for another WTRU if the other WTRU is out of coverage.

A WTRU may determine whether to request and/or select SL-PRS resources for another WTRU based on RRC state of each WTRU. For example, the WTRU (e.g., target WTRU) may request SL-PRS resource for another WTRU if the other WTRU is in RRC idle and/or RRC Inactive status.

In examples, for the SL-TDOA positioning method, the WTRU may request SL-PRS for all WTRUs in the positioning group. In examples, the WTRU may request SL-PRS resources for the out of coverage WTRUs. In examples, the WTRU may request SL-PRS resources for the WTRUs in RRC Inactive and RRC Idle WTRUs.

A WTRU may determine the value of parameters for SL-PRS transmission and/or reception resources for the group. A WTRU may determine the value of one or any appropriate combination of the following parameters for SL-PRS transmission and/or reception resources for the group: the number of SL-PRS transmission and/or reception resource, the minimum, maximum, and/or exact time gap between two SL-PRS resources, the earliest and/or the latest SL-PRS resources, and/or the SL-PRS measurement and processing window.

After the determination of one or more of the above parameters, the WTRU may indicate one or more of these parameters to the network (e.g., LMF and/or gNB), which may help the network in scheduling SL-PRS resource. One or any combination of these parameters for SL-PRS transmission and/or reception may be resources for the group.

One or any combination of the above parameters may be determined by on one or any appropriate combination of the following, including the positioning method. In examples, for DL-like SL-TDOA method, the WTRU may determine the maximum time gap between the first and the last SL-PRS resources to be smaller than a threshold. The network (e.g., LMF) may indicate the time gap and/or threshold. In examples, for RTT method, the WTRU may determine the maximum time gap between the SL-PRS and/or SL-PRS Rx. The network (e.g., LMF) may indicate the maximum time gap.

QOS of the positioning service may also determine the above parameters. For example, the WTRU may determine the number and/or the latest SL-PRS resources based on latency requirement of the positioning service.

The WTRU processing capability and/or WTRU type may also determine the above parameters. For example, the WTRU may send its capability to transmit and/or receive the first SL-PRS to the network. The network may then schedule the first SL-PRS for the WTRU to transmit and/or receive accordingly.

A WTRU may use one SL-PRS transmission to multiple anchor WTRUs in the RTT method. The WTRU (e.g., target WTRU) may perform SL-PRS for the RTT method using unicast (e.g., the SL-PRS targets one WTRU only). In another approach, the WTRU may perform SL-PRS for RTT method using groupcast (e.g., the SL-PRS targets one group of WTRUs). The WTRU may convey the group ID in the transmission (e.g., SCI) associated with the SL-PRS to indicate the group information. Each receiver WTRU in the group may then transmit SL-PRS back for the transmitter.

SL-PRS transmissions may be accomplished via unicast, groupcast and/or broadcast. In one example, a WTRU may determine to transmit SL-PRS via unicast based on the positioning method. For an RTT-based positioning method, SL-PRS transmission via unicast may be applicable. The target WTRU and/or anchor WTRU may transmit and/or receive SL-PRS to each other.

In examples, for TDOA based positioning methods, SL-PRS transmission via groupcast may apply. The Tx WTRU may transmit SL-PRS to a group of WTRUs. The Tx WTRU may send a message to the group of WTRUs informing the PRS configuration used for the groupcast transmission (e.g., SL PRS resource ID, group ID, SL PRS ID, index and/or methods used to generate the SL-PRS sequence where the sequence consists of complex and/or real symbols and they are mapped to resource elements).

In examples, for TDOA based positioning targeting, more than one Rx WTRU, broadcast SL-PRS transmission may apply. Tx WTRU may transmit SL-PRS to potentially unknown number of Rx WTRUs. The Rx WTRUs may make measurements (e.g., RSTD) on the received SL-PRSs where the Rx WTRU may be configured to receive SL-PRS and/or PRS from the reference WTRU and/or TRP. The Rx WTRU may make measurements on ToAs for SL-PRS and/or PRS received from the reference WTRU/TRP and target WTRU/TRP and determine RSTD based on the ToAs. The Rx WTRU may receive broadcast ID from the network and/or peer WTRU based the generated PRS sequence. The peer WTRU may be an anchor WTRU/Tx WTRU/positioning reference unit (PRU) and/or WTRU with LMF capability.

In examples, a WTRU (e.g., target WTRU) may be involved in positioning procedures of a sidelink positioning group for RTT-based positioning method. The positioning group may include one target WTRU and/or one or more anchor WTRUs. The WTRU (e.g., target WTRU) may transmit SL-PRS to one or more anchor WTRUs using groupcast-based SL-PRS. Specifically, the WTRU may transmit one SL-PRS targeting one or more anchor WTRUs. For example, the WTRU may use the group ID to indicate the destination of its SL-PRS. All anchor WTRUs in the group may be the destination of its SL-PRS transmission. For transmission of SL-PRS from each anchor WTRU to the target WTRU, each anchor WTRU may transmit an associated SL-PRS to the target WTRU using unicast-based transmission. Specifically, each anchor WTRU may use the target WTRU ID as the destination of its SL-PRS transmission. In examples, each anchor WTRU may transmit an associated SL-PRS using groupcast-based transmission. Specifically, each anchor UE may use the group ID to transmit SL-PRS to the target WTRU.

In examples, a WTRU (e.g., anchor WTRU) may be involved in positioning procedure of a sidelink positioning group for RTT-based positioning method. The positioning group may include one or more anchor WTRUs and/or multiple target WTRUs. The WTRU (e.g., anchor WTRU) may transmit SL-PRS to multiple target WTRUs and potentially other anchor WTRUs in the group using groupcast-based transmission. For example, the WTRU (e.g., anchor WTRU) may use the group ID to indicate the destination of its SL-PRS, which may target all target WTRUs and/or potentially other anchor WTRUs in the group. For transmission of SL-PRS from each target WTRU to the anchor WTRU, each target WTRU may transmit SL-PRS to the anchor WTRU using unicast-based transmission. Specifically, each target WTRU may use the anchor WTRU ID as the destination of its SL-PRS transmission. In examples, each target WTRU may transmit an associated SL-PRS to the anchor WTRU using groupcast-based transmission. Specifically, each target WTRU may use group ID to transmit SL-PRS to the anchor WTRU.

A WTRU may determine whether to transmit SL-PRS using unicast or groupcast for the RTT method. The WTRU may make this determination based on one or any combination of the following, including the QoS requirement (e.g., latency) of the positioning service. For example, the WTRU (e.g., target WTRU) may transmit SL-PRS using groupcast for low latency positioning service. Additionally or alternatively, for a less stringent positioning service, the WTRU may use unicast type to transmit SL-PRS to the group.

The positioning result/output (e.g., whether the result/output is relative or absolute positioning). For example, for absolute positioning output, the WTRU may transmit SL-PRS using groupcast message. For relative positioning output, the WTRU may transmit SL-PRS using unicast message.

The WTRU may determine whether to transmit SL-PRS using unicast and/or groupcast for the RTT method based on the type of device. For example, the road side unit (RSU) may transmit SL-PRS using groupcast when the positioning group is established. Additionally or alternatively, the RSU may transmit SL-PRS using broadcast when the WTRU does not involve a positioning group and/or SL-PRS does not intend for a group.

The WTRU may determine whether to transmit SL-PRS using unicast and/or groupcast for the RTT method based on the network indication. The WTRU may determine to transmit SL-PRS via unicast, groupcast, and/or broadcast based on the indication and/or configuration from the network.

The WTRU may determine whether to transmit SL-PRS using unicast and/or groupcast for the RTT method based on the number of resources to transmit SL-PRS. The WTRU may select the number of resources to transmit SL-PRS. The network (e.g., gNB or LMF) may schedule the number of resources to transmit SL-PRS. For example, if the number of resources to transmit SL-PRS is smaller than a (pre-) configured threshold, the WTRU may use groupcast-based transmission to transmit SL-PRS. Otherwise, the WTRU may use unicast-based SL-PRS transmission. The (pre-) configured threshold may be a function of the WTRUs in the group.

A WTRU may determine which WTRU to request and/or select sidelink resource for one or more member in the group. The WTRU (e.g., target WTRU) may determine which WTRU (including itself) to request and/or select sidelink resource for one or more WTRUs in the group based on one or any combination of the following, including whether the WTRU initiated the positioning session. In examples, the target WTRU may request and/or select sidelink resources for the group if the WTRU triggers the sidelink positioning session and/or procedure to locate its own position. In examples, an anchor WTRU may request and/or select sidelink resource for the group if the anchor WTRU triggers the sidelink positioning session and/or procedure to locate one or more target WTRUs. The anchor WTRU may receive a request from LMF to trigger locating target WTRU. In this scenario, the anchor WTRU may request and/or select sidelink resources for other WTRU (e.g., one or more target WTRUs).

The WTRU (e.g., target WTRU) may determine which WTRU (including itself) to request and/or select sidelink resource for one or more WTRUs in the group based on the coverage status of the WTRU. One WTRU may request sidelink resource for the group if the WTRU is in coverage.

The WTRU (e.g., target WTRU) may determine which WTRU (including itself) to request and/or select sidelink resource for one or more WTRUs in the group based on the WTRU type. An RSU may request and/or select sidelink resources for another WTRU (e.g., target WTRU)

A WTRU may determine SL-PRS resources for the RTT positioning method. For the RTT positioning method, one WTRU (e.g., anchor WTRU) may receive SL-PRS Tx from another WTRU (e.g., target WTRU). The WTRU may determine which resource to transmit back the SL-PRS based on the (pre-) configured mapping between the first SL-PRS transmission resource and the second SL-PRS transmission resource. For example, the WTRU may be (pre-) configured a mapping between the first SL-PRS and the second SL-PRS in the resource pool. The WTRU may then determine the resource for the second SL-PRS based on the resource for the first SL-PRS.

The WTRU may also determine which resource to transmit back to the SL-PRS based on an indication from another WTRU (e.g., target WTRU).

The WTRU may also determine which resource to transmit back to the SL-PRS based on the resources scheduled by the network based on the request from the WTRU. For example, the WTRU may request the network to schedule a SL-PRS resource. The WTRU may implicitly and/or explicitly indicate the purpose of the requested resource (e.g., to transmit the second SL-PRS in the RTT positioning method). The WTRU may then further indicate the information about the requested SL-PRS resource such as the bandwidth, the SL-PRS pattern, the latency, and/or the number of repetitions and/or retransmissions. Such parameters may be determined based on the SL-PRS configuration of the first SL-PRS transmission. For example, the WTRU may be (pre-) configured the maximum gap between two resources. The WTRU may then indicate the latency of the second SL-PRS resource based on the timing of the first SL-PRS resource.

A WTRU may request resources for sidelink positioning. For example, in one set of solutions, the WTRU (e.g., target WTRU) may request sidelink positioning for itself and/or for a group of sidelink positioning. The WTRU may first establish a group communication for sidelink communication, which may include itself (e.g., target WTRU) and other WTRUs (e.g., anchor WTRUs). The WTRU may be (pre-) configured and/or assigned one or more IDs and/or index (e.g., a group ID, a L2 ID, and/or a L2 destination index) to communicate among the WTRUs in the group for sidelink positioning and/or to communicate with the network (e.g., via UCI, MAC CE, RRC, and/or LPP). The WTRU may use one or any combination of AS message (e.g., one or any combination of UCI, MAC CE, and/or RRC) and/or NAS message (e.g., LPP) to request resource for sidelink positioning. The WTRU may use the information related to the group sidelink positioning (e.g., a group ID, a L2 ID, and/or a L2 destination index) to request resource for sidelink positioning. The WTRU may be (pre-) configured with one or more group IDs. Each group ID may associate with one group the WTRU is involved for sidelink positioning.

The WTRU may implicitly and/or explicitly include one or any combination of the following information to request the resources for sidelink positioning: the sidelink positioning methods, the total number of resources for SL-PRS transmission and/or reception, the number of resources for SL-PRS transmission and/or reception per SL-PRS period, the total number of resources for SL-PRS measurement reporting, the number of SL-PRS transmission and/or reception periods, the duration of SL-PRS transmission and/or reception, the duration of SL-PRS measurement reporting, the periodicity of SL-PRS transmission and/or reception, the periodicity of SL-PRS measurement reporting, the number of WTRUs in the sidelink positioning group, the amount data for SL-PRS measurement reporting in sidelink and/or uplink, the QoS (e.g., priority, latency, and/or reliability) of the sidelink positioning.

A WTRU may send the sidelink positioning group information to the network. The information may help the network in resource scheduling. The information may include the set of sidelink positioning members including itself, the coverage status of one or more WTRUs in the group, the positioning method, or the like, and/or any combination.

A WTRU may indicate an ID and/or index associated with sidelink positioning to the network. For example, the WTRU may indicate to the network the ID and/or index (e.g., destination ID) associated with sidelink positioning. The WTRU may send a message to the network (e.g., RRC message, and/or sidelink WTRU information message, etc.) to indicate that a certain ID is assigned to the WTRU for sidelink positioning. The WTRU may then use such ID to communicate to the network using the ID for sidelink positioning. Specifically, the WTRU may then use the ID to send UCI, MAC CE, RRC, LPP and/or NAS message to the network. The WTRU may then determine whether any transmission (e.g., DCI, MAC CE, RRC, LPP, and/or NAS) from the network may be used for sidelink positioning based on the ID associated and/or embedded in the message.

A WTRU may send UCI (e.g., SR) to request resources for sidelink positioning. The WTRU (e.g., target WTRU) may first trigger UCI (e.g., SR) to request resources for sidelink positioning. In examples, the WTRU may be (pre-) configured dedicated UCI resource (e.g., dedicate SR) to request resource for sidelink positioning. In this case, the WTRU may trigger UCI (e.g., SR) transmission for requesting resource for sidelink positioning, the WTRU may not need to trigger MAC CE (e.g., SL-BSR). In another approach, the WTRU may (pre-) configured UCI (e.g., SR) to request resources for both sidelink positioning and/or other sidelink resources. In this case, the WTRU may trigger the transmission of both UCI (e.g., SR) and/or MAC CE (e.g., SL-BSR).

A WTRU may send MAC CE (e.g., sidelink buffer status report (SL-BSR)) to request resources for sidelink positioning. The WTRU (e.g., target WTRU) may trigger MAC CE (e.g., SL-BSR) to request the resources for sidelink positioning. In examples, the WTRU may use a dedicated MAC CE to request the resources for sidelink positioning. The WTRU may implicitly and/or explicitly indicate the number of resources for sidelink positioning. In examples, the WTRU may report MAC CE for sidelink positioning as a part of another MAC CE (e.g., SL-BSR). The WTRU may use a dedicated destination ID (e.g., dedicated destination index) to report the required number of resources (e.g., SL-PRS transmission and/or reception, and/or SL-PRS measurement reporting) for sidelink positioning. The WTRU may implicitly indicate to the network the dedicated destination as the destination for sidelink positioning. Specifically, the WTRU may indicate (e.g., via RRC) message one dedicated assigned destination ID and/or index as the destination for sidelink positioning.

A WTRU may receive sidelink positioning resources for a group of WTRUs and forward them to the other WTRUs. The WTRU may receive sidelink positioning resources for a group of WTRUs. The WTRU may forward the sidelink positioning resources to other WTRUs. The WTRU (e.g., target WTRU) may receive sidelink positioning resources scheduled for a group of WTRUs (e.g., one or more WTRUs in the group of sidelink positioning WTRUs).

The WTRU may receive one or any combination of the following resources for sidelink positioning for the group of WTRUs, including the group ID associated with the scheduled SL-PRS. For example, for dynamic grant, the WTRU may be provided an indication in DCI that the scheduled resource may be used for a particular group ID. For configured grant, the WTRU may be provided an indication in DCI, and/or RRC the group ID associated with the scheduled resource. Additional resources for sidelink positioning the WTRU may receive for the group of WTRUs includes the sidelink resource to indicate and/or reserve other resource(s) for sidelink positioning, the SL-PRS transmission resource, the SL-PRS reception resource, the SL-PRS usage reporting resource in sidelink direction, the SL-PRS usage reporting resource in uplink direction, the SL-PRS measurement reporting resource in sidelink, the SL-PRS measurement reporting resource in uplink direction.

The WTRU may forward the scheduled resources for sidelink positioning to the sidelink positioning group. The WTRU may use the one or more IDs (e.g., target WTRU ID, group ID, sidelink positioning service ID, L2 destination index, and/or anchor WTRU ID(s), etc.) to include in the forwarded message to help other WTRUs (e.g., anchor WTRUs) in decoding the forwarded message. In examples, the WTRU may use one sidelink resource (e.g., the resource to indicate and/or reserve other resource(s) for sidelink positioning) to forward the scheduled resources for sidelink positioning to other WTRUs in the group. The WTRU may use one or any combination of sidelink messages (e.g., SCI, MAC CE, PC5-RRC, and/or NAS (e.g., LPP) to include all related for sidelink positioning of the scheduling message to forward to the WTRUs in the group. In examples, the WTRU may process the message scheduling resources for sidelink positioning (e.g., DCI, DL MAC CE, RRC, and/or LPP). The WTRU may then perform transmission in the scheduled transmission resources. The WTRU may then forward the scheduled resources (e.g., in the sidelink resource to indicate and/or reserve other resource(s) for sidelink positioning using SCI, MAC CE, RRC, and/or NAS (e.g., LPP) message) for its reception and/or other WTRU's transmission to other WTRUs.

The WTRU may perform transmission in one or any combination of the following resources: the sidelink resource to indicate and/or reserve other resource(s) for sidelink positioning, the SL-PRS transmission resource, the SL-PRS usage reporting resource in sidelink direction, the SL-PRS usage reporting resource in uplink direction, and/or the SL-PRS measurement reporting resource in sidelink.

In examples, the WTRU may process the scheduling message and determine the scheduled resources for each WTRU. The WTRU may then use unicast message (e.g., unicast PC5-RRC) to forward the scheduled resources to each individual WTRU. In examples, the WTRU may process the scheduling message (e.g., from the network) and/or determine the scheduled resources for a group of WTRUs (e.g., a group of anchor WTRUs). The WTRU may then use a groupcast message (e.g., groupcast PC5-RRC) to forward the scheduled resources for the group of WTRUs.

The WTRU may forward one or any combination of the following resources for its reception and/or other WTRU's transmission, including: the SL-PRS reception resource, the SL-PRS usage reporting resource in sidelink direction, and/or the SL-PRS measurement reporting resource in sidelink.

A WTRU may determine the scheduled resource used for a group ID. The WTRU may maintain multiple positioning groups. The WTRU may determine whether a scheduled resource is used for which group ID. The WTRU may be provided an indication of the group ID in the resource scheduling message (e.g., DCI, MAC CE, and/or DCI). The WTRU may determine the group ID based on whether the WTRU requested SL-PRS for which positioning group. The WTRU may use the scheduled SL-PRS for the latest group requesting SL-PRS resource (e.g., the group ID indicated in SL-BSR).

A WTRU may determine whether to forward the scheduled SL-PRS resources to another WTRU. The WTRU (e.g., anchor WTRU) may receive the scheduled SL-PRS resourced to other WTRUs (e.g., the anchor WTRUs). The WTRU may first determine whether to forward the scheduled SL-PRS to other WTRUs based on the content of the scheduled SL-PRS resources. The WTRU may not forward the scheduled resources to other WTRUs if the scheduled resource does not have the SL-PRS Rx resources (e.g., the resource for the other WTRUs to perform SL-PRS transmission and the WTRU to perform SL-PRS reception). This approach may apply when the scheduling message indicates whether a resource may be used for the WTRU's transmissions or for other WTRUs' transmissions.

A WTRU may determine the SL-PRS transmission resources for other WTRUs. The WTRU may receive the scheduled SL-PRS resource from the network. The WTRU may not receive the indication of whether the resource may be used for which WTRU's transmission. The WTRU, based on the set of SL-PRS scheduled by the network, may then determine one or any combination of the following: the resource used for itself, and/or the resources used by other WTRUs. For example, based on the scheduled resources for the group, the WTRU may select one or more resources for itself. The WTRU may then select the resource for other WTRUs.

The WTRU may also determine the positioning method. For example, based on the characteristic (e.g., the number of SL-PRS resources, the distance between two SL-PRS resources, the number of cluster of resources, etc.) of scheduled resources for SL-PRS, the WTRU may determine whether to perform SL-TDOA and/or RTT. Each cluster of resources may be defined as the set of contiguous resources and/or the set of resources being close in time domain.

A WTRU may determine the index and/or ID of each WTRU. A WTRU (e.g., target WTRU) may determine the index and/or member ID of each WTRU in the sidelink positioning group. The WTRU may base these determinations on the WTRU ID and/or the number of WTRUs in the group. The WTRU may then indicate the index and/or member ID to each WTRU in the group. The WTRU may use one or any combination of the AS (e.g., SCI, MAC CE, group PC5-RRC) and/or NAS (e.g., LPP) to convey the index and/or member ID to each WTRU in the group. Other WTRUs in the group (e.g., anchor WTRUs) may receive its index and/or member ID and the number of WTRUs in the group.

A WTRU may receive configuration for sidelink positioning. For example, a WTRU (e.g., target WTRU) may receive configuration for sidelink positioning for a group of WTRUs from the network. In examples, the WTRU may determine the configuration for sidelink positioning for a group of WTRUs. In examples, the WTRU (e.g., target WTRU) and/or the network may configure the sidelink positioning of a group of WTRUs. The network and/or WTRU (e.g., target WTRU) may determine one or more parameters.

The configuration may include one or any combination of the following: the resource pool(s) for sidelink communication to facilitate sidelink positioning. the resource pool(s) for SL-PRS transmission/reception, and/or the property of one SL-PRS measurement reporting. For example, the WTRU may be (pre-) configured the number of subchannels used for each SL-PRS measurement report.

The configuration may include the multiplexing and/or indexing order of SL-PRS measurement reporting resources. For example, the WTRU may be (pre-) configured the indexing order for a group of SL-PRS measurement reporting resources. The WTRU may be (pre-) configured the indexing order from frequency domain to the time domain. Additionally or alternatively, the WTRU may be (pre-) configured the indexing order from time domain to the frequency domain.

The configuration may include property of one SL-PRS resource. For example, the WTRU may be (pre-) configured with one or any combination of the following parameters for one SL-PRS resource: the bandwidth of one SL-PRS resource, the comb value and offset of one SL-PRS resource, the cyclic shift of one SL-PRS resource, the number transmission symbols for one SL-PRS resource, the SL-PRS resource repetition pattern, and/or the cover code associated with the resource.

The configuration may include the number of SL-PRS resources in the frequency, code, and/or cover code domain.

The configuration may include multiplexing and/or indexing order of SL-PRS resource. For example, the WTRU may be (pre-) configured the indexing order for a group of SL-PRS resources. The WTRU may be (pre-) configured the indexing order from time to frequency and/or then to code and/or cover code domain, respectively. Additionally or alternatively, the WTRU may be (pre-) configured the indexing order from frequency to time domain to cover code and/or then to code domain, respectively.

A WTRU may transmit configuration for sidelink positioning to other WTRUs. A WTRU (e.g., target WTRU), upon receiving the configuration for sidelink positioning from the network and/or its own determination of one or more parameters for configuration for sidelink positioning may transmit the configuration to other WTRUs (e.g., anchor WTRUs in the group). The WTRU may use one or any combination of AS message (e.g., SCI, MAC CE, group PC5-RRC) and/or NAS message (e.g., LPP) to convey the configuration of sidelink positioning to for the group of WTRUs. The anchor WTRUs may then receive the configuration from the target WTRU and/or apply the configuration for sidelink positioning of the group of WTRUs. The anchor WTRU may be one of the group's members.

A WTRU may determine the SL-PRS reception resource of each WTRU in a group. A WTRU (e.g., target WTRU) may be scheduled SL-PRS reception resources. The reception resources may be used by other WTRUs (e.g., the set of anchor WTRUs) to perform SL-PRS transmission. The WTRU may then determine the SL-PRS resource of each WTRU (e.g., each anchor WTRU).

The SL-PRS resource may be based on one or any combination of the following: the set of SL-PRS resources scheduled for the group, the index and/or member WTRU ID in the group, the ID of the WTRU forwarding and/or indicating the SL-PRS resources for the group, the number of WTRUs in the group, the number of OCC assigned/(pre-) configured for each WTRU, the slot index of the scheduled SL-PRS resource, and/or the (pre-) configured multiplexing rules among multiple SL-PRS resource.

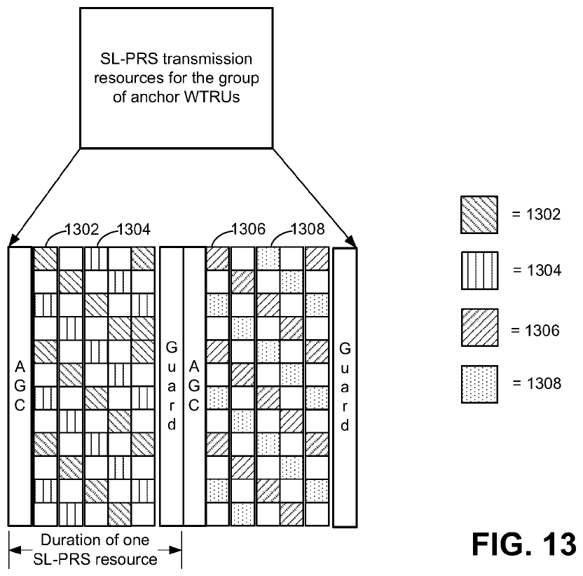

FIG. 13 depicts an example illustration of SL-PRS scheduling for a group of user WTRUs. In the example shown in FIG. 13, the target WTRU may be scheduled SL-PRS reception resources for a group of four WTRUs (e.g., from WTRU1 to WTRU4). Each SL-PRS resource may have comb-4 pattern and the WTRU can multiplex two SL-PRS in the frequency domain. Each SL-PRS resource may occupy half a slot. The WTRU may be (pre-) configured to index from frequency to time domain. The target WTRU may then determine that the SL-PRS resource of WTRU1 1302 and/or WTRU2 1304 may be in the first half of the slot multiplexing in frequency domain with different offset. The WTRU may then determine that the SL-PRS resources for WTRU3 1306 and/or WTRU4 1308 may be in the second half of the slot multiplexing in frequency domain with different offset. The SL-PRS resource for WTRU1 1302 and/or WTRU2 1304 multiplexing with the SL-PRS resource for WTRU3 1306 and/or WTRU4 1308 in time domain.

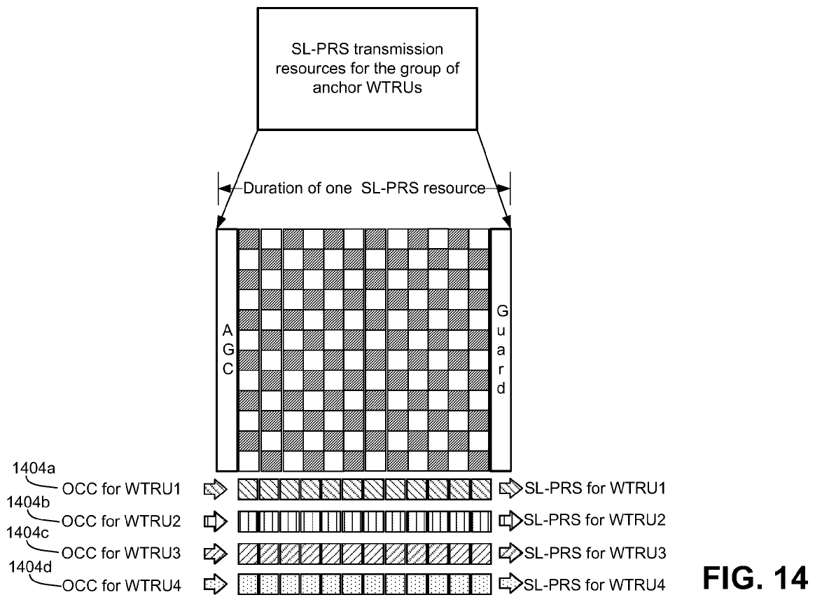

FIG. 14 depicts an example illustration of anchor WTRUs using orthogonal cover codes (OCCs) for one SL-PRS resource. As depicted in FIG. 14, the target WTRU may be scheduled one SL-PRS resource for a group of anchor WTRUs 1402a-d. Each anchor WTRU 1402a-d may apply different OCCs 1404a-d to help the target WTRU to differentiate among different anchor WTRUs 1402a-d. The OCC for each anchor WTRU may be (pre-) configured and/or determined by the target WTRUs. The target WTRU may indicate each anchor WTRU which OCC code to use. This approach may help the target WTRU in determining the transmission from each anchor WTRU.

A WTRU may determine its SL-PRS transmission resources. A WTRU (e.g., anchor WTRU) may receive a scheduled SL-PRS transmission resources for a group of WTRUs including the WTRU itself. The WTRU may then determine its SL-PRS resource to perform SL-PRS transmission.

Similar to the target WTRU, the anchor WTRU may determine its SL-PRS based on one or any combination of the following: the set of SL-PRS resources scheduled for the group, the index and/or member WTRU ID in the group, the ID of the WTRU forwarding/indicating the SL-PRS resources for the group, the number of WTRUs in the group, the OCC assigned/(pre-) configured for each WTRU, the slot index of the scheduled SL-PRS resource, and/or the (pre-) configured multiplexing rules among multiple SL-PRS resource.

A WTRU may determine the SL-PRS measurement reporting resource from each WTRU in a group. A WTRU (e.g., target WTRU) may be scheduled SL-PRS measurement reporting resources for a group of WTRU (e.g., anchor WTRU). The WTRU may then forward the resources for the group of WTRUs. The WTRU may determine the SL-PRS measurement reporting resource for each WTRU (e.g., each anchor WTRU) based on one or any combination of the following: the set of SL-PRS measurement reporting resources scheduled for the group, the index and/or member WTRU ID in the group, the number of WTRUs in the group, the (pre-) configured indexing rules among multiple SL-PRS measurement reporting resource, the ID of the WTRU forwarding and/or indicating the SL-PRS resources (e.g., target WTRU ID) for the group, and/or the slot index of the scheduled SL-PRS measurement reporting resource.

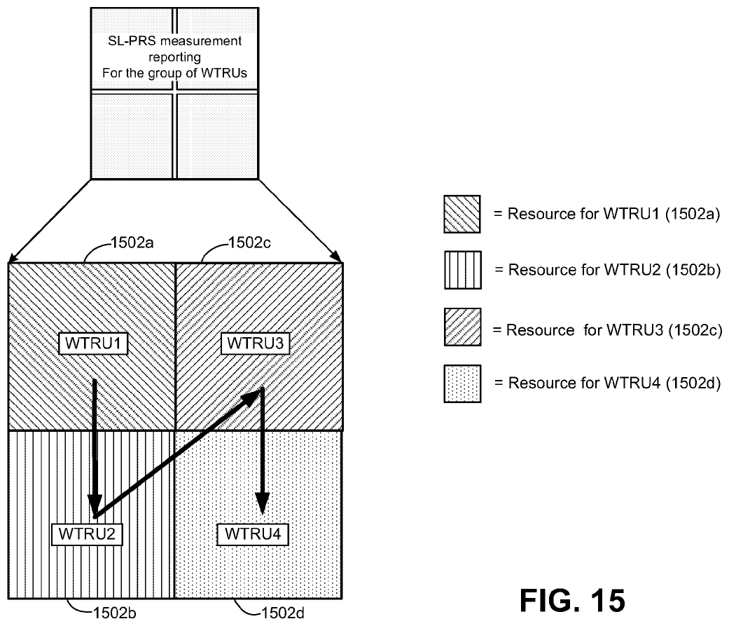

FIG. 15 depicts an example illustration of SL-PRS measurement report scheduling for a group of WTRUs. As depicted in FIG. 15, the target WTRU may be scheduled SL-PRS measurement reporting resources. The SL-PRS measurement reporting resources may include four resources 1502a-d, for a group of four anchor WTRUs. The WTRU may be (pre-) configured to index the resource from frequency to time order. The WTRU (e.g., target WTRU) may then determine the measurement reporting resource for each WTRU according to the (pre-) configured rules and WTRU index.

A WTRU may determine the SL-PRS measurement reporting resource for itself. A WTRU (e.g., anchor WTRU) may receive SL-PRS measurement reporting resources (e.g., from target WTRU) for a group of WTRUs (e.g., anchor WTRUs). Similar to the target WTRU, the anchor WTRU may then determine its SL-PRS measurement reporting resource based on one or any combination of the following: the set of SL-PRS measurement reporting resources scheduled for the group, the index and/or member WTRU ID in the group, the number of WTRUs in the group, the (pre-) configured indexing rules among multiple SL-PRS measurement reporting resource, the ID of the WTRU forwarding and/or indicating the SL-PRS resources (e.g., target WTRU) for the group, and/or the slot index of the scheduled SL-PRS measurement reporting resource.

A WTRU may determine the resource to report and/or indicate the SL-PRS resource usage from the scheduled SL-PRS resources for a group. The WTRU (e.g., anchor WTRU) may determine to feedback the SL-PRS resource usage from the set of scheduled SL-PRS resources for a group. The WTRU may determine the resource to feedback the usage of a SL-PRS resource based on one or any combination of the following: indication from the requesting WTRU, the resource indicating and/or reserving the SL-PRS transmission and/or reception resource, the index and/or member WTRU ID in the group, the number of WTRUs in the group, the ID of the WTRU forwarding and/or indicating the SL-PRS resources (e.g., target WTRU) for the group, the slot index of the scheduled SL-PRS measurement reporting resource, the slot index of the scheduled SL-PRS resource, the earliest and/or the latest scheduled SL-PRS resource, and/or the channel and/or message used to feedback the SL-PRS resource usage.

A WTRU may report synchronization offset information of the positioning group to the network. A WTRU (e.g., target WTRU) may receive synchronization offset information from another WTRU (e.g., anchor WTRU). Additionally or alternatively, the WTRU may derive the synchronization offset information by itself. The synchronization offset information of the positioning group may include the synchronization offset between itself and another WTRU (e.g., anchor WTRU), The synchronization offset between two other WTRUs in the group (e.g., two anchor WTRUs), or any appropriate combination thereof.

The WTRU may report the synchronization offset information of the positioning group to the network (e.g., LMF). The WTRU may use one or any combination of MAC (e.g., MAC CE), RRC, and/or NAS (e.g., LPP) message to convey the synchronization offset to the network (e.g., LMF). The WTRU may trigger sending such report based on one or any appropriate combination of the following: including periodic reporting. For example, the WTRU may periodically report the synchronization offset information to the network (e.g., LMF).

The WTRU may trigger sending such report based on the WTRU may report the SL-PRS measurement report to the network (e.g., LMF). For example, the WTRU may report the synchronization offset information of the group in a measurement report message.

The WTRU may trigger sending such report based on a synchronization offset greater than a (pre-) configured threshold. For example, the WTRU may report synchronization offset between two WTRUs (e.g., between two anchor WTRUs and/or between anchor WTRU and target WTRU) if the synchronization offset between the two WTRUs is greater than a (pre-) configured threshold.

A WTRU may indicate the synchronization offset based on the resource allocation mode of two WTRUs. A WTRU (e.g., target WTRU) may determine the synchronization offset between itself and another WTRU (e.g., target WTRU). Additionally or alternatively, the WTRU may determine the synchronization offset between two other WTRUs (e.g., two anchor WTRUs). The WTRU may receive the synchronization offset information from an anchor WTRU. The WTRU may determine the synchronization offset information between two WTRUs if two WTRU use two different resource allocation mode. For example, the WTRU may determine the synchronization offset information between itself and one anchor WTRU if the WTRU is using network scheduled resource allocation for SL-PRS and the anchor WTRU selects the resource autonomously.

A WTRU may be configured periodic and/or semi-static resources for sidelink positioning. A WTRU (e.g., target WTRU) may be scheduled one or more semi-static (e.g., periodic, or semi-persistent) resources for sidelink positioning. For example, the WTRU may be scheduled one or more semi-persistent resources (e.g., uplink resource, sidelink resource) and/or one or more periodic resources (e.g., uplink resource, sidelink resource) for sidelink positioning. A NAS message (e.g., LPP) and/or via a AS message (e.g., RRC) may configure a periodic and/or a semi-persistent resource. A semi-persistent resource may require the WTRU to receive MAC CE for resource activation and/or deactivation.

A WTRU may be (pre-) configured one or more semi-static resources, in which each semi-static resource may be used for one or more of the following: the sidelink resource to indicate, reserve, and/or request other resource(s) and/or WTRUs for sidelink positioning (e.g., the resource to transmit sidelink positioning requesting message), the SL-PRS transmission resource, the SL-PRS reception resource (which may be used by one anchor WTRU or a group of anchor WTRUs for SL-PRS transmission), the SL-PRS usage reporting resource in sidelink direction (which may be used to report SL-PRS resource usage), the SL-PRS usage reporting resource in uplink direction, the SL-PRS measurement reporting resource in sidelink, and/or the SL-PRS measurement reporting resource in uplink direction.

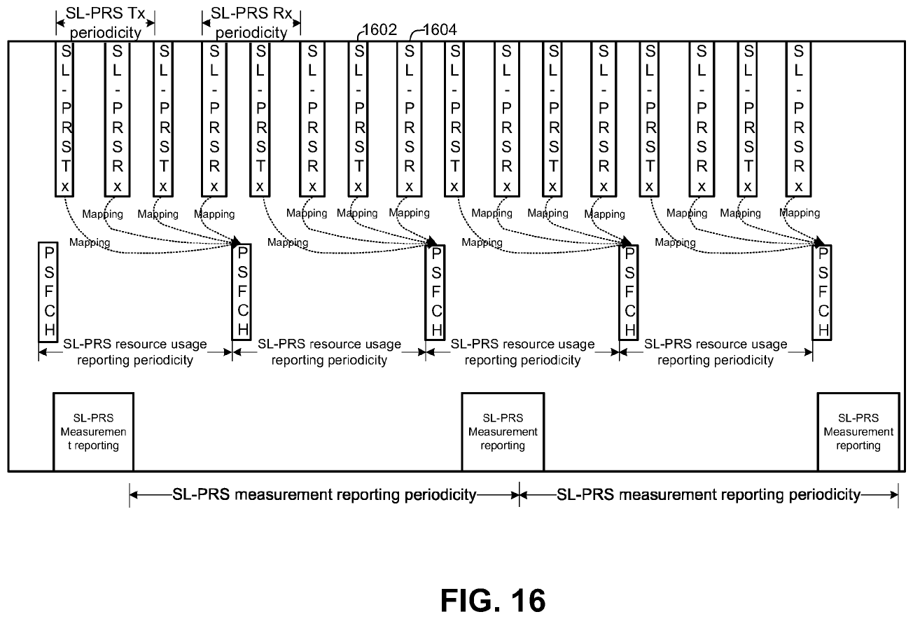

FIG. 16 depicts an example illustration of semi-static resources for sidelink positioning As shown in FIG. 16, the WTRU may be configured semi-static resources for sidelink positioning. The WTRU may be configured semi-static SL-PRS transmission, SL-PRS reception, SL-PRS usage reporting, and/or SL-PRS measurement reporting. The WTRU may be configured semi-static SL-PRS transmission 1602 and reception 1604 resources having the same period. The WTRU may be configured semi-static SL-PRS resource usage reporting resources, which may periodically occur after every N (e.g., N=2) SL-PRS transmission/reception periods. The WTRU may be configured SL-PRS measurement reporting resources after every N (e.g., N=4) SL-PRS transmission and/or reception periods.

A WTRU's behavior may be based on the status of the feedback for SL-PRS resource usage from other WTRUs. The WTRU (e.g., target WTRU) may be scheduled SL-PRS resources. The WTRU may forward the scheduled SL-PRS resources for the group of WTRUs. The WTRU may receive SL-PRS resource usage reporting from zero or more WTRUs in the group.

The WTRU may trigger one or any combination of the following procedures, including performing resource allocation and/or requesting additional dynamic resources (e.g., SL-PRS resource, sidelink positioning requesting message, etc.) for sidelink positioning. For example, the WTRU may request additional dynamic SL-PRS transmission and/or reception resource in one SL-PRS transmission/reception period if the WTRU deprioritize one or more SL-PRS transmission and/or reception. For example, the WTRU may request additional resource for transmitting sidelink positioning requesting message if the WTRU has not received at least N ACK feedbacks (e.g., from the set of anchor WTRUs in the sidelink positioning group).

The WTRU may trigger a procedure for reporting SL-PRS resource usage to the network. The WTRU may trigger a procedure for initializing SL-PRS transmission and/or reception. For example, the WTRU may initialize SL-PRS transmission and/or reception if it has received at least N ACK feedbacks (e.g., from the set of anchor WTRUs in the sidelink positioning group).

The WTRU may trigger a procedure for not performing SL-PRS transmission and/or reception in a scheduled resource. For example, in RTT-based sidelink positioning method, in one SL-PRS transmission and/or reception period, the WTRU may determine to deprioritize all SL-PRS transmission if the WTRU deprioritizes SL-PRS receptions in the period.

The WTRU may trigger a procedure for requesting the network to release one or more semi-static resources for sidelink positioning. For example, the WTRU may request the network to release one or more semi-static SL-PRS reception resources if one or more WTRUs leave the sidelink positioning group. For example, the WTRU may request the network to release all the semi-static resources for itself if the WTRU terminates the sidelink positioning session.

The WTRU may trigger a procedure for requesting the network to activate one or more semi-static resources for sidelink positioning.

The WTRU may trigger a procedure for requesting the network to change the configuration of one or more semi-static resources. For example, the WTRU may request the network to reduce the periodicity of one semi-static resources or increase the number of SL-PRS transmission resources in a SL-PRS transmission periods if it receives feedback from at least N WTRUs requesting additional resources for SL-PRS measurement.

The trigger event may be based on one or any combination of the events described herein and/or one or any combination of the following, including whether the WTRU has received ACK feedback of at least N WTRUs for the requesting message. For example, for ACK/NACK approach for a positioning request message, if the WTRU receive N ACKs (e.g., N equal to the number of anchor WTRUs in the group) from the other WTRUs (e.g., anchor WTRUs) the WTRU may initialize SL-PRS transmission and/or reception.

The trigger event may be based on whether the WTRU has received less than N ACK feedbacks for the requesting message. For example, the WTRU may trigger requesting more sidelink resource for requesting message if it receives smaller than N ACK feedbacks. This approach may be motivated to help WTRU find enough anchor WTRUs to support sidelink positioning.

The trigger event may be based on whether the WTRU has received NACK feedback of at least N WTRUs for the requesting message. For example, the WTRU may trigger requesting more sidelink resource for requesting messages if it receives at least N NACK feedbacks (e.g., N=1) for the requesting message.

The trigger event may be based on whether the WTRU has received feedback from at least N WTRUs indicating that it may perform SL-PRS transmission and/or reception. For example, if the WTRU receive at least N WTRU indicating that it may perform SL-PRS transmission/reception, the WTRU may initialize SL-PRS transmission and/or reception.

The trigger event may be based on whether the WTRU has received feedback from at least N WTRUs indicating that it may not perform SL-PRS transmission and/or reception. For example, the WTRU may trigger requesting more sidelink resources for requesting message if the WTRU receives feedback from at least N WTRUs indicating that the WTRU may not perform SL-PRS transmission and/or reception.

The trigger event may be based on whether the WTRU has received feedback from at least N WTRUs indicating that the WTRU has performed SL-PRS transmission and/or reception. For example, the WTRU may trigger SL-PRS resource usage reporting to the network if at least N WTRUs indicating that it has performed SL-PRS transmission and/or reception.

The trigger event may be based on whether the WTRU has received feedback from at least N WTRUs indicating that it has not performed SL-PRS transmission/reception. For example, the WTRU may trigger requesting more SL-PRS resource if at least N WTRUs indicate that the WTRU has not performed SL-PRS transmission and/or reception. For example, the WTRU may trigger SL-PRS resource usage reporting to the network if at least N WTRUs indicating that it has not performed SL-PRS transmission and/or reception.

The trigger event may be based on whether the WTRU has received feedback from at least N WTRUs indicating it has deprioritized SL-PRS transmission and/or reception. For example, the WTRU may trigger requesting more SL-PRS resource if at least N WTRUs indicating that the WTRU has deprioritized SL-PRS transmission and/or reception. For example, the WTRU may trigger SL-PRS resource usage reporting to the network if at least N WTRUs indicating that the WTRU has deprioritized SL-PRS transmission and/or reception.

The trigger event may be based on whether the WTRU has received feedback from at least N WTRUs indicating the WTRU needs more resources for SL-PRS transmission/reception. For example, the WTRU may trigger requesting more sidelink resource for requesting message if the WTRU receives feedback from at least N WTRUs indicating that it needs more resources for SL-PRS transmission and/or reception.

The trigger event may be based on whether the WTRU has changed the set of WTRUs in the sidelink positioning group. For example, the WTRU may request the network to increase and/or reduce the number of SL-PRS reception resources, and/or the number of SL-PRS measurement report resources in each period if the set of WTRUs in the sidelink positioning group has changed.

The trigger event may be based on whether the WTRU finish a sidelink positioning session. For example, the WTRU may request the network to deactivate and/or release all semi-static resource associated with the WTRU if it determines terminate a sidelink positioning session.

The value of N in the triggering events may be determined based on one or any combination of the following: whether the resources are fixed and/or (pre-) configured. For example, if the WTRU does not receive ACK feedback from one WTRU (e.g., N=1), the WTRU may trigger requesting more resources until the WTRU receives ACK feedbacks from all WTRUs. For example, in some scenarios, if the WTRU receives NACK feedback from at one WTRU (e.g., N=1), the WTRU may trigger requesting more resources until the WTRU receives ACK feedbacks from the WTRU.

The value of N in the triggering events may be determined based on the number of WTRUs and/or the number of anchor WTRUs in the group. For example, in some scenarios, if the WTRU does not receive ACK feedback from one WTRU (e.g., N=1), the WTRU may request more resources for transmission and/or reception until the WTRU receives ACK feedbacks from all WTRUs.

The value of N in the triggering events may be determined based on the QoS (e.g., latency, accuracy) requirement of the positioning service.

For a relaxed sidelink positioning accuracy requirement, the WTRU may require support of small number of anchor WTRUs. However, for high sidelink positioning accuracy requirement, the WTRU may require the support from a large number of anchor WTRUs.

A WTRU may request periodic and/or aperiodic SL-PRS resources. A WTRU may request and/or select periodic and/or aperiodic SL-PRS resources (e.g., the WTRU may request the SL-PRS from the network (e.g., gNB and/or LMF) and/or another WTRU (e.g., RSU, peer WTRU, target WTRU, and/or anchor WTRU). The WTRU may determine one and/or any appropriate combination of the parameters in the SL-PRS configuration (e.g., the offset, the periodicity, and/or the latency) for the periodic SL-PRS based on one and/or any combination of the following:

The selected, requested, and/or available SL-PRS configuration from peer WTRU. For example, for RTT positioning method, one WTRU (e.g., the target WTRU) may request and/or select a periodic SL-PRS resources first. The WTRU may then inform other WTRU (e.g., an anchor WTRU) of a requested, selected, and/or scheduled periodic SL-PRS resource. The other WTRU (e.g., anchor WTRU) may then determine the parameters in its SL-PRS configuration (e.g., the offset, the latency, the periodicity, the bandwidth of SL-PRS, and/or the SL-PRS pattern) based on the requested, selected, and/or scheduled periodic SL-PRS resource from the peer WTRU.

In examples, if the WTRU determines to request and/or select a periodic SL-PRS resource, the WTRU may select and/or request the similar SL-PRS configuration as the SL-PRS configuration of the target WTRU. However, the offset may have a gap to the requested, selected and/or scheduled SL-PRS from the peer WTRU. The gap may be (pre-) configured and/or determined by the WTRU based on the QoS (e.g., latency and/or accuracy) of the positioning service.

In examples, if the WTRU determines to request and/or select an aperiodic SL-PRS resource, the WTRU may select a similar SL-PRS configuration as SL-PRS configuration of the target WTRU except the latency and/or periodicity. Specifically, the WTRU may not request and/or select a periodic resource and the WTRU may request and/or select aperiodic SL-PRS having latency being smaller than periodicity of the periodic SL-PRS. The WTRU may select and/or request the aperiodic SL-PRS based on the timing of the periodic SL-PRS of the other WTRU and/or the QoS requirement of the positioning service.

A WTRU may trigger changing a SL-PRS configuration (e.g., SL-PRS offset and/or periodicity). A WTRU (e.g., target WTRU and/or anchor WTRU) may trigger requesting and/or selecting a new SL-PRS which may be a new periodic SL-PRS and/or a new aperiodic SL-PRS based on one and/or any appropriate combination of the following:

The SL-PRS configuration of another WTRU may have changed. For example, for RTT positioning method, a WTRU may select a periodic SL-PRS based on a periodic SL-PRS from another WTRU. The WTRU may trigger requesting and/or selecting a new periodic SL-PRS (e.g., with the new value of offset and/or periodicity) if the WTRU detects the associated periodic SL-PRS has changed.

The WTRU may have detected collision of the existing periodic SL-PRS. For example, the WTRU may trigger selecting a new SL-PRS if the WTRU detects collision with another SL-PRS transmission.

The WTRU receives an indication from another WTRU to change its SL-PRS configuration. For example, another WTRU (e.g., target WTRU) may indicate the WTRU (e.g., anchor WTRU) to change its SL-PRS configuration. The WTRU may then trigger requesting and/or selecting a new periodic SL-PRS to accommodate the other WTRU (e.g., the target WTRU).

A WTRU may indicate the priority of the sidelink positioning service. The WTRU (e.g., target WTRU) may initialize its sidelink positioning service. In examples, the WTRU may determine the priority of its sidelink positioning and/or indicate its decision to the network. In examples, the WTRU may suggest, indicate, and/or request a priority level for its sidelink positioning. The WTRU may then receive the assigned priority for its sidelink positioning from the network. The WTRU may then determine the priority of one or any combination of the following transmission and/or reception, which may be based on the priority of the sidelink positioning service: sidelink positioning requesting transmission, SL-PRS transmission, SL-PRS reception, SL-PRS measurement reporting, SL-PRS resource usage reporting in sidelink, and/or SL-PRS resource usage reporting in uplink.

A WTRU may report its SL-PRS resources to the network. In examples, the WTRU may receive the request from another WTRU (e.g., anchor WTRU) to perform SL-PRS reception (e.g., semi-static SL-PRS reception). The WTRU may then indicate and/or report the SL-PRS reception resources to the network. The WTRU may indicate the processing time for each SL-PRS resource to the network. This approach may help the network avoid scheduling Uu transmission and/or reception during SL-PRS reception time. In examples, the WTRU may receive measurement gap (MG) and/or positioning processing window (PPW) configuration from the network. In examples, the WTRU may deprioritize SL-PRS reception if the WTRU has not received feedback from the network regarding SL-PRS reception prioritization. In one example, during a measurement gap, the WTRU may not transmit or receive channels or signals and perform measurement only. During a positioning processing window, the WTRU may determine to receive SL-PRS or other channels (e.g., SLCCH, SLSCH) or signals (e.g., SSB) according to priority level associated with the signal or channel.

A WTRU may determine whether to perform SL-PRS reception. Upon receiving a SL-PRS reception request from another WTRU, the WTRU may determine whether to perform SL-PRS reception. The WTRU may then indicate and/or report its decision to the other node (e.g., gNB or another WTRU).

The WTRU may determine whether to perform SL-PRS reception based on one or any combination of the following, including the priority of the SL-PRS. For example, the WTRU may determine to perform SL-PRS reception if the priority of the SL-PRS is larger than a threshold. The threshold may be (pre-) configured, and/or determined based on its existing sidelink communication service in PC5 interface and/or the existing Uu service in Uu interface.

The WTRU may determine whether to perform SL-PRS reception based on the priority of the overlapping sidelink communication (e.g., sidelink transmission and/or reception). For example, the WTRU may determine to perform SL-PRS reception if the priority of the SL-PRS is larger than the priority of the overlapping sidelink communication. The WTRU may then trigger resource reselection in for its overlapping sidelink transmission. The WTRU may indicate and/or request the WTRU performing overlapping sidelink communication to reselect and/or deprioritize the overlapping sidelink communication. For example, the WTRU may determine to deprioritize SL-PRS reception if the priority of the SL-PRS is smaller than the priority of the overlapping sidelink communication. The WTRU may then indicate its decision of deprioritizing SL-PRS reception to the SL-PRS transmitting WTRU. The SL-PRS transmitting WTRU may change the configuration of the SL-PRS transmission resource.

The WTRU may determine whether to perform SL-PRS reception based on the duration of SL-PRS reception in one period. For example, the WTRU may determine to perform SL-PRS reception if the duration of SL-PRS reception in one period is smaller than a threshold. Otherwise, the WTRU may determine not to perform SL-PRS reception.

The WTRU may determine whether to perform SL-PRS reception based on the periodicity of the SL-PRS reception resource. For example, the WTRU may determine to perform SL-PRS reception if the periodicity of the SL-PRS reception is smaller than a threshold. Otherwise, the WTRU may determine not to perform SL-PRS reception.

The WTRU may determine whether to perform SL-PRS reception based on the number and/or duration of the existing SL-PRS reception in a period. For example, the WTRU may determine whether to perform SL-PRS reception based on the number and/or duration of the existing SL-PRS reception in a period. For example, the WTRU may be (pre-) configured to receive maximum N SL-PRS reception in a period. The WTRU may then determine whether to perform additional SL-PRS reception. Determining whether to perform additional SL-PRS reception may be based on the whether the additional SL-PRS reception may result in exceeding its configured and/or preconfigured SL-PRS reception capability.

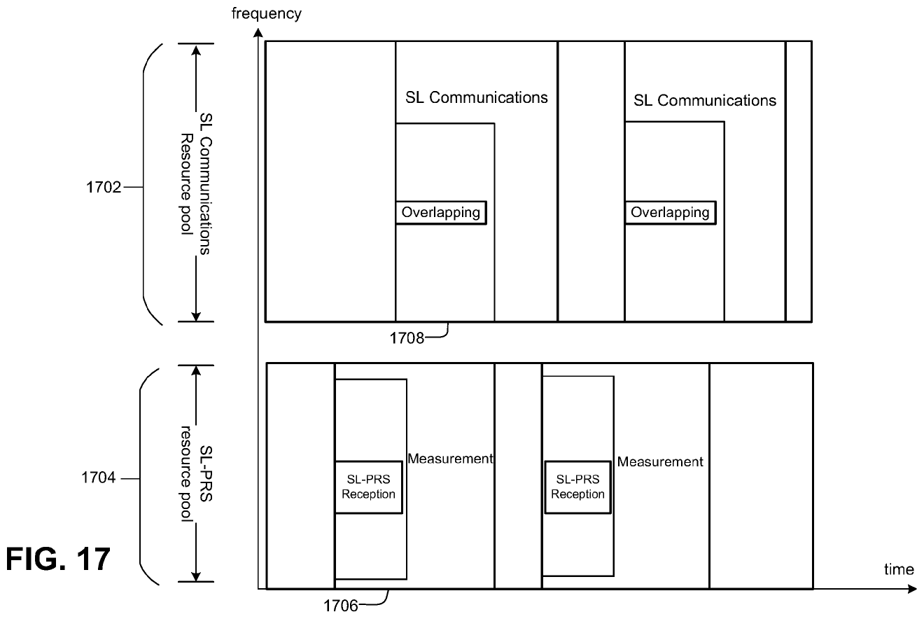

FIG. 17 depicts an example illustration of overlapping between SL-PRS reception and SL communication resource pools. As shown in FIG. 17, the WTRU may perform SL-PRS reception in one resource pool 1702 and sidelink communication in another resource pool 1704. When the WTRU performs SL-PRS reception 1706 (e.g., for the SL-PRS signal), the WTRU may need more time for SL-PRS processing. Therefore, the WTRU may not perform other sidelink transmission and/or reception 1708.

A WTRU may request a MG and/or a PPW for SL-PRS reception. A WTRU may determine to perform SL-PRS reception for a SL-PRS resource (e.g., semi-static SL-PRS resource). The WTRU may then request the network for MG/PPW configuration. The MG and/or PPW configuration may include one and/or any combination of the periodicity of the MG and/or PPW and/or the duration of the MG and/or PPW in each periodicity.

In examples, the WTRU may request one MG and/or PPW for each semi-static SL-PRS reception. In examples, the WTRU may determine the MG and/or PPW configuration based multiple (e.g., all) semi-static SL-PRS reception resources. The WTRU may then request the determined MG and/or PPW to perform receptions of multiple semi-static SL-PRS reception resources.

A WTRU may indicate its SL-PRS reception resources to other WTRUs. In examples, a WTRU upon receiving a request to perform SL-PRS reception may indicate its (e.g., semi-static) SL-PRS reception resource to other node (e.g., the WTRU having existing sidelink communication to the WTRU or the gNB). This approach may help other nodes to avoid scheduling and/or transmitting the overlapping resources with the SL-PRS reception resource of the WTRU.

A WTRU may prioritize between SL-PRS reception and/or other sidelink transmission and/or reception. In examples, the WTRU may perform prioritization between SL-PRS reception and/or another overlapping transmission and/or reception in Uu and/or sidelink. In examples, the WTRU may determine whether to perform SL-PRS reception and/or Tx and/or Rx in Uu and/or SL. The WTRU may make this determination based on relative priority between SL-PRS and/or the Tx and/or Rx resource in Uu and/or SL. For example, the WTRU may prioritize SL-PRS reception if the priority of SL-PRS is larger than the priority of Tx/Rx resource in SL and/or Uu. Otherwise, the WTRU may deprioritize SL-PRS reception.

In examples, the WTRU may prioritize Tx and/or Rx in Uu and/or SL if the priority of Tx and/or Rx in Uu and/or SL is greater than a threshold. Otherwise, the WTRU may prioritize SL-PRS reception. The threshold may be (pre-) configured. In examples, the WTRU may prioritize SL-PRS reception if the priority of SL-PRS is greater than a threshold. Otherwise, the WTRU may prioritize Tx and/or Rx in Uu and/or SL. The threshold may be (pre-) configured.

In examples, the WTRU may prioritizes SL-PRS reception if the priority of SL-PRS reception is greater than a first threshold. Otherwise, the WTRU may prioritize Tx and/or Rx in Uu and/or SL if the priority of the Tx and/or Rx in Uu and/or SL is greater than the second threshold. Otherwise, if both SL-PRS reception and Tx and/or Rx in Uu and/or SL are smaller than its respective threshold, the WTRU may randomly determine which to prioritize. The WTRU may base the prioritization on other criteria. The thresholds may be (pre-) configured.

In examples, the WTRU may prioritize Tx and/or Rx in Uu and/or SL if the priority of Tx and/or Rx in Uu and/or SL is greater than a first threshold. Otherwise, the WTRU may prioritize SL-PRS reception if the priority of the SL-PRS reception is greater than the second threshold. Otherwise, if both SL-PRS reception and Tx and/or Rx in Uu and/or SL are smaller than its respective threshold, the WTRU may base the prioritization on other criteria. The thresholds may be (pre-) configured.

For hybrid positioning, a WTRU may be configured with SL and/or Uu positioning independently. In examples, the WTRU may report measurements related to SL positioning (e.g., RSRP, RSTD, and/or Rx-Tx time difference related to SL PRS) and/or Uu positioning (e.g., RSRP, RSTD, and/or Rx-Tx time difference related to PRS transmitted from TRPs or gNBs) in the same report associated with a time stamp. The network may use the time stamp to track when the measurement report containing measurements related to SL positioning and/or Uu positioning is sent. For example, the target WTRU may determine that the it is in the corner of a room based on Uu positioning results (e.g., location information, zone ID, SSB measurements, etc.). If the target WTRU determines that it is in the corner of a room (e.g., based on zone ID and/or location information), the target WTRU may determine to initiate SL positioning and/or use one or more anchor WTRU(s) for SL positioning.

A WTRU may determine whether to measure RSTD between two RATs. The WTRU may use one node in one radio access technology (RAT) as the reference node to measure the measurement quantity difference (e.g., RSTD and/or PDOA) between the reference node and/or the measured node. The measurement may occur in both the same and/or different RAT compared with the reference node. The WTRU may use one node in one RAT as the reference to the node in the same RAT. The WTRU may determine whether to use one node in one RAT as the reference for the node in both RATs The WTRU may make this determination based on whether the PC5 RAT is (pre-) configured to use the same BWP as Uu. If PC5-RAT is (pre-) configured to use the same carrier as Uu, the WTRU may use one node (e.g., serving gNB) as the reference node for the nodes in both RATs. Otherwise, if PC5 RAT is (pre-) configured to use a different BWP as Uu, the WTRU may use a node in each RAT as the reference for all node in the same RAT.

A WTRU may determine the reference node for RSTD measurement. The WTRU may determine which node as the reference node to measure the measurement quantity difference. The WTRU may make this determination based on and one and/or the combination of the type of WTRU, wherein the WTRU may prioritize the RSU as a reference node, the coverage status, and/or wherein the WTRU may prioritize an in-coverage WTRU as a reference node.

A WTRU may trigger resource reselection and/or pre-emption upon reception of MG and/or PPW configuration in Uu. The WTRU (e.g., target WTRU) may receive MG and/or PPW configuration from the network (e.g., gNB). The WTRU may then trigger resource reselection and/or pre-emption if the WTRU detects that one or more of its reserved sidelink resources is within the MG and/or PPW duration in Uu. The WTRU may then select another resource considering the configured MG and/or PPW. The WTRU may first exclude all the candidate resources within the configured MG and/or PPW and then select the resource outside of the configured MG/PPW.

A WTRU may trigger resource reselection and/or pre-emption upon reception of MG and/or PPW in Uu of the peer. The WTRU, upon reception of the MG and/or PPW in Uu of the per WTRU, may determine to perform trigger resource reselection and/or pre-emption if it detects that its reserved sidelink transmission resource to the peer WTRU is within the MG and/or PPW of the peer WTRU. The WTRU may then select another resource outside of the MG and/or PPW of the peer WTRU.

A WTRU may avoid transmitting to a peer WTRU during its MG and/or PPW. The WTRU may avoid transmitting to a peer WTRU during the peer WTRU's MG and/or PPW duration. The WTRU may perform LCP procedure, in which, for any resource within MG and/or PPW of the peer WTRU, the WTRU may not select data and/or SL-PRS to transmit to the peer WTRU. The WTRU may select data and/or SL-PRS to transmit to the peer WTRU outside of its MG and/or PPW period. The WTRU may trigger resource reselection if one of its reserved resources is within the MG and/or PPW of the peer WTRU.

A WTRU may indicate the network (e.g., LMF) of its MG and/or PPW. A WTRU may indicate one or any appropriate combination of the following MG and/or PPW to another node (e.g., to another WTRU, to the network such as LMF and/or gNB) including its MG and/or PPW in Uu. For example, the WTRU may indicate its MG and/or PPW to another WTRU so that another WTRU and/or gNB may avoid transmit channels (e.g., SLCCH and/or SLSCH) and/or signals to the WTRU and/or request the WTRU to transmit/receive signals (e.g., SL-PRS) during the MG and/or PPW duration.

The WTRU may indicate its MG and/or PPW in sidelink. For example, the WTRU may indicate its MG and/or PPW to another WTRU so that another WTRU and/or gNB may avoid transmitting to the WTRU during the MG and/or PPW duration. Alternatively, a gNB may avoid scheduling Uu resources during its MG and/or PPW in sidelink.

The WTRU may indicate the MG and/or PPW of one or more other WTRUs. For example, the WTRU may indicate the MG and/or PPW of another WTRU in sidelink to the gNB. The gNB may implicitly request the gNB to schedule transmission resources (e.g., sidelink transmission resource and/or SL-PRS transmission resource) to one or more WTRUs outside the indicated MG and/or PPW periods.

In a positioning method such as multi-RTT, SL-TDOA, SL-AOD and/or SL-AoA, the target WTRU may receive configurations for more than one anchor WTRU(s). When the target WTRU determines a relative position with respect to a reference node (e.g., distance and angle with respect to a reference node), the WTRU may define what to use as a reference node. If a reference node is a mobile node (e.g., vehicle), the relative location with respect to such node may become outdated quickly and/or inaccurate.

Given a set of anchor WTRU(s), the target WTRU may determine the reference node based on at least one of the following conditions: the reference node may be an anchor WTRU, indicated by one of the anchor WTRU(s) and/or network (e.g., gNB, LMF). The reference node may be a stationary anchor WTRU (e.g., roadside unit, positioning reference unit). In one example, if the target WTRU receives configurations for more than one anchor WTRU(s) and one of the anchor WTRU(s) is a stationary WTRU (e.g., roadside unit), the target WTRU may use the WTRU as the reference node. If there are more than one stationary WTRUs, the target WTRU may randomly select one of them, and report to the network and/or anchor WTRU(s) which WTRU the target WTRU selected. Additionally or alternatively, the target WTRU may use measurement results (e.g., RSRP) to select the WTRU as the reference node.

The target WTRU determines a reference node based on the measurements on SL-PRS transmitted by anchor WTRU(s). For example, the target WTRU may determine to use the anchor WTRU with the highest SL-PRS RSRP as the reference node.

Given a set of anchor WTRU(s), the target WTRU may determine the reference node based on whether the target WTRU receives a list of priority levels associated with anchor WTRU(s). The target WTRU may determine the reference node based on the priority level (e.g., the anchor WTRU with the highest level of priority is chosen as the reference node. If the anchor WTRU with the highest level of priority is not available for PRS transmission, and/or the anchor is a mobile anchor WTRU, the target WTRU may determine to use the anchor WTRU with the second highest priority level as the reference node)

Given a set of anchor WTRU(s), the target WTRU may determine the reference node based on the location of the reference node and/or identity of the reference node (e.g., anchor WTRU ID). The network may indicate the reference node and/or anchor WTRU(s) and/or the target WTRU may determine to report relative location with respect to the reference node.

Given a set of anchor WTRU(s), the target WTRU may determine the reference node based on whether the reference node is one of the sources (e.g., source of synchronization, and/or reference WTRU with which RSTD is determined) for SL positioning and/or SL communication. In examples, the target WTRU may receive priority level associated with the sources. For example, the priority level of the source of synchronization may have higher priority level than the level associated with the reference WTRU that computes the RSTD.

In examples, the target WTRU may indicate information (e.g., WTRU ID, SL PRS resource ID and/or SL PRS ID associated with the SL-PRS transmitted by the reference node) related to the reference node in the relative location information. In examples, during positioning, the target WTRU may determine to change the reference node. In such a case, the target WTRU may send a request to anchor WTRU(s) and/or network to terminate the current positioning session and restart the session.

In examples, the WTRU may determine to include information related to the reference node when there is a change in the reference node. If the reference node does not change, the target WTRU may determine to include a timestamp in the measurement report where the timestamp may indicate the time the reference node is configured. For example, if the target WTRU may determines to use an anchor WTRU_A as the reference node at time T1, the target WTRU may indicate to the network that WTRU_A is used as the reference node at time T1. At time T2, which is later than T1, if the reference node does not change, the target WTRU may associate T1 with relative location information determined at T2. The network may refer to the report at T1 to determine which reference node is used. If, at time T3, which is later than T2, the target WTRU may determine to change the reference node (e.g., to anchor WTRU_B), the target WTRU may indicate the reference node information (e.g., information related to anchor WTRU_B such as its location information, WTRU ID, and/or PRS resource ID) in its report, associating T3 with the information. At time T4 which is later than T3, if there the reference node does not change, the target WTRU may indicate T3 to the network for reference node information.

In examples, for each reference node, the target WTRU may receive a validity period during which the target WTRU may use the reference node for relative location. In examples, the target WTRU may determine to use more than one reference node based on the conditions described above. The target WTRU may include relative location information corresponding to each reference node in its report sent to anchor WTRU(s) and/or network.

A WTRU may request resources for sidelink positioning and forward the schedule to a group. In examples, a WTRU (e.g., target WTRU) may receive a scheduled sidelink resource (e.g., via DCI) for a group of WTRUs for sidelink positioning. The WTRU may then determine the positioning method to use for the group based on the set of scheduled sidelink resources (e.g., in DCI). The target WTRU may then forward the scheduled SL-PRS reception (if available), and/or SL-PRS measurement reporting resources (if available) indicated in the scheduled sidelink resources (e.g., DCI) using a groupcast message associated with the group for potential SL-PRS transmission and/or measurement reporting of the anchor WTRUs.

In such a case, the WTRU may perform the following steps: the WTRU may perform a discovery procedure to determine the set of anchor WTRUs and/or determines the group ID to represent the positioning group. The WTRU may inform the positioning group information to the gNB. The WTRU may request the sidelink resources for the group of WTRU to perform sidelink positioning. The WTRU may receive the scheduled sidelink resource (e.g., via DCI) for the group of WTRUs to perform sidelink positioning.

The WTRU may determine the positioning method based on the content of the scheduled sidelink resources. For example, if the scheduled resources have both SL-PRS transmission and/or SL-PRS reception resources, the WTRU may perform RTT-based sidelink positioning. If the scheduled resources have SL-PRS transmission resources, the WTRU may perform SL-PRS transmission-based method. If the scheduled resources have SL-PRS reception resource, the WTRU may perform SL-PRS reception-based method.

Additional steps the WTRU may perform occur if the scheduled sidelink resources have SL-PRS reception and/or SL-PRS measurement reporting resources, the WTRU may forward the scheduled resources for anchor WTRUs using the groupcast ID. The WTRU may perform SL-PRS transmission in the scheduled resource for SL-PRS transmission. The WTRU may perform SL-PRS reception in the scheduled resource for SL-PRS reception.

A WTRU may determine sidelink resource for each WTRU in a group. In examples, for RTT-based method, a WTRU (e.g., the target WTRU) may perform SL-PRS reception and/or SL-PRS measurement reporting reception from the group of WTRU (e.g., group of anchor WTRUs). The WTRU may determine SL-PRS and/or measurement reporting resource for each anchor WTRU based on the anchor WTRU ID, number of WTRUs in the group, the OCC (pre-) configured for each WTRU, the set of sidelink resources scheduled for the group, and/or the (pre-) configured multiplexing rules. The WTRU may then transmit the derived positioning (e.g., relative positioning) using a groupcast message associated with the group.

For example, the WTRU may perform one or any combination of the following steps: the WTRU may determines the group of WTRUs for sidelink positioning, the WTRU may configures each anchor WTRU with one OCC (e.g., based on WTRU ID), the WTRU may receive the SL-PRS resource configuration and/or SL-PRS measurement reporting configuration from gNB, which may include: the bandwidth, duration, comb size, number of repetitions, for each SL-PRS resource, and/or the resource size for each measurement reporting. The SL-PRS resource configuration and/or SL-PRS measurement reporting configuration from gNB may also include the order of SL-PRS multiplexing for the group of resources (e.g., OCC, then frequency, then time) and/or the order multiplexing of SL-PRS measurement reporting resource (e.g., time, then frequency).

The WTRU may also forward the configuration to the group using the group ID. The WTRU may receive the scheduled sidelink resources (e.g., via DCI) for the group of WTRUs to perform sidelink positioning and/or forwards the scheduled resources to the anchor WTRUs. The WTRU may perform SL-PRS transmission in the scheduled sidelink resources for its SL-PRS transmission. The WTRU may determine the SL-PRS and measurement reporting resource for each anchor WTRU based on the anchor WTRU ID, number of WTRUs in the group, the OCC (pre-) configured for each WTRU, the set of sidelink resources scheduled for the group, and/or the (pre-) configured multiplexing rules. The WTRU may calculate the RTT between each WTRU based on the WTRU's measured Tx-Rx of SL-PRS and the reported Tx-Rx from each anchor WTRU. The WTRU may include the calculated relative positioning to anchor WTRUs in one message and/or transmit to the group using the group ID.

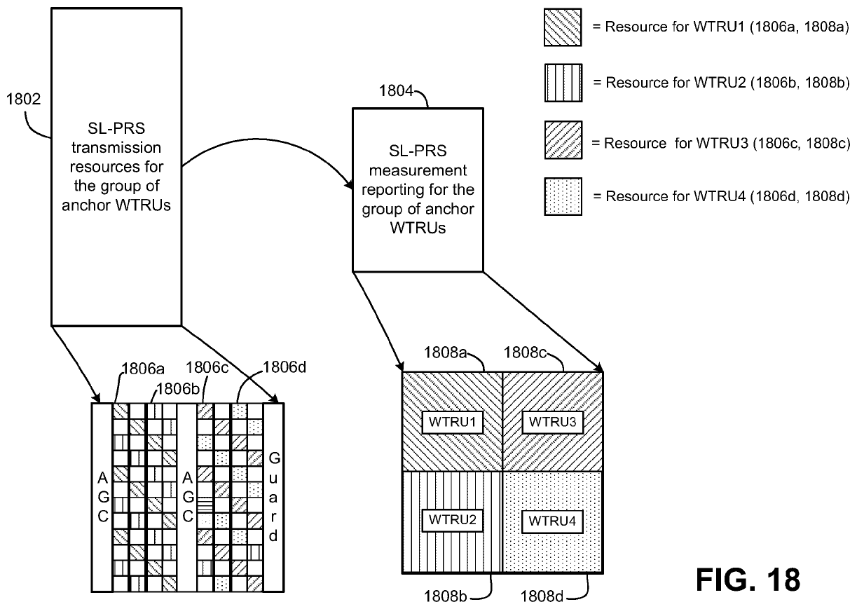

FIG. 18 depicts an example illustration of SL-PRS 1802 and SL-PRS measurement reporting 1804 multiplexing among WTRUs in the group. As shown in FIG. 18, the WTRU may be scheduled SL-PRS resources 1806a-d and SL-PRS measurement reporting resources 1808a-d for a group of WTRUs. The WTRU may then determine the SL-PRS resource 1806a-d and SL-PRS measurement reporting resources 1808a-d for each WTRU.

A WTRU may determine its SL-PRS and/or SL-PRS measurement reporting resources from the resources for a group. In examples, for RTT-based method, a WTRU (e.g., an anchor WTRU) may receive (e.g., from the target WTRU) a set of resources for SL-PRS transmission and a set resources for SL-PRS measurement reporting. The WTRU may then determine its SL-PRS transmission resource and/or its SL-PRS measurement reporting resource (e.g., to report Tx-Rx difference) based on its WTRU ID, the number of WTRUs in the group, the OCC (pre-) configured to the WTRU, and/or the (pre-) configured multiplexing rules.

For example, to determine its SL-PRS transmission resource and/or its SL-PRS measurement reporting resource the WTRU may perform one or any combination of the following: determines its WTRU ID in the group and the number of WTRUs in the positioning group, receive a dedicated OCC (e.g., based on WTRU ID) for SL-PRS transmission, receives the SL-PRS resource configuration and/or SL-PRS measurement reporting configuration from the target WTRUs, receive the scheduled sidelink resources for the group of WTRUs to perform sidelink positioning and/or from the target WTRU, determine its SL-PRS and measurement reporting resource for each anchor WTRU based on its WTRU ID, number of WTRUs in the group, the WTRU's configured OCC, the set of sidelink resources scheduled for the group, and/or the (pre-) configured multiplexing rules, and/or perform SL-PRS transmission and/or SL-PRS measurement reporting in the determined resources.

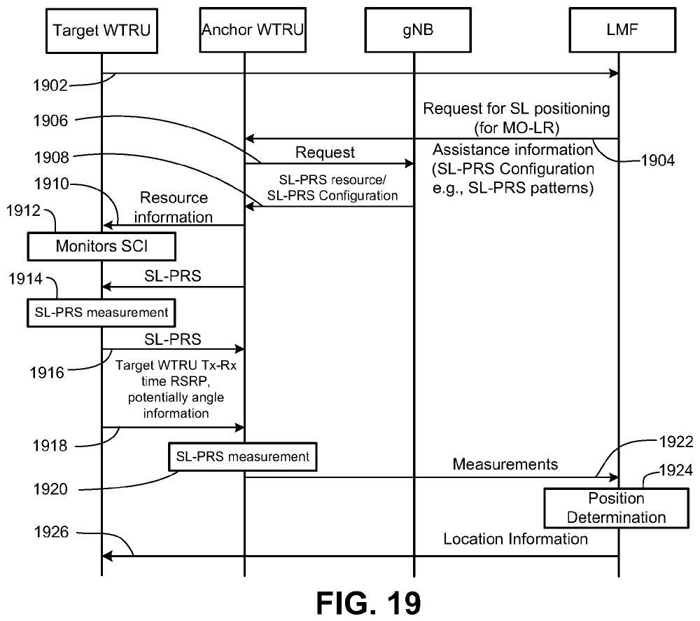

FIG. 19 depicts an example signal flow diagram for in-coverage round trip time (RTT). positioning. At 1902, the target WTRU may send a positioning request to the network (e.g., LMF, or the like, etc.), for example. Such a request may include a MO-LR request (e.g., sent in LPP or LCS message), LPP message (e.g., LPP request for sidelink positioning, LPP request for assistance data, LPP capability info), and/or AS layer message (e.g. RRC message, MAC CE.

At 1904, the anchor WTRU may receive PRS configurations (e.g., PRS parameters such as comb value, number of slots, bandwidth, and/or positioning method) for the anchor WTRU and/or target WTRU. At 1906, the anchor WTRU may send a request to the gNB to schedule resources for transmission of PRS for anchor WTRU and/or target WTRU. At 1908, the gNB may respond to the anchor WTRUs with SL-PRS resource and/or SL-PRS configurations.

At 1910, the target WTRU may receive resource information (e.g., location(s) of SL-PRS in time and/or frequency domain) from the anchor WTRU. Next, though not shown in FIG. 19, the target WTRU may receive, from the anchor WTRU(s) and/or gNB, a set of resources and/or SL PRS configurations. In examples, the target WTRU may receive from anchor WTRU and/or gNB an indication of the sidelink positioning method (e.g. RTT) to apply. The target WTRU may determine a resource and/or configuration for its SL-PRS transmission based on the aforementioned set of resources and/or SL PRS configurations. The target WTRU may receive such information and/or indication in any of SCI, MAC-CE, PC5-RRC and/or LPP message, for example.

At 1912, the target WTRU may monitor SCI from the anchor WTRU and/or may receive SL-PRS from the anchor WTRU at the resource indicated in SCI. At 1914, the target WTRU may make measurements on the received PRS (e.g., received timing, RSRP, and/or AoA). At 1914, the target WTRU may transmit SL-PRS to the anchor WTRU.

At 1918, the target WTRU may report the target WTRU Rx-Tx time difference to the anchor WTRU (e.g., via any of LPP message, PC5-RRC message, SL MAC CE, and/or SCI), where the target WTRU Tx-Rx time difference may be the difference between the time the target WTRU received SL-PRS from the anchor WTRU and the time the target WTRU transmits SL-PRS. In examples, the target WTRU may report the target WTRU Tx-Rx time difference and/or other measurements (e.g., RSRP per SL-PRS resource) to the LMF via an LPP message.

At 1920, the anchor WTRU may receive a SL-PRS from the target WTRU and/or may make measurements (e.g., received timing, RSRP, AoA, and/or anchor WTRU Rx-Tx time difference) where the anchor WTRU Rx-Tx time difference may be the difference between the time the anchor WTRU transmitted SL-PRS and/or the time the anchor WTRU received SL-PRS from the target WTRU. In examples, the anchor WTRU may send the anchor WTRU Rx-Tx time difference to the LMF in an LPP message.

At 1922, the anchor WTRU may send measurements made by the anchor WTRU and target WTRU to the LMF. In examples, the anchor WTRU may determine relative position between the anchor WTRU and target WTRU and/or absolute position of the target WTRU and may send the position(s) to the LMF in an LPP message. At 1924, the LMF may then receive the position determination and/or determine the location information based on the measurements. At 1926, the target WTRU may receive the location information determined by the LMF based on the measurements.

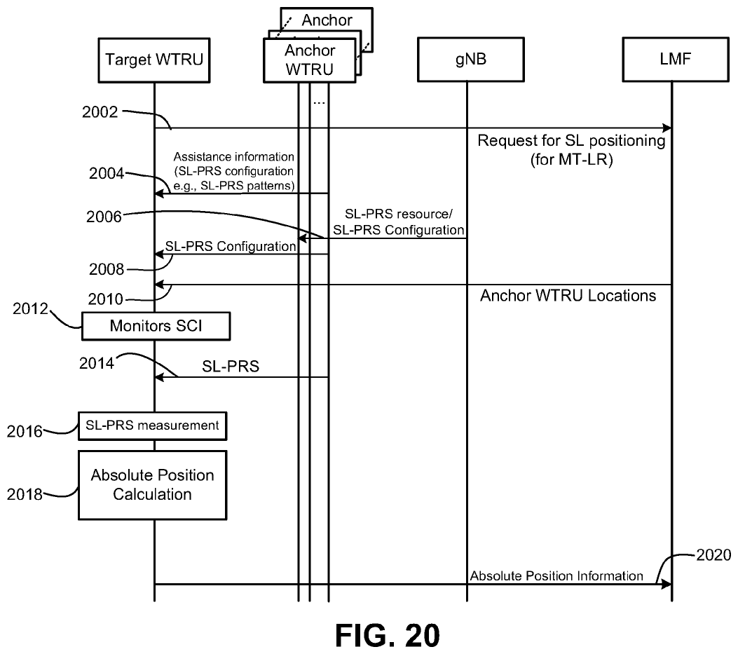

FIG. 20 depicts an example signal flow diagram for WTRU-based in-coverage SL positioning (e.g., SL-TDOA and/or SL-AoD). At 2002, the target WTRU may send a request to the network (e.g., LMF and/or gNB) for its location information. For example, the WTRU may send the request for location information in a LCS message (e.g., MT-LR), LPP message (e.g., LPP request for sidelink positioning, LPP request for location info, and/or LPP request for capability info) and/or in AS layer message (e.g., RRC, and/or MAC CE).

At 2004, the target WTRU may receive assistance information from the anchor WTRU(s) related to SL-PRS configurations (e.g., comb values, number of slots, and/or symbols that contain SL-PRS) and WTRU-based positioning method.

At 2006, the anchor WTRU may receive SL-PRS resource information (e.g., location(s) of SL-PRS in time and/or frequency domain) from gNB. The target WTRU may then receive SL-PRS configuration from one or more anchor WTRUs to perform SL-PRS measurement. At 2008, the target WTRU may receive SL-PRS configuration information from the anchor WTRUs. At 2010, the target WTRU may receive anchor WTRU locations from the LMF, if the anchor WTRUs are stationary such as, (e.g. RSU, via an LPP message including but not limited to LPP assistance data). In examples, if some anchor WTRUs are mobile, the target may receive location information from the anchor WTRUs (e.g., via any of LPP message, PC5-RRC, MAC CE, and/or SCI).

At 2012, the target WTRU may monitor SCI (e.g., received from the gNB and/or anchor WTRUs) for SL-PRS transmitted from anchor WTRUs. At 2014, the target WTRU may receive a SL-PRS from anchor WTRUs. At 2016, the target WTRU may make measurements (e.g., RSRP and/or RSTD) on the received SL-PRS. At 2018, the target WTRU may determine the absolute position based on the measurements.

At 2020, the target WTRU may report the absolute position to the LMF (e.g., via an LPP message). In examples, if the WTRU is configured with an WTRU-assisted SL positioning method, the WTRU may returns measurement report(s) to the LMF.

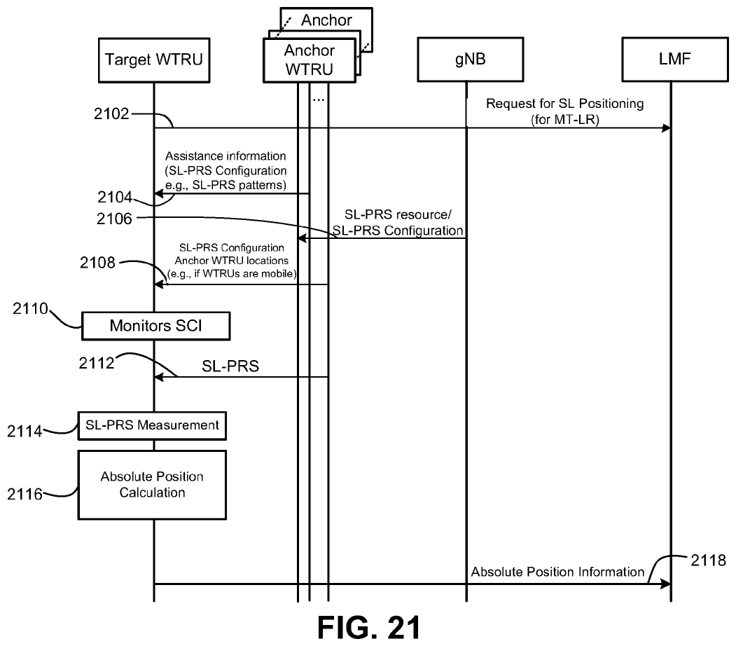

FIG. 21 depicts an example process for SL positioning in which WTRU information may be provided by an anchor WTRU and/or WTRUs. For example, a target WTRU may receive anchor WTRU location(s) if anchor WTRU(s) are mobile.

At 2102, the target WTRU may receive a request from the network (e.g., LMF and/or gNB) for its location information. For example, the WTRU may receive the request for location information in a LCS message (e.g., MT-LR), LPP message (e.g., LPP request for sidelink positioning, LPP request for location info, LPP request for capability info), and/or in AS layer message (e.g., RRC, and/or MAC CE).

At 2104, the target WTRU may receive assistance information from the anchor WTRU(s) related to SL-PRS configurations (e.g., comb values, number of slots and/or symbols that contain SL-PRS) and WTRU-based positioning method.

At 2106, the anchor WTRU may receive SL-PRS resource information (e.g., location(s) of SL-PRS in time and/or frequency domain) from the anchor WTRU(s). At 2108, the target WTRU may receive anchor WTRU locations from the anchor WTRUs (e.g., via any of LPP message, PC5-RRC, MAC CE, and/or SCI).

At 2110, the target WTRU may monitor SCI (e.g., received from the gNB and/or anchor WTRUs) for SL-PRS transmitted from anchor WTRUs. At 2112, the target WTRU may receive a SL-PRS from anchor WTRUs. At 2114, the target WTRU may make measurements (e.g., RSRP and/or RSTD) on the received SL-PRS. At 2116, the target WTRU may determine the absolute position based on the measurements.

At 2118, the target WTRU may report the absolute position to the LMF (e.g., via an LPP message). In examples, if the WTRU is configured with an WTRU-assisted SL positioning method, the WTRU may returns measurement report(s) to the LMF.

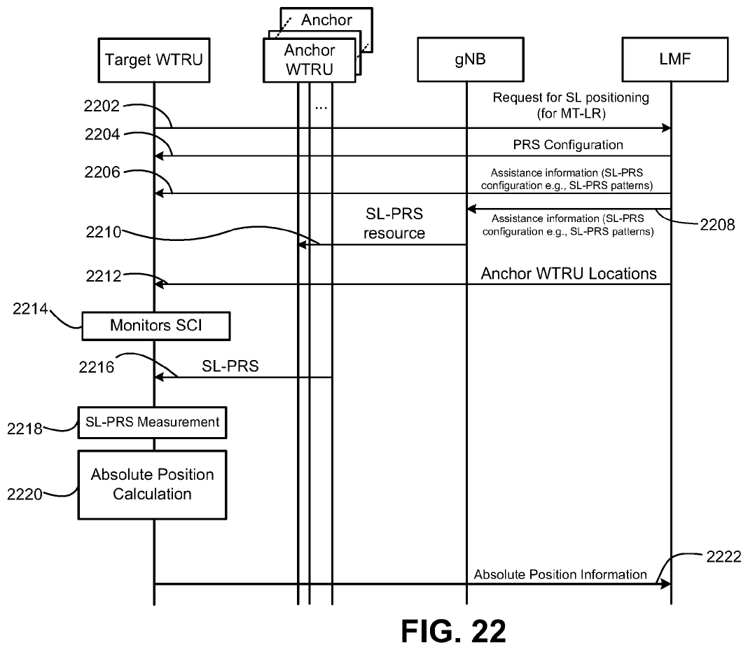

FIG. 22 depicts an example flow diagram of in-coverage, SL positioning (WTRU-based), anchor WTRU information coming from the LMF, PRS configuration coming from the LMF to the target WTRU. At 2202, the target WTRU may send a request to the LMF for SL positioning data. At 2204, the target WTRU may receive the PRS configuration from the LMF in a LPP message (e.g., in any of LPP assistance data message and/or LPP request for location info message). For example, the WTRU may receive the request for location information in a LCS message (e.g., MT-LR), LPP message (e.g., LPP request for sidelink positioning, LPP request for location info, and/or LPP request for capability info) and/or in AS layer message (e.g., RRC, and/or MAC CE).

At 2206, the target WTRU may receive assistance information from the LMF related to SL-PRS configurations (e.g., comb values, number of slots, and/or symbols that contain SL-PRS) and WTRU-based positioning method. At 2208, the gNB may receive assistance information from the LMF related to SL-PRS configurations (e.g., comb values, number of slots, and/or symbols that contain SL-PRS) and WTRU-based positioning method.

At 2210, the anchor WTRU may receive SL-PRS resource information (e.g., location(s) of SL-PRS in time and/or frequency domain) from the gNB. At 2212, the target WTRU may receive anchor WTRU locations from the LMF, if the anchor WTRUs are stationary such as, (e.g. RSU, via an LPP message, including but not limited to LPP assistance data). In examples, if some anchor WTRUs are mobile, the target may receive location information from the anchor WTRUs (e.g., via any of LPP message, PC5-RRC, MAC CE, and/or SCI).

At 2214, the target WTRU may monitor SCI (e.g., received from the gNB and/or anchor WTRUs) for SL-PRS transmitted from anchor WTRUs. At 2216, the target WTRU may receive a SL-PRS from anchor WTRUs. At 2218, the target WTRU may make measurements (e.g., RSRP and/or RSTD) on the received SL-PRS. At 2220, the target WTRU may determine the absolute position based on the measurements.

At 2222, the target WTRU may report the absolute position to the LMF (e.g., via an LPP message). In examples, if the WTRU is configured with an WTRU-assisted SL positioning method, the WTRU may returns measurement report(s) to the LMF.

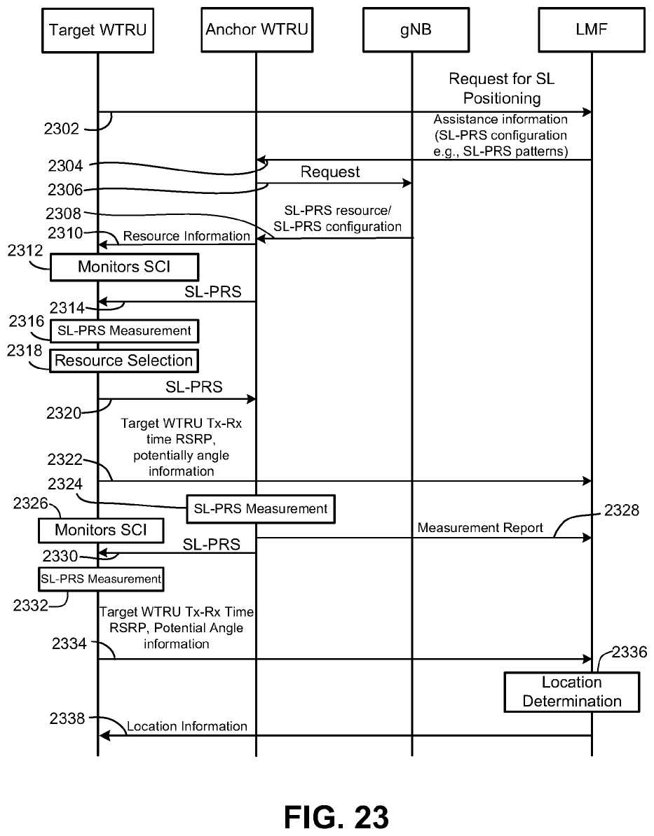

FIG. 23 depicts an example process for two-sided RTT SL positioning. Error! Reference source not found. At 2302, the target WTRU may send a request for positioning to the LMF in an LPP message. At 2304, the anchor WTRU may receive a PRS configuration from the LMF (e.g., in LPP assistance data message). At 2306, the anchor WTRU may send a request for time and/or frequency resources for transmission of SL-PRS from the anchor WTRU and/or target WTRU. At 2308, the anchor WTRU may receive SL-PRS resources and/or configurations from the gNB in response to the request. At 2310, the target WTRU may receive resource information from the anchor WTRU (e.g., via any of LPP, PC5-RRC, MAC CE, and/or SCI). At 2312, the target WTRU may monitor SCI (e.g., received from the gNB and/or anchor WTRUs) for transmitted SL-PRS.

At 2314, the target WTRU may receive a SL-PRS transmitted by the anchor WTRU where the resource for SL-PRS is indicated in SCI. At 2316, the target WTRU may make measurements on SL-PRS (e.g., RSRP, and/or ToA). At 2318, the target WTRU may perform resource selection based on the measurements. At 2320, the target WTRU may transmit SL-PRS based on the resource the target WTRU determines to use. At 2322, the target WTRU may send the first measurement report to the LMF in an LPP message where the report contains, e.g., the target WTRU Tx-Rx time, RSRP per SL-PRS resource, and/or associated AoA measurements.

At 2324, the anchor WTRU may make measurements on SL-PRS transmitted by the target WTRU. At 2326, the target WTRU may monitor SCI (e.g., received from the gNB and/or anchor WTRUs) for transmitted SL-PRS. At 2328, the anchor WTRU may send a measurement report (e.g., anchor WTRU Rx-Tx time, AoA, and/or RSRP). At 2330, the target WTRU may receive the second SL-PRS from the anchor WTRU where its resource information is indicated in SCI. At 2332, the target WTRU may make measurements on SL-PRS (e.g., RSRP, and/or ToA). At 2334, the target WTRU may send the second measurement report to the LMF in an LPP message where the report may contain, e.g., the target WTRU Rx-Tx time, RSRP per SL-PRS resource, and/or associated AoA measurements.

The second target WTRU Rx-Tx time may be defined by the difference between the reception time of the second SL-PRS (from the anchor WTRU) and transmission time of SL-PRS (from the target WTRU). In example, the target WTRU may combine the first and second measurement report and sends the combined measurement report to the LMF.

At 2336, the LMF may determine location of the target WTRU based on the measurement reports. At 2338, the target WTRU may receive location information determined by the LMF.

The herein described sidelink positioning methods may support the SL-TDOA method and/or the RTT method. To ensure positioning QoS, such as accuracy and latency, resources may be coordinated to lessen time gaps between SL-PRS Tx and/or Rx) for the RTT method. Each WTRU may be required to independently request its sidelink Tx resources. This may result in uncoordinated SL-PRS transmission in SL-TDOA and/or prolonged time gaps between SL-PRS Tx and/or Rx in RTT.

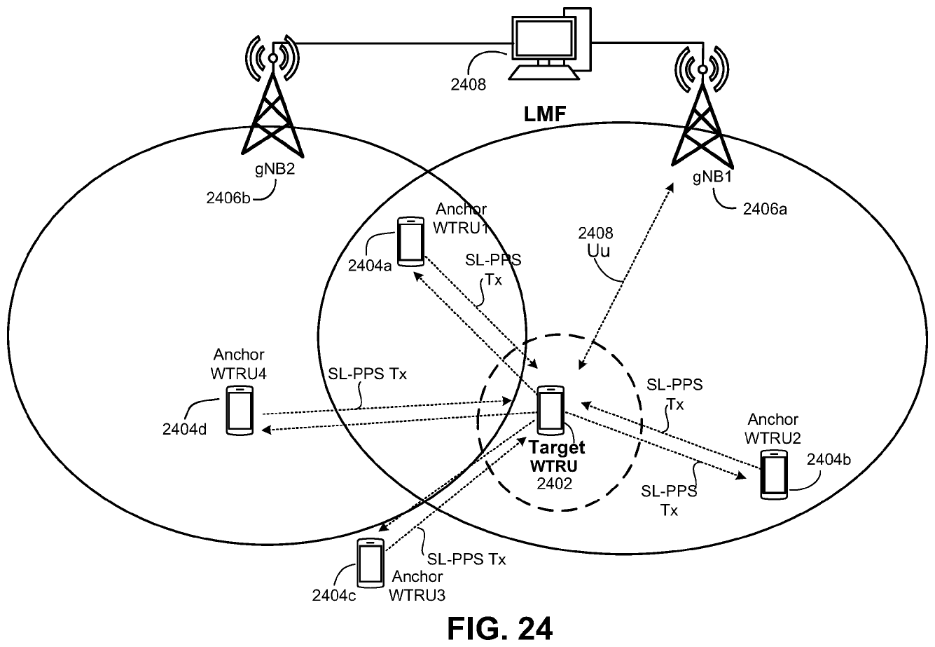

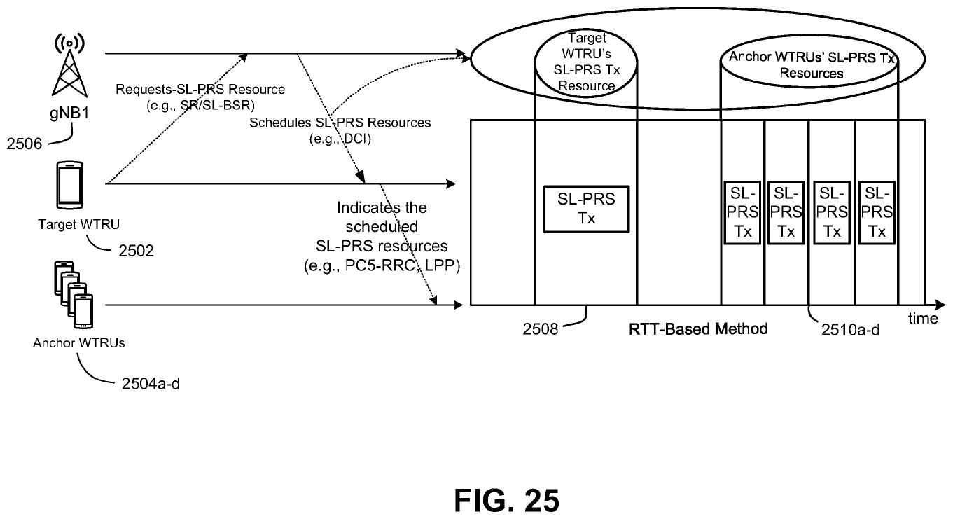

In examples, a WTRU (e.g., a target WTRU) may request resources (e.g., SL-PRS Tx resources) for a group of WTRUs. FIG. 24 depicts an example diagram depicting a WTRU obtaining and providing sidelink resources associated with a group of WTRUs. FIG. 25 depicts another example diagram depicting a WTRU obtaining and providing sidelink resources associated with a group of WTRUs.

As depicted in FIG. 24 a WTRU 2402 (e.g., the depicted target WTRU) may request sidelink-position reference signal (SL-PRS) transmission (Tx) resources for a group of WTRUs 2404a-d (e.g., the depicted anchor WTRUs). The target WTRU 2402 may indicate, in the request, the number of resources needed for itself and for the anchor WTRUs 2404a-d. The target WTRU 2402 may receive an indication of the requested resources and forward scheduled SL-PRS resource to the group (e.g., anchor WTRUs 2404a-d). The target WTRU 2402 may request changes in the SL-PRS configuration based on the measurement report status of the other WTRUs 2404a-d in the group. For network-assisted positioning, the target WTRU 2402 may determine the set of received measurements and/or WTRUs to report to the network based on one or more (pre-) configured conditions.

The target WTRU 2402 may form a sidelink position group via discovery procedures. The target WTRU 2402 may determine a positioning method, (e.g., the RTT method, the SL-TDOA method, and/or any appropriate combination thereof). The target WTRU 2402 may indicate positioning group information, such as, a group identifier (ID) and/or WTRU numbers, etc., to a network entity.

The network entity may comprise any network entity, e.g., gNB1 2406a and/or gNB2 2406b. The target WTRU 2402 may request SL-PRS resources for the group of WTRUs from the network entity (e.g., gNB1 2406a and/or gNB2 2406b). The request may comprise a group ID, the number of resource for the target WTRU 2402's SL-PRS Tx, the number of resources for the anchor WTRUs' 2404a-d SL-PRS Tx, and/or any combination thereof.

As depicted in FIG. 24, the target WTRU 2402 may provide the request 2408 to gNB1 2406a directly. The target WTRU 2042 may go to gNB2 2406b indirectly via another network entity, e.g. the LMF 2410. The target WTRU 2402 may receive the requested resources from the network entity. The target WTRU 2402 may receive SL-PRS resource form gNB1 2406a for the group. The resources may be received via DCI.

The target WTRU 2402 may provide and/or forward the scheduled resource for SL-PRS to the group. The scheduled resources may be provided and/or forwarded via any mechanism, e.g., a PC5-RRC interface.

As depicted in FIG. 25, a WTRU 2502 (e.g., the depicted target WTRU) may request sidelink-position reference signal (SL-PRS) transmission (Tx) 2504 resources for a group of WTRUs 2504 (e.g., the depicted anchor WTRUs). The target WTRU 2502 may indicate, in the request, the number of resources needed for itself and for the anchor WTRUs 2504a-d. The target WTRU 2502 may receive an indication of the requested resources and forward scheduled SL-PRS resource to the group (e.g., anchor WTRUs 2504a-d). The target WTRU 2402 may request changes in the SL-PRS configuration based on the measurement report status of the other WTRUs 2504a-d in the group. For network-assisted positioning, the target WTRU 2502 may determine the set of received measurements and/or WTRUs to report to the network based on one or more (pre-) configured conditions.

As depicted in FIG. 25, the target WTRU 2502 may form a sidelink position group via discovery procedures. The target WTRU 2502 may determine a positioning method, (e.g., the RTT method, the SL-TDOA method, and/or any appropriate combination thereof). The target WTRU 2502 may indicate positioning group information, such as, a group identifier (ID) and/or WTRU numbers, etc. to a network entity.

The network entity may comprise any network entity, e.g., gNB1 2506. The target WTRU 2502 may request SL-PRS resources for the group of WTRUs from the network entity (e.g., gNB1 2506a). The request may comprise a group ID, the number of resource for the target WTRU 2502's SL-PRS Tx 2508, the number of resources for the anchor WTRUs' 2504a-d SL-PRS Tx 2510a-d, and/or any combination thereof.

FIG. 25 depicts a RTT-based positioning method wherein the target WTRU 2502 may determine to transmit SL-PRS 2508 in groupcast-based transmission. Each SL-PRS transmission 2508 may target all anchor WTRUs 2504a-d. Each anchor WTRU 2504a-d may then transmit back SL-PRS 2510a-d using unicast-based transmission.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

Although foregoing embodiments may be discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, are not limited to thereto, and may be applied to other systems that use other forms of electromagnetic waves or non-electromagnetic waves such as acoustic waves, for example.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above are possible without departing from the scope of the invention. In view of the wide variety of embodiments that can be applied, it should be understood that the illustrated embodiments are examples only, and should not be taken as limiting the scope of the following claims. For instance, embodiments provided herein include handheld devices, which may include or be utilized with any appropriate voltage source, such as a battery or the like, providing any appropriate voltage.

Moreover, in embodiments provided herein, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. Those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

What is claimed is:

1.-20. (canceled)

21. A first wireless transmit receive unit (WTRU) comprising:
a transceiver and a processor, the processor configured to:
receive a sidelink positioning reference signal (SL-PRS) transmission request from a second WTRU;
send, via the transceiver in response to the SL-PRS transmission request from the second WTRU, a request to a network for an allocation of SL-PRS resources, a priority associated with the SL-PRS transmission request, and a bandwidth associated with the SL-PRS transmission request; and
receive, via the transceiver from the network, the allocation of SL-PRS resources for the SL-PRS transmission associated with the first WTRU.

22. The first WTRU of claim 21, wherein the processor is further configured to:
receive an indication from the second WTRU, the indication comprising information associated with the priority associated with the SL-PRS and the bandwidth associated with the SL-PRS.

23. The first WTRU of claim 22, wherein the processor is further configured to:
determine, based on the indication, the priority associated with the SL-PRS and the bandwidth associated with the SL-PRS.

24. The first WTRU of claim 22, wherein the indication further comprises information associated with one or more of a latency associated with the SL-PRS or a periodicity associated with the SL-PRS.

25. The first WTRU of claim 24, wherein the processor is configured to:
send, via the transceiver in response to the SL-PRS transmission request from the second WTRU, the latency associated with the SL-PRS or the periodicity associated with the SL-PRS.

26. The first WTRU of claim 21, wherein the request to the network for the allocation of SL-PRS resources is sent via one or more of a scheduling request (SR), a medium access control (MAC) control element (CE) transmission, a radio resource control (RRC) transmission, or a location positioning protocol (LPP) transmission.

27. The first WTRU of claim 21, wherein the request to the network for the allocation of SL-PRS resources is sent via a medium access control (MAC) control element (CE), and wherein the request to the network for the allocation of SL-PRS resources comprises a request for an aperiodic SL-PRS resource transmission.

28. The first WTRU of claim 21, wherein the request to the network for the allocation of SL-PRS resources is sent via a radio resource control (RRC) transmission, and wherein the request to the network for the allocation of SL-PRS resources comprises a request for a periodic SL-PRS resource transmission.

29. The first WTRU of claim 21, wherein the processor is further configured to:
send, via the transceiver in response to the SL-PRS transmission request from the second WTRU, an indication of availability of a sidelink positioning service.

30. The first WTRU of claim 21, wherein the processor is configured to:
send, via the transceiver in response to the SL-PRS transmission request from the second WTRU, a latency associated with the SL-PRS and a periodicity associated with the SL-PRS.

31. A method implemented by a first wireless transmit receive unit (WTRU), the method comprising:
receiving a sidelink positioning reference signal (SL-PRS) transmission request from a second WTRU;
sending, in response to the SL-PRS transmission request from the second WTRU, a request to a network for an allocation of SL-PRS resources, a priority associated with the SL-PRS transmission request, and a bandwidth associated with the SL-PRS transmission request; and
receiving, from the network, the allocation of SL-PRS resources for the SL-PRS transmission associated with the first WTRU.

32. The method of claim 31, further comprising:
receiving an indication from the second WTRU, the indication comprising information associated with the priority associated with the SL-PRS and the bandwidth associated with the SL-PRS.

33. The method of claim 32, further comprising:
determining, based on the indication, the priority associated with the SL-PRS and the bandwidth associated with the SL-PRS.

34. The method of claim 32, wherein the indication further comprises information associated with one or more of a latency associated with the SL-PRS or a periodicity associated with the SL-PRS.

35. The method of claim 34, further comprising:
sending, in response to the SL-PRS transmission request from the second WTRU, the latency associated with the SL-PRS or the periodicity associated with the SL-PRS.

36. The method of claim 31, wherein the request to the network for the allocation of SL-PRS resources is sent via one or more of a scheduling request (SR), a medium access control (MAC) control element (CE) transmission, a radio resource control (RRC) transmission, or a location positioning protocol (LPP) transmission.

37. The method of claim 31, wherein the request to the network for the allocation of SL-PRS resources is sent via a medium access control (MAC) control element (CE), and wherein the request to the network for the allocation of SL-PRS resources comprises a request for an aperiodic SL-PRS resource transmission.

38. The method of claim 31, wherein the request to the network for the allocation of SL-PRS resources is sent via a radio resource control (RRC) transmission, and wherein the request to the network for the allocation of SL-PRS resources comprises a request for a periodic SL-PRS resource transmission.

39. The method of claim 31, further comprising:
sending, via the transceiver in response to the SL-PRS transmission request from the second WTRU, an indication of availability of a sidelink positioning service.

40. The method of claim 31, further comprising:
sending, in response to the SL-PRS transmission request from the second WTRU, a latency associated with the SL-PRS and a periodicity associated with the SL-PRS.
